(19) United States
(12) Patent Application Publication
(10) Pub. No.: US 2026/0089695 A1
(43) Pub. Date: Mar. 26, 2026

(54) Multiple Cells and Multiple Physical Shared Channels Scheduling

(71) Applicant: Comcast Cable Communications, LLC, Philadelphia, PA (US)

(72) Inventors: Hua Zhou, Vienna, VA (US); Yunjung Yi, Vienna, VA (US); Esmael Hejazi Dinan, McLean, VA (US); Hyoungsuk Jeon, Centreville, VA (US); Mohammad Ghadir Khoshkholgh Dashtaki, Reston, VA (US); Ali Cagatay Cirik, Chantilly, VA (US)

(21) Appl. No.: 19/337,191

(22) Filed: Sep. 23, 2025

Related U.S. Application Data
(60) Provisional application No. 63/697,824, filed on Sep. 23, 2024.

(51) Int. Cl. H04W 72/0446; H04L 5/00; H04W 72/1263

(52) U.S. Cl. CPC H04W 72/0446; H04L 5/0044; H04W 72/1263

(57) ABSTRACT

Wireless communications between a base station and a wireless device may be scheduled. The wireless device may receive information for scheduling multiple transmissions on a cell. The information may comprise time allocations for the scheduled transmissions. For example, a time allocation table may be used, whereby the received information may indicate an entry in the table that may correspond to one or more time allocations for one or more scheduled transmissions via a bandwidth part of the cell. A quantity of scheduled transmissions on a cell may be determined based on the time allocations and/or may be indicated based on a number of bits in a control signal.

### CROSS-REFERENCE TO RELATED APPLICATIONS

This application claims the benefit of U.S. Provisional Application No. 63/697,824 filed on Sep. 23, 2024. The above referenced application is hereby incorporated by reference in its entirety.

### BACKGROUND

A wireless device communicates with a base station. The base station sends various configuration parameters to the wireless device. Downlink control information is sent by the base station via a cell to schedule a downlink transmission to the wireless device via the cell.

### SUMMARY

The following summary presents a simplified summary of certain features. The summary is not an extensive overview and is not intended to identify key or critical elements.

A base station may schedule multiple transmissions on multiple cells. The multiple transmissions may include more than one transmission on a cell. The base station may indicate (e.g., to a wireless device) multi-cell multi-transmission scheduling and time allocations for scheduled transmissions. For example, the base station may provide a wireless device with a time allocation table and an indication of an entry in the table (e.g., for a bandwidth part of the cell). The entry may correspond to multiple time allocations (e.g., time domain resource allocations) corresponding to multiple scheduled transmissions via a bandwidth part of the cell. Additionally or alternatively, a base station may indicate a quantity (e.g., a maximum number/quantity) of scheduled transmissions on a cell, for example, based on a number of bits that are included in a field (e.g., a new data indicator field) of a control signal. Each bit may correspond to a scheduled transmission. The quantity of scheduled transmissions on a cell may be determined, for example, based on the time allocations (e.g., time domain resource allocations).

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1A and FIG. 1B show example communication networks.

FIG. 2A shows an example user plane.

FIG. 2B shows an example control plane configuration.

FIG. 3 shows example of protocol layers.

FIG. 4A shows an example downlink data flow for a user plane configuration.

FIG. 4B shows an example format of a Medium Access Control (MAC) subheader in a MAC Protocol Data Unit (PDU).

FIG. 5A shows an example mapping for downlink channels.

FIG. 5B shows an example mapping for uplink channels.

FIG. 6 shows example radio resource control (RRC) states and RRC state transitions.

FIG. 7 shows an example configuration of a frame.

FIG. 8 shows an example resource configuration of one or more carriers.

FIG. 9 shows an example configuration of bandwidth parts (BWPs).

FIG. 10A shows example carrier aggregation configurations based on component carriers.

FIG. 10B shows example group of cells.

FIG. 11A shows an example mapping of one or more synchronization signal/physical broadcast channel (SS/PBCH) blocks.

FIG. 11B shows an example mapping of one or more channel state information reference signals (CSI-RSs).

FIG. 12A shows examples of downlink beam management procedures.

FIG. 12B shows examples of uplink beam management procedures.

FIG. 13A shows an example four-step random access procedure.

FIG. 13B shows an example two-step random access procedure.

FIG. 13C shows an example two-step random access procedure.

FIG. 14A shows an example of control resource set (CORESET) configurations.

FIG. 14B shows an example of a control channel element to resource element group (CCE-to-REG) mapping.

FIG. 15A shows an example of communications between a wireless device and a base station.

FIG. 15B shows example elements of a computing device that may be used to implement any of the various devices described herein.

FIG. 16A, FIG. 16B, FIG. 16C, and FIG. 16D show examples of uplink and downlink signal transmission.

FIG. 17A, FIG. 17B, and FIG. 17C show example MAC subheaders.

FIG. 18A and FIG. 18B show example MAC PDUs.

FIG. 19 shows example logical channel identifier (LCID) values.

FIG. 20 shows example LCID values.

FIG. 21A and FIG. 21B show example secondary cell (SCell) Activation/Deactivation MAC control elements (CEs).

FIG. 22 shows an example of BWP activation/deactivation.

FIG. 23 shows examples of various downlink control information (DCI) formats.

FIG. 24 shows an example of RRC configuration of a serving cell.

FIG. 25 shows an example of Physical Downlink Control Channel (PDCCH) configuration parameters associated with a BWP of a serving cell.

FIG. 26 shows an example of search space configuration parameters.

FIG. 27 shows an example of Physical Downlink Shared Channel (PDSCH) configuration parameters of a BWP of a serving cell.

FIG. 28 shows an example of single PDSCH scheduling on a serving cell.

FIG. 29 shows an example of multiple-PDSCH scheduling on a serving cell.

FIG. 30 shows an example of multiple PDSCH scheduling on multiple cells with one PDSCH per cell.

FIG. 31 shows an example of Time Domain Resource Allocation (TDRA) determination for multiple PDSCH scheduling on multiple cells with one PDSCH per cell.

FIG. 32 shows an example of multi-cell multi-PDSCH/Physical Uplink Shared Channel (PUSCH) scheduling.

FIG. 33 shows an example of multi-cell scheduling.

FIG. 34 shows an example of Type 2 multi-cell scheduling.

FIG. 35 shows an example of serving cell configuration of a serving cell for multi-cell scheduling.

FIG. 36 shows an example of PDSCH configuration of a scheduled cell for multi-cell scheduling.

FIG. 37 shows an example of multi-cell scheduling.

### DETAILED DESCRIPTION

The accompanying drawings and descriptions provide examples. It is to be understood that the examples shown in the drawings and/or described are non-exclusive, and that features shown and described may be practiced in other examples. Examples are provided for operation of wireless communication systems.

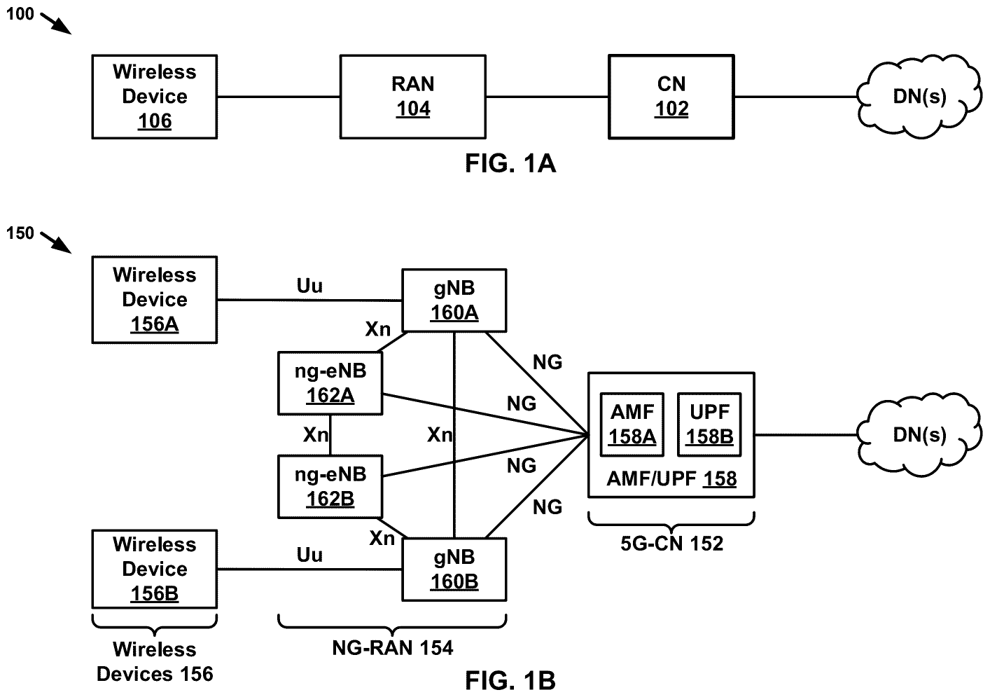

FIG. 1A shows an example communication network 100. The communication network 100 may comprise a mobile communication network. The communication network 100 may comprise, for example, a public land mobile network (PLMN) operated/managed/run by a network operator. The communication network 100 may comprise one or more of a core network (CN) 102, a radio access network (RAN) 104, and/or a wireless device 106. The communication network 100 may comprise, and/or a device within the communication network 100 may communicate with (e.g., via CN 102), one or more data networks (DN(s)) 108. The wireless device 106 may communicate with the one or more DNs 108, such as public DNS (e.g., the Internet), private DNs, and/or intra-operator DNs. The wireless device 106 may communicate with the one or more DNs 108 via the RAN 104 and/or via the CN 102. The CN 102 may provide/configure the wireless device 106 with one or more interfaces to the one or more DNs 108. As part of the interface functionality, the CN 102 may set up end-to-end connections between the wireless device 106 and the one or more DNs 108, authenticate the wireless device 106, provide/configure charging functionality, etc.

The wireless device 106 may communicate with the RAN 104 via radio communications over/via an air interface. The RAN 104 may communicate with the CN 102 via various communications (e.g., wired communications and/or wireless communications). The wireless device 106 may establish a connection with the CN 102 via the RAN 104. The RAN 104 may provide/configure scheduling, radio resource management, and/or retransmission protocols, for example, as part of the radio communications. The communication direction from the RAN 104 to the wireless device 106 over/via the air interface may be referred to as the downlink and/or downlink communication direction. The communication direction from the wireless device 106 to the RAN 104 over/via the air interface may be referred to as the uplink and/or uplink communication direction. Downlink transmissions may be separated and/or distinguished from uplink transmissions, for example, based on at least one of: frequency division duplexing (FDD), time-division duplexing (TDD), any other duplexing schemes, and/or one or more combinations thereof.

As used throughout, the term “wireless device” may comprise one or more of: a mobile device, a fixed (e.g., non-mobile) device for which wireless communication is configured or usable, a computing device, a node, a device capable of wirelessly communicating, or any other device capable of sending and/or receiving signals. As non-limiting examples, a wireless device may comprise, for example: a telephone, a cellular phone, a Wi-Fi phone, a smartphone, a tablet, a computer, a laptop, a sensor, a meter, a wearable device, an Internet of Things (IOT) device, a hotspot, a cellular repeater, a vehicle roadside unit (RSU), a relay node, an automobile, a wireless user device (e.g., user equipment (UE), a user terminal (UT), etc.), an access terminal (AT), a mobile station, a handset, a wireless transmit and receive unit (WTRU), a wireless communication device, and/or any combination thereof.

The RAN 104 may comprise one or more base stations (not shown). As used throughout, the term “base station” may comprise one or more of: a base station, a node, a Node B (NB), an evolved NodeB (eNB), a Generation Node B (base station/gNB), an Next Generation Evolved Node B (ng-eNB), a relay node (e.g., an integrated access and backhaul (IAB) node), a donor node (e.g., a donor eNB, a donor base station/gNB, etc.), an access point (AP) (e.g., a Wi-Fi access point), a transmission and reception point (TRP), a computing device, a device capable of wirelessly communicating, or any other device capable of sending and/or receiving signals. A base station may comprise one or more of the elements listed above. For example, a base station may comprise one or more TRPs. As other non-limiting examples, a base station may comprise for example, one or more of: a Node B (e.g., associated with Universal Mobile Telecommunications System (UMTS) and/or third-generation (3G) standards), an eNB (e.g., associated with Evolved-Universal Terrestrial Radio Access (E-UTRA) and/or fourth-generation (4G) standards), a remote radio head (RRH), a baseband processing unit coupled to one or more RRHs, a repeater node or relay node used to extend the coverage area of a donor node, a ng-eNB, a base station/gNB (e.g., associated with New Radio (NR) and/or fifth-generation (5G) standards), an AP (e.g., associated with, for example, Wi-Fi or any other suitable wireless communication standard), any other generation base station, and/or any combination thereof. A base station may comprise one or more devices, such as at least one base station central device (e.g., a base station/gNB Central Unit (gNB-CU)) and at least one base station distributed device (e.g., a base station/gNB Distributed Unit (gNB-DU)).

A base station (e.g., in the RAN 104) may comprise one or more sets of antennas for communicating with the wireless device 106 wirelessly (e.g., via an over the air interface). One or more base stations may comprise sets (e.g., three sets or any other quantity of sets) of antennas to respectively control multiple cells or sectors (e.g., three cells, three sectors, any other quantity of cells, or any other quantity of sectors). The size of a cell may be determined by a range at which a receiver (e.g., a base station receiver) may successfully receive transmissions from a transmitter (e.g., a wireless device transmitter) operating in the cell. One or more cells of base stations (e.g., by alone or in combination with other cells) may provide/configure a radio coverage to the wireless device 106 over a wide geographic area to support wireless device mobility. A base station comprising three sectors (e.g., or n-sector, where n refers to any quantity n) may be referred to as a three-sector site (e.g., or an n-sector site) or a three-sector base station (e.g., an n-sector base station).

One or more base stations (e.g., in the RAN 104) may be implemented as a sectored site with more or less than three sectors. One or more base stations of the RAN 104 may be implemented as an AP, as a baseband processing device/unit coupled to several RRHs, and/or as a repeater or relay node used to extend the coverage area of a node (e.g., a donor node). A baseband processing device/unit coupled to RRHs may be part of a centralized or cloud RAN architecture, for example, where the baseband processing device/unit may be centralized in a pool of baseband processing devices/units or virtualized. A repeater node may amplify and send (e.g., transmit, retransmit, rebroadcast, etc.) a radio signal received from a donor node. A relay node may perform substantially the same/similar functions as a repeater node. The relay node may decode the radio signal received from the donor node, for example, to remove noise before amplifying and sending the radio signal.

The RAN 104 may be deployed as a homogenous network of base stations (e.g., macrocell base stations) that have similar antenna patterns and/or similar high-level transmit powers. The RAN 104 may be deployed as a heterogeneous network of base stations (e.g., different base stations that have different antenna patterns). In heterogeneous networks, small cell base stations may be used to provide/configure small coverage areas, for example, coverage areas that overlap with comparatively larger coverage areas provided/configured by other base stations (e.g., macrocell base stations). The small coverage areas may be provided/configured in areas with high data traffic (or so-called “hotspots”) or in areas with a weak macrocell coverage. Examples of small cell base stations may comprise, in order of decreasing coverage area, microcell base stations, picocell base stations, and femtocell base stations or home base stations.

Examples described herein may be used in a variety of types of communications. For example, communications may be in accordance with the Third-Generation Partnership Project (3GPP) (e.g., one or more network elements similar to those of the communication network 100), communications in accordance with Institute of Electrical and Electronics Engineers (IEEE), communications in accordance with International Telecommunication Union (ITU), communications in accordance with International Organization for Standardization (ISO), etc. The 3GPP has produced specifications for multiple generations of mobile networks: a 3G network known as UMTS, a 4G network known as Long-Term Evolution (LTE) and LTE Advanced (LTE-A), and a 5G network known as 5G System (5GS) and NR system. 3GPP may produce specifications for additional generations of communication networks (e.g., 6G and/or any other generation of communication network). Examples may be described with reference to one or more elements (e.g., the RAN) of a 3GPP 5G network, referred to as a next-generation RAN (NG-RAN), or any other communication network, such as a 3GPP network and/or a non-3GPP network. Examples described herein may be applicable to other communication networks, such as 3G and/or 4G networks, and communication networks that may not yet be finalized/specified (e.g., a 3GPP 6G network), satellite communication networks, and/or any other communication network. NG-RAN implements and updates 5G radio access technology referred to as NR and may be provisioned to implement 4G radio access technology and/or other radio access technologies, such as other 3GPP and/or non-3GPP radio access technologies.

FIG. 1B shows an example communication network 150. The communication network may comprise a mobile communication network. The communication network 150 may comprise, for example, a PLMN operated/managed/run by a network operator. The communication network 150 may comprise one or more of: a CN 152 (e.g., a 5G core network (5G-CN)), a RAN 154 (e.g., an NG-RAN), and/or wireless devices 156A and 156B (collectively wireless device(s) 156). The communication network 150 may comprise, and/or a device within the communication network 150 may communicate with (e.g., via CN 152), one or more data networks (DN(s)) 170. These components may be implemented and operate in substantially the same or similar manner as corresponding components described with respect to FIG. 1A.

The CN 152 (e.g., 5G-CN) may provide/configure the wireless device(s) 156 with one or more interfaces to the one or more DNs 170. The wireless device(s) 156 may communicate with the one or more DNs 170, such as public DNS (e.g., the Internet), private DNs, and/or intra-operator DNs. As part of the interface functionality, the CN 152 (e.g., 5G-CN) may set up end-to-end connections between the wireless device(s) 156 and the one or more DNs 170, authenticate the wireless device(s) 156, and/or provide/configure charging functionality. The CN 152 (e.g., the 5G-CN) may be a service-based architecture, which may differ from other CNs (e.g., such as a 3GPP 4G CN). The architecture of nodes of the CN 152 (e.g., 5G-CN) may be defined as network functions that offer services via interfaces to other network functions. The network functions of the CN 152 (e.g., 5G-CN) may be implemented in several ways, for example, as network elements on dedicated or shared hardware, as software instances running on dedicated or shared hardware, and/or as virtualized functions instantiated on a platform (e.g., a cloud-based platform).

The CN 152 (e.g., 5G-CN) may comprise an Access and Mobility Management Function (AMF) device 158A and/or a User Plane Function (UPF) device 158B, which may be separate components or one component AMF/UPF device 158. The UPF device 158B may serve as a gateway between the RAN 154 (e.g., NG-RAN) and the one or more DNs 170. The UPF device 158B may perform functions, such as: packet routing and forwarding, packet inspection and user plane policy rule enforcement, traffic usage reporting, uplink classification to support routing of traffic flows to the one or more DNs 170, quality of service (QOS) handling for the user plane (e.g., packet filtering, gating, uplink/downlink rate enforcement, and uplink traffic verification), downlink packet buffering, and/or downlink data notification triggering. The UPF device 158B may serve as an anchor point for intra-/inter-Radio Access Technology (RAT) mobility, an external protocol (or packet) data unit (PDU) session point of interconnect to the one or more DNs 170, and/or a branching point to support a multi-homed PDU session. The wireless device(s) 156 may be configured to receive services via a PDU session, which may be a logical connection between a wireless device and a DN.

The AMF device 158A may perform functions, such as: Non-Access Stratum (NAS) signaling termination, NAS signaling security, Access Stratum (AS) security control, inter-CN node signaling for mobility between access networks (e.g., 3GPP access networks and/or non-3GPP networks), idle mode wireless device reachability (e.g., idle mode UE reachability for control and execution of paging retransmission), registration area management, intra-system and inter-system mobility support, access authentication, access authorization including checking of roaming rights, mobility management control (e.g., subscription and policies), network slicing support, and/or session management function (SMF) selection. NAS may refer to the functionality operating between a CN and a wireless device, and AS may refer to the functionality operating between a wireless device and a RAN.

The CN 152 (e.g., 5G-CN) may comprise one or more additional network functions that may not be shown in FIG. 1B. The CN 152 (e.g., 5G-CN) may comprise one or more devices implementing at least one of: a Session Management Function (SMF), an NR Repository Function (NRF), a Policy Control Function (PCF), a Network Exposure Function (NEF), a Unified Data Management (UDM), an Application Function (AF), an Authentication Server Function (AUSF), and/or any other function.

The RAN 154 (e.g., NG-RAN) may communicate with the wireless device(s) 156 via radio communications (e.g., an over the air interface). The wireless device(s) 156 may communicate with the CN 152 via the RAN 154. The RAN 154 (e.g., NG-RAN) may comprise one or more first-type base stations (e.g., base stations/gNBs comprising a base station/gNB 160A and a base station/gNB 160B (collectively base stations/gNBs 160)) and/or one or more second-type base stations (e.g., ng-eNBs comprising an ng-cNB 162A and an ng-eNB 162B (collectively ng-eNBs 162)). The RAN 154 may comprise one or more of any quantity of types of base station. The base stations/gNBs 160 and/or ng-eNBs 162 may be referred to as base stations. The base stations (e.g., the gNBs 160 and/or ng-eNBs 162) may comprise one or more sets of antennas for communicating with the wireless device(s) 156 wirelessly (e.g., an over an air interface). One or more base stations (e.g., the gNBs 160 and/or the ng-eNBs 162) may comprise multiple sets of antennas to respectively control multiple cells (or sectors). The cells of the base stations (e.g., the gNBs 160 and/or the ng-eNBs 162) may provide a radio coverage to the wireless device(s) 156 over a wide geographic area to support wireless device mobility.

The base stations (e.g., the gNBs 160 and/or the ng-eNBs 162) may be connected to the CN 152 (e.g., 5G-CN) via a first interface (e.g., an NG interface) and to other base stations via a second interface (e.g., an Xn interface). The NG and Xn interfaces may be established using direct physical connections and/or indirect connections over an underlying transport network, such as an internet protocol (IP) transport network. The base stations (e.g., the gNBs 160 and/or the ng-eNBs 162) may communicate with the wireless device(s) 156 via a third interface (e.g., a Uu interface). A base station (e.g., the gNB 160A) may communicate with the wireless device 156A via a Uu interface. The NG, Xn, and Uu interfaces may be associated with a protocol stack. The protocol stacks associated with the interfaces may be used by the network elements shown in FIG. 1B to exchange data and signaling messages. The protocol stacks may comprise two planes: a user plane and a control plane. Any other quantity of planes may be used (e.g., in a protocol stack). The user plane may handle data of interest to a user. The control plane may handle signaling messages of interest to the network elements.

One or more base stations (e.g., the gNBs 160 and/or the ng-eNBs 162) may communicate with one or more AMF/UPF devices, such as the AMF/UPF 158, via one or more interfaces (e.g., NG interfaces). A base station (e.g., the gNB 160A) may be in communication with, and/or connected to, the UPF 158B of the AMF/UPF 158 via an NG-User plane (NG-U) interface. The NG-U interface may provide/perform delivery (e.g., non-guaranteed delivery) of user plane PDUs between a base station (e.g., the gNB 160A) and a UPF device (e.g., the UPF 158B). The base station (e.g., the gNB 160A) may be in communication with, and/or connected to, an AMF device (e.g., the AMF 158A) via an NG-Control plane (NG-C) interface. The NG-C interface may provide/perform, for example, NG interface management, wireless device context management (e.g., UE context management), wireless device mobility management (e.g., UE mobility management), transport of NAS messages, paging, PDU session management, configuration transfer, and/or warning message transmission.

A wireless device may access the base station, via an interface (e.g., Uu interface), for the user plane configuration and the control plane configuration. The base stations (e.g., gNBs 160) may provide user plane and control plane protocol terminations towards the wireless device(s) 156 via the Uu interface. A base station (e.g., the gNB 160A) may provide user plane and control plane protocol terminations toward the wireless device 156A over a Uu interface associated with a first protocol stack. A base station (e.g., the ng-eNBs 162) may provide E-UTRA user plane and control plane protocol terminations towards the wireless device(s) 156 via a Uu interface (e.g., where E-UTRA may refer to the 3GPP 4G radio-access technology). A base station (e.g., the ng-eNB 162B) may provide E-UTRA user plane and control plane protocol terminations towards the wireless device 156B via a Uu interface associated with a second protocol stack. The user plane and control plane protocol terminations may comprise, for example, NR user plane and control plane protocol terminations, 4G user plane and control plane protocol terminations, etc.

The CN 152 (e.g., 5G-CN) may be configured to handle one or more radio accesses (e.g., NR, 4G, and/or any other radio accesses). It may also be possible for an NR network/device (or any first network/device) to connect to a 4G core network/device (or any second network/device) in a non-standalone mode (e.g., non-standalone operation). In a non-standalone mode/operation, a 4G core network may be used to provide (or at least support) control-plane functionality (e.g., initial access, mobility, and/or paging). Although only one AMF/UPF 158 is shown in FIG. 1B, one or more base stations (e.g., one or more gNBs and/or one or more ng-eNBs) may be connected to multiple AMF/UPF nodes, for example, to provide redundancy and/or to load share across the multiple AMF/UPF nodes.

An interface (e.g., Uu, Xn, and/or NG interfaces) between network elements (e.g., the network elements shown in FIG. 1B) may be associated with a protocol stack that the network elements may use to exchange data and signaling messages. A protocol stack may comprise two planes: a user plane and a control plane. Any other quantity of planes may be used (e.g., in a protocol stack). The user plane may handle data associated with a user (e.g., data of interest to a user). The control plane may handle data associated with one or more network elements (e.g., signaling messages of interest to the network elements).

The communication network 100 in FIG. 1A and/or the communication network 150 in FIG. 1B may comprise any quantity/number and/or type of devices, such as, for example, computing devices, wireless devices, mobile devices, handsets, tablets, laptops, IoT devices, hotspots, cellular repeaters, computing devices, and/or, more generally, UE. Although one or more of the above types of devices may be referenced herein (e.g., UE, wireless device, computing device, etc.), it should be understood that any device herein may comprise any one or more of the above types of devices or similar devices. The communication network, and any other network referenced herein, may comprise an LTE network, a 5G network, a 6G network, a satellite network, and/or any other network for wireless communications (e.g., any 3GPP network and/or any non-3GPP network). Apparatuses, systems, and/or methods described herein may generally be described as implemented on one or more devices (e.g., wireless device, base station, eNB, gNB, computing device, etc.), in one or more networks, but it will be understood that one or more features and steps may be implemented on any device and/or in any network.

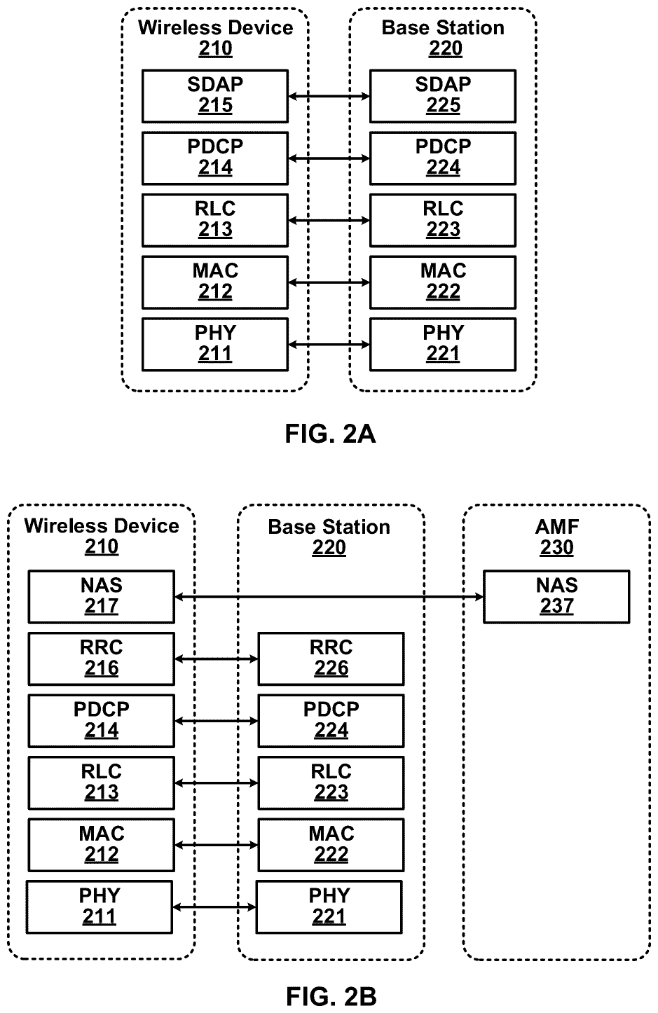

FIG. 2A shows an example user plane configuration. The user plane configuration may comprise, for example, an NR user plane protocol stack. FIG. 2B shows an example control plane configuration. The control plane configuration may comprise, for example, an NR control plane protocol stack. One or more of the user plane configurations and/or the control plane configurations may use a Uu interface that may be between a wireless device 210 and a base station 220. The protocol stacks shown in FIG. 2A and FIG. 2B may be substantially the same or similar to those used for the Uu interface between, for example, the wireless device 156A and the base station 160A shown in FIG. 1B.

A user plane configuration (e.g., an NR user plane protocol stack) may comprise multiple layers (e.g., five layers or any other quantity of layers) implemented in the wireless device 210 and the base station 220 (e.g., as shown in FIG. 2A). At the bottom of the protocol stack, physical layers (PHYs) 211 and 221 may provide transport services to the higher layers of the protocol stack and may correspond to layer 1 of the Open Systems Interconnection (OSI) model. The protocol layers above PHY 211 may comprise a medium access control layer (MAC) 212, a radio link control layer (RLC) 213, a packet data convergence protocol layer (PDCP) 214, and/or a service data application protocol layer (SDAP) 215. The protocol layers above PHY 221 may comprise a medium access control layer (MAC) 222, a radio link control layer (RLC) 223, a packet data convergence protocol layer (PDCP) 224, and/or a service data application protocol layer (SDAP) 225. One or more of the four protocol layers above PHY 211 may correspond to layer 2, or the data link layer, of the OSI model. One or more of the four protocol layers above PHY 221 may correspond to layer 2, or the data link layer, of the OSI model.

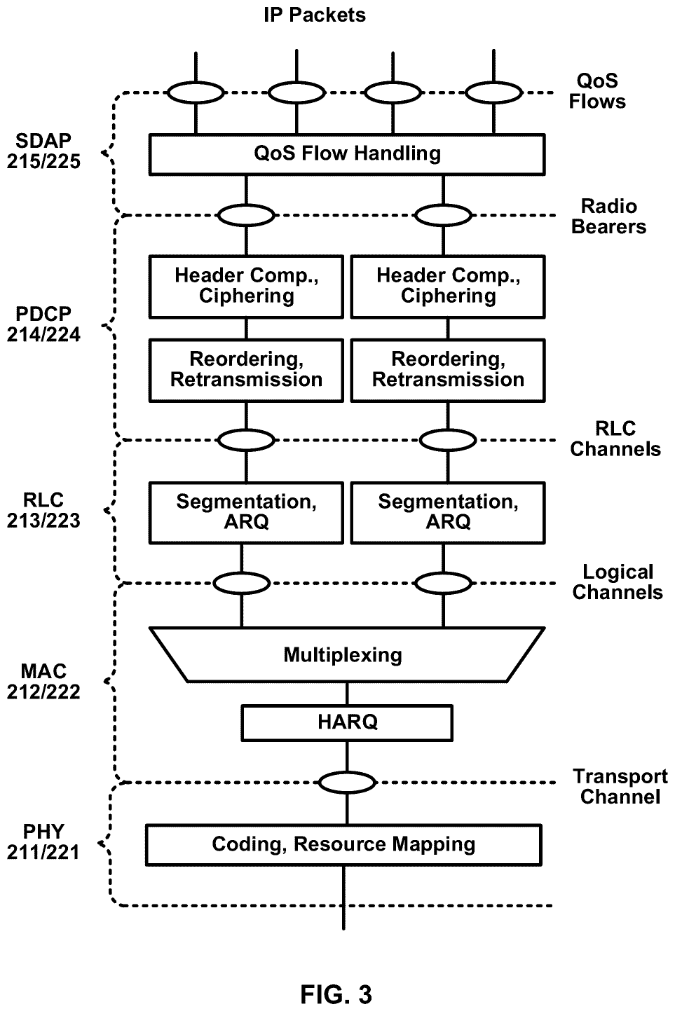

FIG. 3 shows an example of protocol layers. The protocol layers may comprise, for example, protocol layers of the NR user plane protocol stack. One or more services may be provided between protocol layers. SDAPs (e.g., SDAPS 215 and 225 shown in FIG. 2A and FIG. 3) may perform QoS flow handling. A wireless device (e.g., the wireless devices 106, 156A, 156B, and 210) may receive services through/via a PDU session, which may be a logical connection between the wireless device and a DN. The PDU session may have one or more QoS flows 310. A UPF (e.g., the UPF 158B) of a CN may map IP packets to the one or more QoS flows 310 of the PDU session, for example, based on one or more QoS requirements (e.g., in terms of delay, data rate, error rate, and/or any other quality/service requirement). The SDAPs 215 and 225 may perform mapping/de-mapping between the one or more QoS flows 310 and one or more radio bearers 320 (e.g., data radio bearers). The mapping/de-mapping between the one or more QoS flows 310 and the radio bearers 320 may be determined by the SDAP 225 of the base station 220. The SDAP 215 of the wireless device 210 may be informed of the mapping between the QoS flows 310 and the radio bearers 320 via reflective mapping and/or control signaling received from the base station 220. For reflective mapping, the SDAP 225 of the base station 220 may mark the downlink packets with a QoS flow indicator (QFI), which may be monitored/detected/identified/indicated/observed by the SDAP 215 of the wireless device 210 to determine the mapping/de-mapping between the one or more QoS flows 310 and the radio bearers 320.

PDCPs (e.g., the PDCPs 214 and 224 shown in FIG. 2A and FIG. 3) may perform header compression/decompression, for example, to reduce the amount of data that may need to be transmitted (e.g., sent) over the air interface, ciphering/deciphering to prevent unauthorized decoding of data transmitted (e.g., sent) over the air interface, and/or integrity protection (e.g., to ensure control messages originate from intended sources). The PDCPs 214 and 224 may perform retransmissions of undelivered packets, in-sequence delivery and reordering of packets, and/or removal of packets received in duplicate due to, for example, a handover (e.g., an intra-gNB handover). The PDCPs 214 and 224 may perform packet duplication, for example, to improve the likelihood of the packet being received. A receiver may receive the packet in duplicate and may remove any duplicate packets. Packet duplication may be useful for certain services, such as services that require high reliability.

The PDCP layers (e.g., PDCPs 214 and 224) may perform mapping/de-mapping between a split radio bearer and RLC channels (e.g., RLC channels 330) (e.g., in a dual connectivity scenario/configuration). Dual connectivity may refer to a technique that allows a wireless device to communicate with multiple cells (e.g., two cells) or, more generally, multiple cell groups comprising: a master cell group (MCG) and a secondary cell group (SCG). A split bearer may be configured and/or used, for example, if a single radio bearer (e.g., such as one of the radio bearers provided/configured by the PDCPs 214 and 224 as a service to the SDAPs 215 and 225) is handled by cell groups in dual connectivity. The PDCPs 214 and 224 may map/de-map between the split radio bearer and RLC channels 330 belonging to the cell groups.

RLC layers (e.g., RLCs 213 and 223) may perform segmentation, retransmission via Automatic Repeat Request (ARQ), and/or removal of duplicate data units received from MAC layers (e.g., MACs 212 and 222, respectively). The RLC layers (e.g., RLCs 213 and 223) may support multiple transmission modes (e.g., three transmission modes: transparent mode (TM); unacknowledged mode (UM); and acknowledged mode (AM)). The RLC layers (e.g., RLCs 213 and 223) may perform one or more of the noted functions, for example, based on the transmission mode the RLC layer (e.g., RLCs 213 and 223) is operating. The RLC configuration may be per logical channel. The RLC configuration may not depend on numerologies and/or Transmission Time Interval (TTI) durations (or other durations). The RLC layers (e.g., RLCs 213 and 223) may provide/configure RLC channels 330 as a service to the PDCP layers (e.g., PDCPs 214 and 224, respectively), such as shown in FIG. 3.

The MAC layers (e.g., MACs 212 and 222) may perform multiplexing/demultiplexing of logical channels 340 and/or mapping between logical channels 340 and transport channels 350. The multiplexing/demultiplexing may comprise multiplexing/demultiplexing of data units/data portions, belonging to the one or more logical channels 340, into/from Transport Blocks (TBs) delivered to/from PHY layers (e.g., PHYs 211 and 221, respectively). The MAC layer of a base station (e.g., MAC 222) may be configured to perform scheduling, scheduling information reporting, and/or priority handling between wireless devices via dynamic scheduling. Scheduling may be performed by a base station (e.g., the base station 220 at the MAC 222) for downlink/or and uplink. The MAC layers (e.g., MACs 212 and 222) may be configured to perform error correction(s) via Hybrid Automatic Repeat Request (HARQ) (e.g., one HARQ entity per carrier in case of Carrier Aggregation (CA)), priority handling between logical channels 340 of the wireless device 210 via logical channel prioritization and/or padding. The MAC layers (e.g., MACs 212 and 222) may support one or more numerologies and/or transmission timings. Mapping restrictions in a logical channel prioritization may control which numerology and/or transmission timing a logical channel may use. The MAC layers (e.g., the MACs 212 and 222) may provide/configure logical channels 340 as a service to the RLC layers (e.g., the RLCs 213 and 223).

The PHY layers (e.g., PHYs 211 and 221) may perform mapping of transport channels 350 to physical channels and/or digital and analog signal processing functions, for example, for sending and/or receiving information (e.g., via an over the air interface). The digital and/or analog signal processing functions may comprise, for example, coding/decoding and/or modulation/demodulation. The PHY layers (e.g., PHYs 211 and 221) may perform multi-antenna mapping. The PHY layers (e.g., the PHYs 211 and 221) may provide/configure one or more transport channels (e.g., transport channels 350) as a service to the MAC layers (e.g., the MACs 212 and 222, respectively).

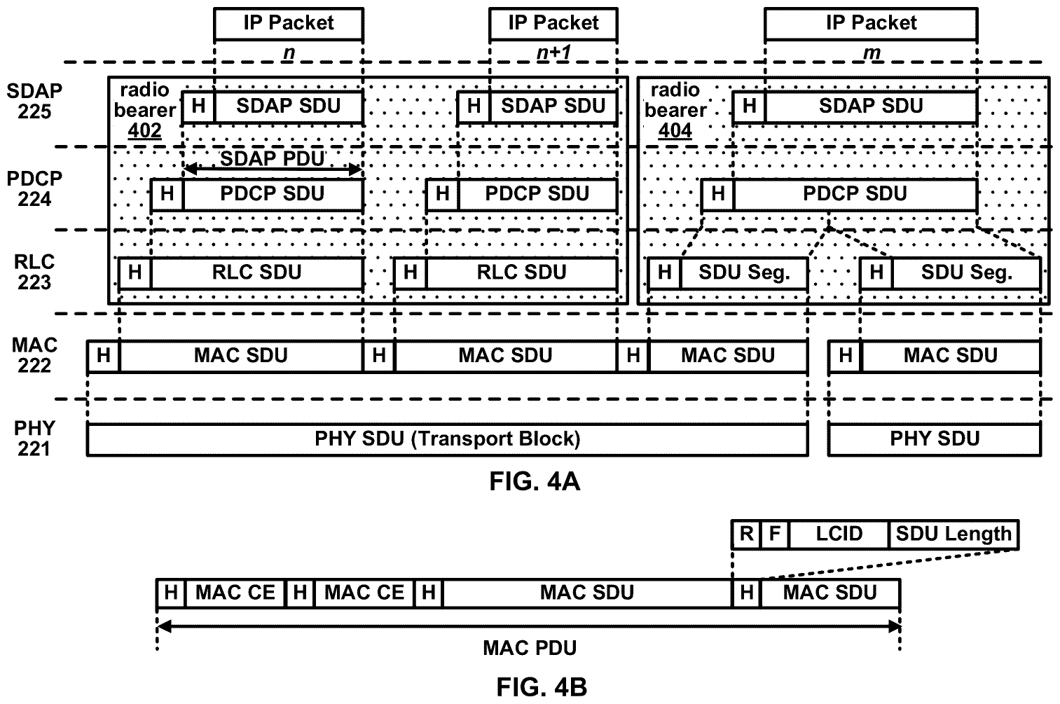

FIG. 4A shows an example downlink data flow for a user plane configuration. The user plane configuration may comprise, for example, the NR user plane protocol stack shown in FIG. 2A. One or more TBs may be generated, for example, based on a data flow via a user plane protocol stack. As shown in FIG. 4A, a downlink data flow of three IP packets (n, n+1, and m) via the NR user plane protocol stack may generate two TBs (e.g., at the base station 220). An uplink data flow via the NR user plane protocol stack may be similar to the downlink data flow shown in FIG. 4A. The three IP packets (n, n+1, and m) may be determined from the two TBs, for example, based on the uplink data flow via an NR user plane protocol stack. A first quantity of packets (e.g., three or any other quantity) may be determined from a second quantity of TBs (e.g., two or another quantity).

The downlink data flow may begin, for example, if the SDAP 225 receives the three IP packets (or other quantity of IP packets) from one or more QoS flows and maps the three packets (or other quantity of packets) to radio bearers (e.g., radio bearers 402 and 404). The SDAP 225 may map the IP packets n and n+1 to a first radio bearer 402 and map the IP packet m to a second radio bearer 404. An SDAP header (labeled with “H” preceding each SDAP SDU shown in FIG. 4A) may be added to an IP packet to generate an SDAP PDU, which may be referred to as a PDCP SDU. The data unit transferred from/to a higher protocol layer may be referred to as a service data unit (SDU) of the lower protocol layer, and the data unit transferred to/from a lower protocol layer may be referred to as a protocol data unit (PDU) of the higher protocol layer. As shown in FIG. 4A, the data unit from the SDAP 225 may be an SDU of lower protocol layer PDCP 224 (e.g., PDCP SDU) and may be a PDU of the SDAP 225 (e.g., SDAP PDU).

Each protocol layer (e.g., protocol layers shown in FIG. 4A) or at least some protocol layers may: perform its own function(s) (e.g., one or more functions of each protocol layer described with respect to FIG. 3), add a corresponding header, and/or forward a respective output to the next lower layer (e.g., its respective lower layer). The PDCP 224 may perform an IP-header compression and/or ciphering. The PDCP 224 may forward its output (e.g., a PDCP PDU, which is an RLC SDU) to the RLC 223. The RLC 223 may optionally perform segmentation (e.g., as shown for IP packet m in FIG. 4A). The RLC 223 may forward its outputs (e.g., two RLC PDUs, which are two MAC SDUs, generated by adding respective subheaders to two SDU segments (SDU Segs)) to the MAC 222. The MAC 222 may multiplex a number of RLC PDUs (MAC SDUs). The MAC 222 may attach a MAC subheader to an RLC PDU (MAC SDU) to form a TB. The MAC subheaders may be distributed across the MAC PDU (e.g., in an NR configuration as shown in FIG. 4A). The MAC subheaders may be entirely located at the beginning of a MAC PDU (e.g., in an LTE configuration). The NR MAC PDU structure may reduce a processing time and/or associated latency, for example, if the MAC PDU subheaders are computed before assembling the full MAC PDU.

FIG. 4B shows an example format of a MAC subheader in a MAC PDU. A MAC PDU may comprise a MAC subheader (H) and a MAC SDU. Each of one or more MAC subheaders may comprise an SDU length field for indicating the length (e.g., in bytes) of the MAC SDU to which the MAC subheader corresponds; a logical channel identifier (LCID) field for identifying/indicating the logical channel from which the MAC SDU originated to aid in the demultiplexing process; a flag (F) for indicating the size of the SDU length field; and a reserved bit (R) field for future use.

One or more MAC control elements (CEs) may be added to, or inserted into, the MAC PDU by a MAC layer, such as MAC 212 or MAC 222. As shown in FIG. 4B, two MAC CEs may be inserted into/added to the MAC PDU. The MAC CEs may be inserted/added at the beginning of a MAC PDU for downlink transmissions (as shown in FIG. 4B). One or more MAC CEs may be inserted/added at the end of a MAC PDU for uplink transmissions. MAC CEs may be used for in band control signaling. Example MAC CEs may comprise scheduling-related MAC CEs, such as buffer status reports and power headroom reports; activation/deactivation MAC CEs (e.g., MAC CEs for activation/deactivation of PDCP duplication detection, channel state information (CSI) reporting, sounding reference signal (SRS) transmission, and prior configured components); discontinuous reception (DRX)-related MAC CEs; timing advance MAC CEs; and random access-related MAC CEs. A MAC CE may be preceded by a MAC subheader with a similar format as described for the MAC subheader for MAC SDUs and may be identified with a reserved value in the LCID field that indicates the type of control information included in the corresponding MAC CE.

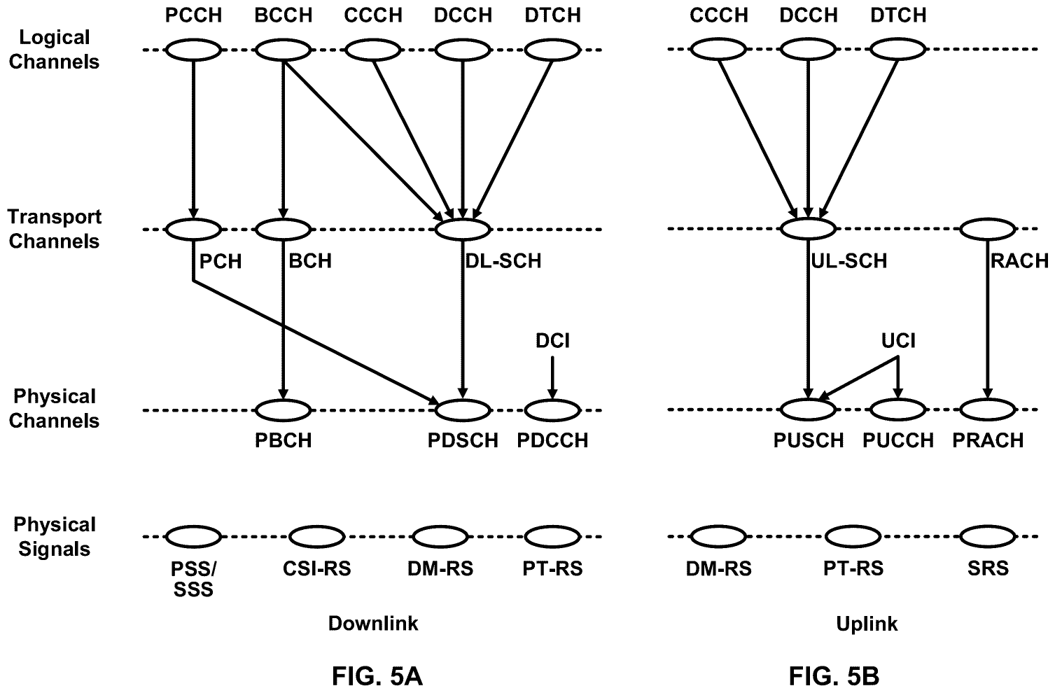

FIG. 5A shows an example mapping for downlink channels. The mapping for downlink channels may comprise mapping between channels (e.g., logical channels, transport channels, and physical channels) for downlink. FIG. 5B shows an example mapping for uplink channels. The mapping for uplink channels may comprise mapping between channels (e.g., logical channels, transport channels, and physical channels) for uplink.

Information may be passed through/via channels between the RLC, the MAC, and the PHY layers of a protocol stack (e.g., the NR protocol stack). A logical channel may be used between the RLC and the MAC layers. The logical channel may be classified/indicated as a control channel that may carry control and/or configuration information (e.g., in the NR control plane), or as a traffic channel that may carry data (e.g., in the NR user plane). A logical channel may be classified/indicated as a dedicated logical channel that may be dedicated to a specific wireless device, and/or as a common logical channel that may be used by more than one wireless device (e.g., a group of wireless devices).

A logical channel may be defined by the type of information it carries. The set of logical channels (e.g., in an NR configuration) may comprise one or more channels described below. A paging control channel (PCCH) may comprise/carry one or more paging messages used to page a wireless device whose location is not known to the network on a cell level. A broadcast control channel (BCCH) may comprise/carry system information messages in the form of a master information block (MIB) and several system information blocks (SIBs). The system information messages may be used by wireless devices to obtain information about how a cell is configured and how to operate within the cell. A common control channel (CCCH) may comprise/carry control messages together with random access. A dedicated control channel (DCCH) may comprise/carry control messages to/from a specific wireless device to configure the wireless device with configuration information. A dedicated traffic channel (DTCH) may comprise/carry user data to/from a specific wireless device.

Transport channels may be used between the MAC and PHY layers. Transport channels may be defined by how the information they carry is sent/transmitted (e.g., via an over the air interface). The set of transport channels (e.g., that may be defined by an NR configuration or any other configuration) may comprise one or more of the following channels. A paging channel (PCH) may comprise/carry paging messages that originated from the PCCH. A broadcast channel (BCH) may comprise/carry the MIB from the BCCH. A downlink shared channel (DL-SCH) may comprise/carry downlink data and signaling messages, including the SIBs from the BCCH. An uplink shared channel (UL-SCH) may comprise/carry uplink data and signaling messages. A random access channel (RACH) may provide a wireless device with an access to the network without any prior scheduling.

The PHY layer may use physical channels to pass/transfer information between processing levels of the PHY layer. A physical channel may comprise an associated set of time-frequency resources for carrying the information of one or more transport channels. The PHY layer may generate control information to support the low-level operation of the PHY layer. The PHY layer may provide/transfer the control information to the lower levels of the PHY layer via physical control channels (e.g., referred to as layer 1 or layer 2 (e.g., L1 or L2, Layer 1/Layer 2, L1/L2, Layer 1 or layer 2, Layer 1 or Layer 2, L½, Layer ½, layer ½, etc.) control channels). The set of physical channels and physical control channels (e.g., that may be defined by an NR configuration or any other configuration) may comprise one or more of the following channels. A physical broadcast channel (PBCH) may comprise/carry the MIB from the BCH. A physical downlink shared channel (PDSCH) may comprise/carry downlink data and signaling messages from the DL-SCH, as well as paging messages from the PCH. A physical downlink control channel (PDCCH) may comprise/carry downlink control information (DCI), which may comprise downlink scheduling commands, uplink scheduling grants, and uplink power control commands. A physical uplink shared channel (PUSCH) may comprise/carry uplink data and signaling messages from the UL-SCH and in some instances uplink control information (UCI) as described below. A physical uplink control channel (PUCCH) may comprise/carry UCI, which may comprise HARQ acknowledgments, channel quality indicators (CQI), pre-coding matrix indicators (PMI), rank indicators (RI), and scheduling requests (SR). A physical random access channel (PRACH) may be used for random access.

The PHY layer may generate physical signals to support the low-level operation of the PHY layer, which may be similar to the physical control channels. As shown in FIG. 5A and FIG. 5B, the physical layer signals (e.g., that may be defined by an NR configuration or any other configuration) may comprise primary synchronization signals (PSS), secondary synchronization signals (SSS), channel state information reference signals (CSI-RS), demodulation reference signals (DM-RS), SRS, phase-tracking reference signals (PT RS), and/or any other signals.

One or more of the channels (e.g., logical channels, transport channels, physical channels, etc.) may be used to carry out functions associated with the control plane protocol stack (e.g., NR control plane protocol stack). FIG. 2B shows an example control plane configuration (e.g., an NR control plane protocol stack). As shown in FIG. 2B, the control plane configuration (e.g., the NR control plane protocol stack) may use substantially the same/similar one or more protocol layers (e.g., PHYs 211 and 221, MACs 212 and 222, RLCs 213 and 223, and PDCPs 214 and 224) as the example user plane configuration (e.g., the NR user plane protocol stack). Similar four protocol layers may comprise the PHYs 211 and 221, the MACs 212 and 222, the RLCs 213 and 223, and the PDCPs 214 and 224. The control plane configuration (e.g., the NR control plane protocol stack) may have radio resource controls (RRCs) 216 and 226 and NAS protocols 217 and 237 at the top of the control plane configuration (e.g., the NR control plane protocol stack), for example, instead of having the SDAPs 215 and 225. The control plane configuration may comprise an AMF 230 comprising the NAS protocol 237.

The NAS protocols 217 and 237 may provide control plane functionality between the wireless device 210 and the AMF 230 (e.g., the AMF 158A or any other AMF) and/or, more generally, between the wireless device 210 and a CN (e.g., the CN 152 or any other CN). The NAS protocols 217 and 237 may provide control plane functionality between the wireless device 210 and the AMF 230 via signaling messages, referred to as NAS messages. There may be no direct path between the wireless device 210 and the AMF 230 via which the NAS messages may be transported. The NAS messages may be transported using the AS of the Uu and NG interfaces. The NAS protocols 217 and 237 may provide control plane functionality, such as authentication, security, a connection setup, mobility management, session management, and/or any other functionality.

The RRCs 216 and 226 may provide/configure control plane functionality between the wireless device 210 and the base station 220 and/or, more generally, between the wireless device 210 and the RAN (e.g., the base station 220). The RRC layers 216 and 226 may provide/configure control plane functionality between the wireless device 210 and the base station 220 via signaling messages, which may be referred to as RRC messages. The RRC messages may be sent/transmitted between the wireless device 210 and the RAN (e.g., the base station 220) using signaling radio bearers and substantially the same/similar PDCP, RLC, MAC, and PHY protocol layers. The MAC layer may multiplex control-plane and user-plane data into the same TB. The RRC layers 216 and 226 may provide/configure control plane functionality, such as one or more of the following functionalities: broadcast of system information related to AS and NAS; paging initiated by the CN or the RAN; establishment, maintenance and release of an RRC connection between the wireless device 210 and the RAN (e.g., the base station 220); security functions including key management; establishment, configuration, maintenance and release of signaling radio bearers and data radio bearers; mobility functions; QoS management functions; wireless device measurement reporting and control of the reporting; detection of and recovery from radio link failure (RLF); and/or NAS message transfer. As part of establishing an RRC connection, the RRC layers 216 and 226 may establish an RRC context, which may involve configuring parameters for communication between the wireless device 210 and the RAN (e.g., the base station 220).

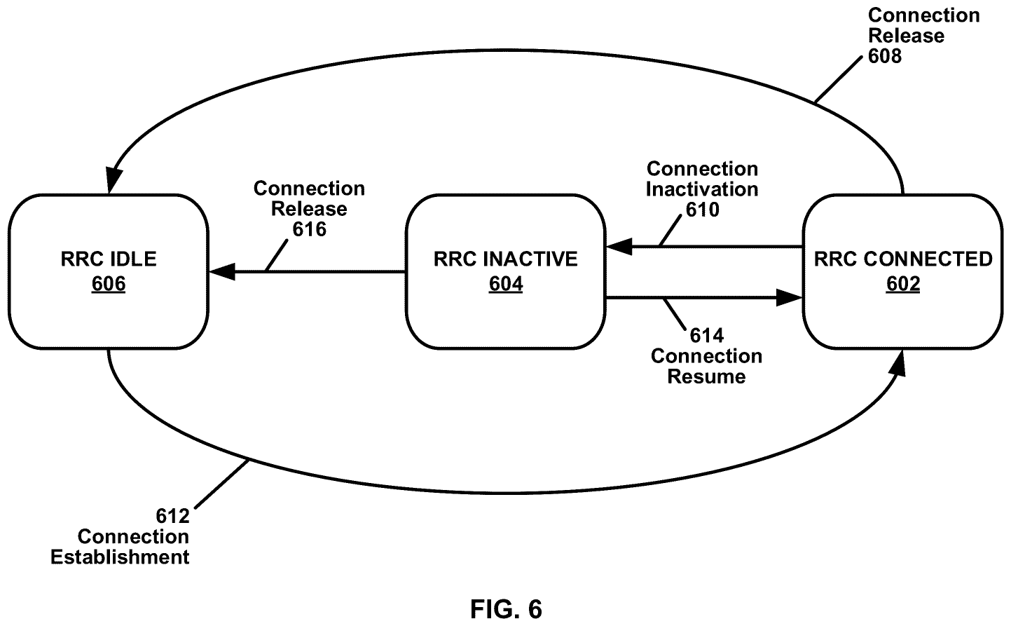

FIG. 6 shows example RRC states and RRC state transitions. An RRC state of a wireless device may be changed to another RRC state (e.g., RRC state transitions of a wireless device). The wireless device may be substantially the same or similar to the wireless device 106, 210, or any other wireless device. A wireless device may be in at least one of a plurality of states, such as three RRC states comprising RRC connected 602 (e.g., RRC_CONNECTED), RRC idle 606 (e.g., RRC_IDLE), and RRC inactive 604 (e.g., RRC_INACTIVE). The RRC inactive 604 may be RRC connected but inactive.

An RRC connection may be established for the wireless device. For example, this may be during an RRC connected state. During the RRC connected state (e.g., during the RRC connected 602), the wireless device may have an established RRC context and may have at least one RRC connection with a base station. The base station may be similar to one of the one or more base stations (e.g., one or more base stations of the RAN 104 shown in FIG. 1A, one of the base stations/gNBs 160 or ng-eNBs 162 shown in FIG. 1B, the base station 220 shown in FIG. 2A and FIG. 2B, or any other base stations). The base station with which the wireless device is connected (e.g., has established an RRC connection) may have the RRC context for the wireless device. The RRC context, which may be referred to as a wireless device context (e.g., the UE context), may comprise parameters for communication between the wireless device and the base station. These parameters may comprise, for example, one or more of: AS contexts; radio link configuration parameters; bearer configuration information (e.g., relating to a data radio bearer, a signaling radio bearer, a logical channel, a QoS flow, and/or a PDU session); security information; and/or layer configuration information (e.g., PHY, MAC, RLC, PDCP, and/or SDAP layer configuration information). During the RRC connected state (e.g., the RRC connected 602), mobility of the wireless device may be managed/controlled by an RAN (e.g., the RAN 104, the RAN 154, or any other RAN). The wireless device may measure received signal levels (e.g., reference signal levels, reference signal received power, reference signal received quality, received signal strength indicator, etc.) based on one or more signals sent from a serving cell and neighboring cells. The wireless device may report these measurements to a serving base station (e.g., the base station currently serving the wireless device). The serving base station of the wireless device may request a handover to a cell of one of the neighboring base stations, for example, based on the reported measurements. The RRC state may transition from the RRC connected state (e.g., the RRC connected 602) to an RRC idle state (e.g., the RRC idle 606) via a connection release procedure 608. The RRC state may transition from the RRC connected state (e.g., the RRC connected 602) to the RRC inactive state (e.g., the RRC inactive 604) via a connection inactivation procedure 610.

An RRC context may not be established for the wireless device. For example, this may be during the RRC idle state. During the RRC idle state (e.g., the RRC idle 606), an RRC context may not be established for the wireless device. During the RRC idle state (e.g., the RRC idle 606), the wireless device may not have an RRC connection with the base station. During the RRC idle state (e.g., the RRC idle 606), the wireless device may be in a sleep state for the majority of the time (e.g., to conserve battery power). The wireless device may wake up periodically (e.g., one time in every DRX cycle) to monitor for paging messages (e.g., paging messages set from the RAN). Mobility of the wireless device may be managed by the wireless device via a procedure of a cell reselection. The RRC state may transition from the RRC idle state (e.g., the RRC idle 606) to the RRC connected state (e.g., the RRC connected 602) via a connection establishment procedure 612, which may involve a random access procedure.

A previously established RRC context may be maintained for the wireless device. For example, this may be during the RRC inactive state. During the RRC inactive state (e.g., the RRC inactive 604), the RRC context previously established may be maintained in the wireless device and the base station. The maintenance of the RRC context may enable/allow a fast transition to the RRC connected state (e.g., the RRC connected 602) with reduced signaling overhead as compared to the transition from the RRC idle state (e.g., the RRC idle 606) to the RRC connected state (e.g., the RRC connected 602). During the RRC inactive state (e.g., the RRC inactive 604), the wireless device may be in a sleep state and mobility of the wireless device may be managed/controlled by the wireless device via a cell reselection. The RRC state may transition from the RRC inactive state (e.g., the RRC inactive 604) to the RRC connected state (e.g., the RRC connected 602) via a connection resume procedure 614.

The RRC state may transition from the RRC inactive state (e.g., the RRC inactive 604) to the RRC idle state (e.g., the RRC idle 606) via a connection release procedure 616 that may be substantially the same as or similar to connection release procedure 608.

An RRC state may be associated with a mobility management mechanism. During the RRC idle state (e.g., the RRC idle 606) and the RRC inactive state (e.g., the RRC inactive 604), mobility may be managed/controlled by the wireless device via a cell reselection. The purpose of mobility management during the RRC idle state (e.g., the RRC idle 606) or during the RRC inactive state (e.g., the RRC inactive 604) may be to enable/allow the network to be able to notify the wireless device of an event via a paging message without having to broadcast the paging message over the entire mobile communications network. The mobility management mechanism used during the RRC idle state (e.g., the RRC idle 606) or during the RRC inactive state (e.g., the RRC inactive 604) may enable/allow the network to track the wireless device on a cell-group level, for example, so that the paging message may be broadcast over the cells of the cell group that the wireless device currently resides within (e.g. instead of sending the paging message over the entire mobile communication network). The mobility management mechanisms for the RRC idle state (e.g., the RRC idle 606) and the RRC inactive state (e.g., the RRC inactive 604) may track the wireless device on a cell-group level. The mobility management mechanisms may do the tracking, for example, using different granularities of grouping. There may be a plurality of levels of cell-grouping granularity (e.g., three levels of cell-grouping granularity: individual cells; cells within a RAN area identified by a RAN area identifier (RAI); and cells within a group of RAN areas, referred to as a tracking area and identified by a tracking area identifier (TAI)).

Tracking areas may be used to track the wireless device (e.g., tracking the location of the wireless device at the CN level). The CN (e.g., the CN 102, the CN 152, or any other CN) may send to the wireless device a list of TAIs associated with a wireless device registration area (e.g., a UE registration area). A wireless device may perform a registration update with the CN to allow the CN to update the location of the wireless device and provide the wireless device with a new the wireless device registration area, for example, if the wireless device moves (e.g., via a cell reselection) to a cell associated with a TAI that may not be included in the list of TAIs associated with the wireless device registration area.

RAN areas may be used to track the wireless device (e.g., the location of the wireless device at the RAN level). For a wireless device in an RRC inactive state (e.g., the RRC inactive 604), the wireless device may be assigned/provided/configured with a RAN notification area. A RAN notification area may comprise one or more cell identities (e.g., a list of RAIs and/or a list of TAIs). A base station may belong to one or more RAN notification areas. A cell may belong to one or more RAN notification areas. A wireless device may perform a notification area update with the RAN to update the RAN notification area of the wireless device, for example, if the wireless device moves (e.g., via a cell reselection) to a cell not included in the RAN notification area assigned/provided/configured to the wireless device.

A base station storing an RRC context for a wireless device or a last serving base station of the wireless device may be referred to as an anchor base station. An anchor base station may maintain an RRC context for the wireless device at least during a period of time that the wireless device stays in a RAN notification area of the anchor base station and/or during a period of time that the wireless device stays in an RRC inactive state (e.g., the RRC inactive 604).

A base station (e.g., the gNBs 160 in FIG. 1B or any other base station) may be split into two parts: a central unit (e.g., a base station central unit, such as a gNB-CU) and one or more distributed units (e.g., a base station distributed unit, such as a gNB-DU). A base station central unit (CU) may be coupled to one or more base station distributed units (DUs) using an F1 interface (e.g., an F1 interface defined in an NR configuration). The base station CU may comprise the RRC, the PDCP, and the SDAP layers. A base station distributed unit (DU) may comprise the RLC, the MAC, and the PHY layers.

The physical signals and physical channels (e.g., described with respect to FIG. 5A and FIG. 5B) may be mapped onto one or more symbols (e.g., orthogonal frequency divisional multiplexing (OFDM) symbols in an NR configuration or any other symbols). OFDM may be a multicarrier communication scheme that sends/transmits data over F orthogonal subcarriers (or tones). The data may be mapped to a series of complex symbols (e.g., M-quadrature amplitude modulation (M-QAM) symbols or M-phase shift keying (M PSK) symbols or any other modulated symbols), referred to as source symbols, and divided into F parallel symbol streams, for example, before transmission of the data. The F parallel symbol streams may be treated as if they are in the frequency domain. The F parallel symbol streams may be used as inputs to an Inverse Fast Fourier Transform (IFFT) block that transforms them into the time domain. The IFFT block may take in F source symbols at a time, one from each of the F parallel symbol streams. The IFFT block may use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. An OFDM symbol provided/output by the IFFT block may be sent/transmitted over the air interface on a carrier frequency, for example, after one or more processes (e.g., addition of a cyclic prefix) and up-conversion. The F parallel symbol streams may be mixed, for example, using a Fast Fourier Transform (FFT) block before being processed by the IFFT block. This operation may produce Discrete Fourier Transform (DFT)-precoded OFDM symbols and may be used by one or more wireless devices in the uplink to reduce the peak to average power ratio (PAPR). Inverse processing may be performed on the OFDM symbol at a receiver using an FFT block to recover the data mapped to the source symbols.

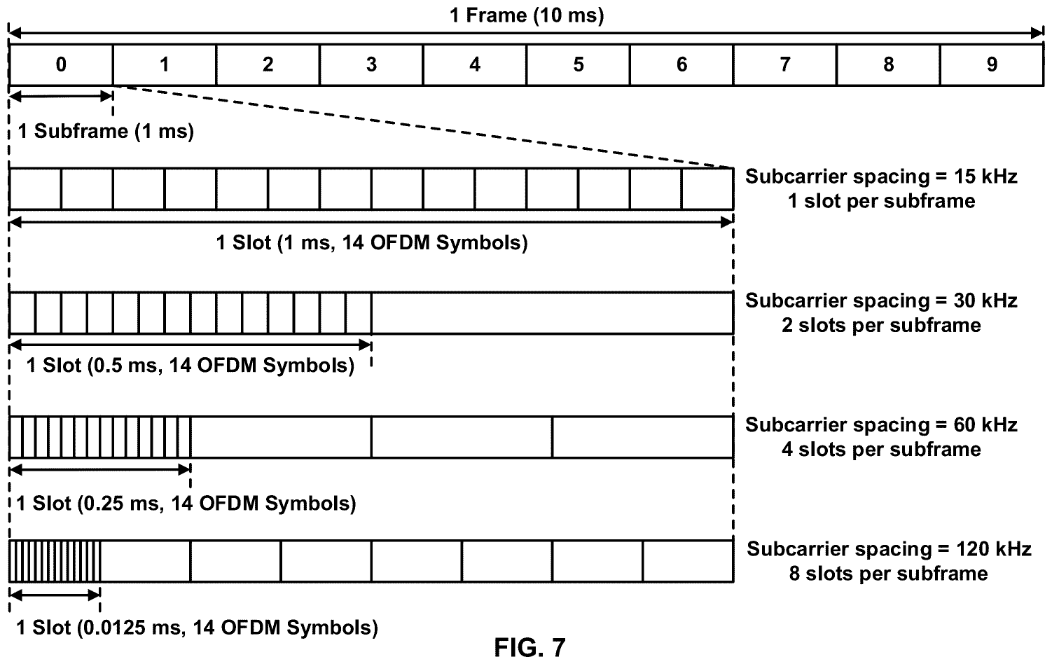

FIG. 7 shows an example configuration of a frame. The frame may comprise, for example, an NR radio frame into which OFDM symbols may be grouped. A frame (e.g., an NR radio frame) may be identified/indicated by a system frame number (SFN) or any other value. The SFN may repeat with a period of 1024 frames. One NR radio frame may be 10 milliseconds (ms) in duration and may comprise 10 subframes that are 1 ms in duration. A subframe may be divided into one or more slots (e.g., depending on numerologies and/or different subcarrier spacings). Each of the one or more slots may comprise, for example, 14 OFDM symbols per slot. Any quantity of symbols, slots, or duration may be used for any time interval.

The duration of a slot may depend on the numerology used for the OFDM symbols of the slot. A flexible numerology may be supported, for example, to accommodate different deployments (e.g., cells with carrier frequencies below 1 GHz up to cells with carrier frequencies in the mm-wave range). A flexible numerology may be supported, for example, in an NR configuration or any other radio configurations. A numerology may be defined in terms of subcarrier spacing and/or cyclic prefix duration. Subcarrier spacings may be scaled up by powers of two from a baseline subcarrier spacing of 15 kHz. Cyclic prefix durations may be scaled down by powers of two from a baseline cyclic prefix duration of 4.7 μs, for example, for a numerology in an NR configuration or any other radio configurations. Numerologies may be defined with the following subcarrier spacing/cyclic prefix duration combinations: 15 kHz/4.7 μs; 30 kHz/2.3 μs; 60 kHz/1.2 μs; 120 kHz/0.59 μs; 240 kHz/0.29 μs, and/or any other subcarrier spacing/cyclic prefix duration combinations.

A slot may have a fixed number/quantity of OFDM symbols (e.g., 14 OFDM symbols). A numerology with a higher subcarrier spacing may have a shorter slot duration and more slots per subframe. Examples of numerology-dependent slot duration and slots-per-subframe transmission structure are shown in FIG. 7 (the numerology with a subcarrier spacing of 240 kHz is not shown in FIG. 7). A subframe (e.g., in an NR configuration) may be used as a numerology-independent time reference. A slot may be used as the unit upon which uplink and downlink transmissions are scheduled. Scheduling (e.g., in an NR configuration) may be decoupled from the slot duration. Scheduling may start at any OFDM symbol. Scheduling may last for as many symbols as needed for a transmission, for example, to support low latency. These partial slot transmissions may be referred to as mini-slot or sub-slot transmissions.

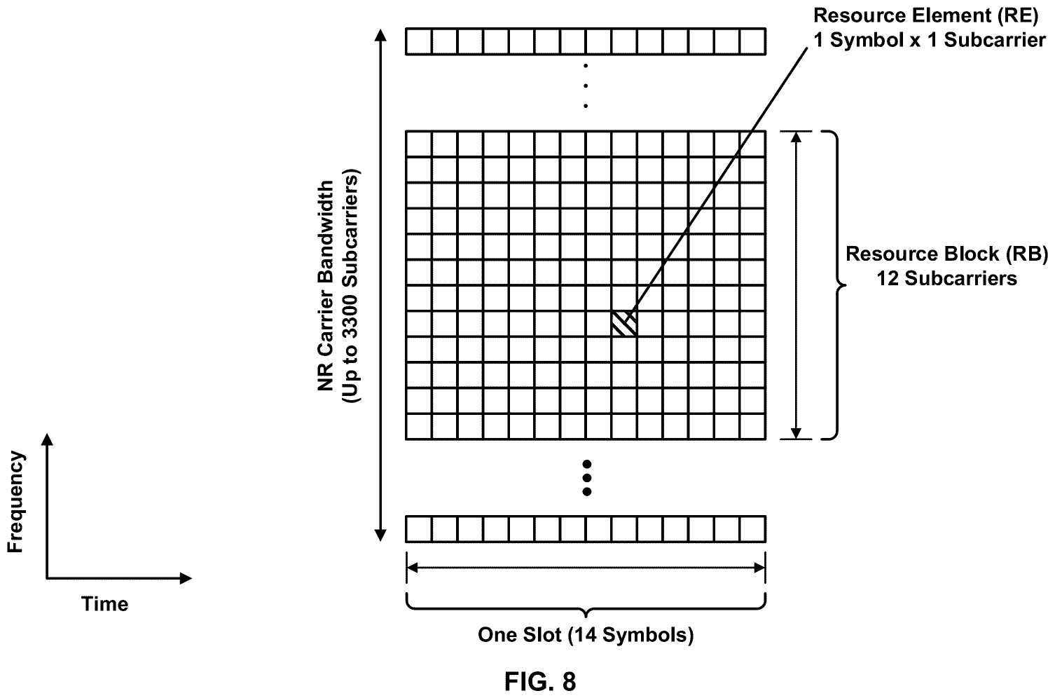

FIG. 8 shows an example resource configuration of one or more carriers. The resource configuration may comprise a slot in the time and frequency domain for an NR carrier or any other carrier. The slot may comprise resource elements (REs) and resource blocks (RBs). A resource element (RE) may be the smallest physical resource (e.g., in an NR configuration). An RE may span one OFDM symbol in the time domain by one subcarrier in the frequency domain, such as shown in FIG. 8. An RB may span twelve consecutive REs in the frequency domain, such as shown in FIG. 8. A carrier (e.g., an NR carrier) may be limited to a width of a certain quantity of RBs and/or subcarriers (e.g., 275 RBs or 275×12=3300 subcarriers). Such limitation(s), if used, may limit the carrier (e.g., NR carrier) frequency based on subcarrier spacing (e.g., carrier frequency of 50, 100, 200, and 400 MHZ for subcarrier spacings of 15, 30, 60, and 120 kHz, respectively). A 400 MHz bandwidth may be set based on a 400 MHz per carrier bandwidth limit. Any other bandwidth may be set based on a per carrier bandwidth limit.

A single numerology may be used across the entire bandwidth of a carrier (e.g., an NR carrier such as shown in FIG. 8). In other example configurations, multiple numerologies may be supported on the same carrier. NR and/or other access technologies may support wide carrier bandwidths (e.g., up to 400 MHz for a subcarrier spacing of 120 kHz). Not all wireless devices may be able to receive the full carrier bandwidth (e.g., due to hardware limitations and/or different wireless device capabilities). Receiving and/or utilizing the full carrier bandwidth may be prohibitive, for example, in terms of wireless device power consumption. A wireless device may adapt the size of the receive bandwidth of the wireless device, for example, based on the amount of traffic the wireless device is scheduled to receive (e.g., to reduce power consumption and/or for other purposes). Such an adaptation may be referred to as bandwidth adaptation.

Configuration of one or more bandwidth parts (BWPs) may support one or more wireless devices not capable of receiving the full carrier bandwidth. BWPs may support bandwidth adaptation, for example, for such wireless devices not capable of receiving the full carrier bandwidth. A BWP (e.g., a BWP of an NR configuration) may be defined by a subset of contiguous RBs on a carrier. A wireless device may be configured (e.g., via an RRC layer) with one or more downlink BWPs per serving cell and one or more uplink BWPs per serving cell (e.g., up to four downlink BWPs per serving cell and up to four uplink BWPs per serving cell). One or more of the configured BWPs for a serving cell may be active, for example, at a given time. The one or more BWPs may be referred to as active BWPs of the serving cell. A serving cell may have one or more first active BWPs in the uplink carrier and one or more second active BWPs in the secondary uplink carrier, for example, if the serving cell is configured with a secondary uplink carrier.

A downlink BWP from a set of configured downlink BWPs may be linked with an uplink BWP from a set of configured uplink BWPs (e.g., for unpaired spectra). A downlink BWP and an uplink BWP may be linked, for example, if a downlink BWP index of the downlink BWP and an uplink BWP index of the uplink BWP are the same. A wireless device may expect that the center frequency for a downlink BWP is the same as the center frequency for an uplink BWP (e.g., for unpaired spectra).

A base station may configure a wireless device with one or more control resource sets (CORESETs) for at least one search space. The base station may configure the wireless device with one or more CORESETS, for example, for a downlink BWP in a set of configured downlink BWPs on a primary cell (PCell) or on a secondary cell (SCell). A search space may comprise a set of locations in the time and frequency domains where the wireless device may monitor/find/detect/identify control information. The search space may be a wireless device-specific search space (e.g., a UE-specific search space) or a common search space (e.g., potentially usable by a plurality of wireless devices or a group of wireless user devices). A base station may configure a group of wireless devices with a common search space, on a PCell or on a primary secondary cell (PSCell), in an active downlink BWP.

A base station may configure a wireless device with one or more resource sets for one or more PUCCH transmissions, for example, for an uplink BWP in a set of configured uplink BWPs. A wireless device may receive downlink receptions (e.g., PDCCH or PDSCH) in a downlink BWP, for example, according to a configured numerology (e.g., a configured subcarrier spacing and/or a configured cyclic prefix duration) for the downlink BWP. The wireless device may send/transmit uplink transmissions (e.g., PUCCH or PUSCH) in an uplink BWP, for example, according to a configured numerology (e.g., a configured subcarrier spacing and/or a configured cyclic prefix length for the uplink BWP).

One or more BWP indicator fields may be provided/comprised in DCI. A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a wireless device with a default downlink BWP within a set of configured downlink BWPs associated with a PCell. A default downlink BWP may be an initial active downlink BWP, for example, if the base station does not provide/configure a default downlink BWP to/for the wireless device. The wireless device may determine which BWP is the initial active downlink BWP, for example, based on a CORESET configuration obtained using the PBCH.

A base station may configure a wireless device with a BWP inactivity timer value for a PCell. The wireless device may start or restart a BWP inactivity timer at any appropriate time. The wireless device may start or restart the BWP inactivity timer, for example, if one or more conditions are satisfied. The one or more conditions may comprise at least one of: the wireless device detects DCI indicating an active downlink BWP other than a default downlink BWP for a paired spectra operation; the wireless device detects DCI indicating an active downlink BWP other than a default downlink BWP for an unpaired spectra operation; and/or the wireless device detects DCI indicating an active uplink BWP other than a default uplink BWP for an unpaired spectra operation. The wireless device may start/run the BWP inactivity timer toward expiration (e.g., increment from zero to the BWP inactivity timer value, or decrement from the BWP inactivity timer value to zero), for example, if the wireless device does not detect DCI during a time interval (e.g., 1 ms or 0.5 ms). The wireless device may switch from the active downlink BWP to the default downlink BWP, for example, if the BWP inactivity timer expires.

A base station may semi-statically configure a wireless device with one or more BWPs. A wireless device may switch an active BWP from a first BWP to a second BWP, for example, based on (e.g., after or in response to) receiving DCI indicating the second BWP as an active BWP. A wireless device may switch an active BWP from a first BWP to a second BWP, for example, based on (e.g., after or in response to) an expiry of the BWP inactivity timer (e.g., if the second BWP is the default BWP).

A downlink BWP switching may refer to switching an active downlink BWP from a first downlink BWP to a second downlink BWP (e.g., the second downlink BWP is activated and the first downlink BWP is deactivated). An uplink BWP switching may refer to switching an active uplink BWP from a first uplink BWP to a second uplink BWP (e.g., the second uplink BWP is activated and the first uplink BWP is deactivated). Downlink and uplink BWP switching may be performed independently (e.g., in paired spectrum/spectra). Downlink and uplink BWP switching may be performed simultaneously (e.g., in unpaired spectrum/spectra). Switching between configured BWPs may occur, for example, based on RRC signaling, DCI signaling, expiration of a BWP inactivity timer, and/or an initiation of random access.

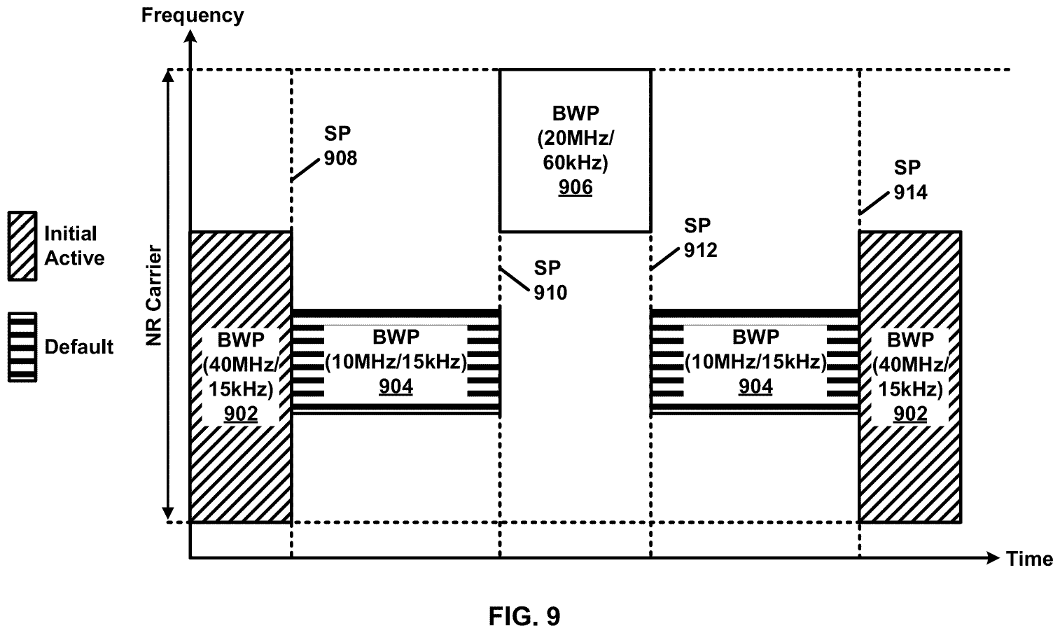

FIG. 9 shows an example of configured BWPs. Bandwidth adaptation using multiple BWPs (e.g., three configured BWPs for an NR carrier) may be available. A wireless device configured with multiple BWPs (e.g., the three BWPs) may switch from one BWP to another BWP at a switching point. The BWPs may comprise: a BWP 902 having a bandwidth of 40 MHz and a subcarrier spacing of 15 kHz; a BWP 904 having a bandwidth of 10 MHz and a subcarrier spacing of 15 kHz; and a BWP 906 having a bandwidth of 20 MHz and a subcarrier spacing of 60 kHz. The BWP 902 may be an initial active BWP, and the BWP 904 may be a default BWP. The wireless device may switch between BWPs at switching points. The wireless device may switch from the BWP 902 to the BWP 904 at a switching point 908. The switching at the switching point 908 may occur for any suitable reasons. The switching at the switching point 908 may occur, for example, based on (e.g., after or in response to) an expiry of a BWP inactivity timer (e.g., indicating switching to the default BWP). The switching at the switching point 908 may occur, for example, based on (e.g., after or in response to) receiving DCI indicating the BWP 904 as the active BWP. The wireless device may switch at a switching point 910 from the active BWP (e.g., the BWP 904) to the BWP 906, for example, after or in response receiving DCI indicating the BWP 906 as a new active BWP. The wireless device may switch at a switching point 912 from the active BWP (e.g., the BWP 906) to the BWP 904, for example, a based on (e.g., after or in response to) an expiry of a BWP inactivity timer. The wireless device may switch at the switching point 912 from the active BWP (e.g., the BWP 906) to the BWP 904, for example, after or in response to receiving DCI indicating the BWP 904 as a new active BWP. The wireless device may switch at a switching point 914 from the active BWP (e.g., the BWP 904) to the BWP 902, for example, after or in response receiving DCI indicating the BWP 902 as a new active BWP.

Wireless device procedures for switching BWPs on a secondary cell may be substantially the same/similar as those on a primary cell, for example, if the wireless device is configured for a secondary cell with a default downlink BWP in a set of configured downlink BWPs and a timer value. The wireless device may use the timer value and the default downlink BWP for the secondary cell in substantially the same/similar manner as the wireless device uses the timer value and/or default downlink BWPs for a primary cell. The timer value (e.g., the BWP inactivity timer) may be configured per cell (e.g., for one or more BWPs), for example, via RRC signaling or any other signaling. One or more active BWPs may switch to another BWP, for example, based on an expiration of the BWP inactivity timer.

Two or more carriers may be aggregated and data may be simultaneously sent/transmitted to/from the same wireless device using carrier aggregation (CA) (e.g., to increase data rates). The aggregated carriers in CA may be referred to as component carriers (CCs). There may be a number/quantity of serving cells for the wireless device (e.g., one serving cell for a CC), for example, if CA is configured/used. The CCs may have multiple configurations in the frequency domain.

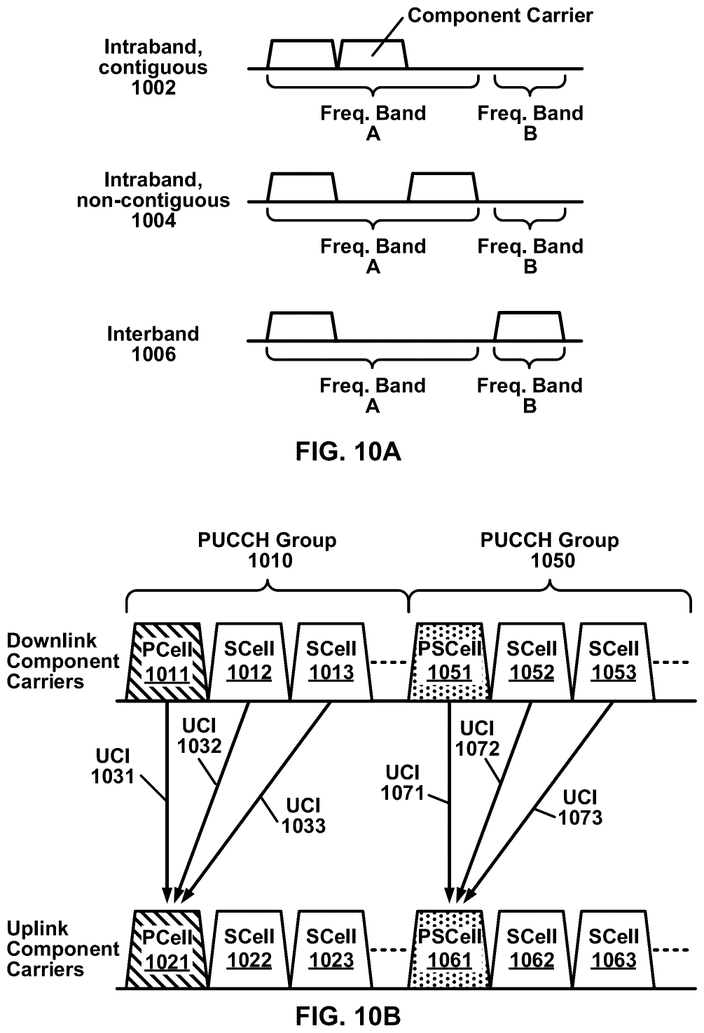

FIG. 10A shows example CA configurations based on CCs. As shown in FIG. 10A, three types of CA configurations may comprise an intraband (contiguous) configuration 1002, an intraband (non-contiguous) configuration 1004, and/or an interband configuration 1006. In the intraband (contiguous) configuration 1002, two CCs may be aggregated in the same frequency band (frequency band A) and may be located directly adjacent to each other within the frequency band. In the intraband (non-contiguous) configuration 1004, two CCs may be aggregated in the same frequency band (frequency band A) but may be separated from each other in the frequency band by a gap. In the interband configuration 1006, two CCs may be located in different frequency bands (e.g., frequency band A and frequency band B, respectively).

A network may set the maximum quantity of CCs that can be aggregated (e.g., up to 32 CCs may be aggregated in NR, or any other quantity may be aggregated in other systems). The aggregated CCs may have the same or different bandwidths, subcarrier spacing, and/or duplexing schemes (TDD, FDD, or any other duplexing schemes). A serving cell for a wireless device using CA may have a downlink CC. One or more uplink CCs may be optionally configured for a serving cell (e.g., for FDD). The ability to aggregate more downlink carriers than uplink carriers may be useful, for example, if the wireless device has more data traffic in the downlink than in the uplink.

One of the aggregated cells for a wireless device may be referred to as a primary cell (PCell), for example, if a CA is configured. The PCell may be the serving cell that the wireless initially connects to or access to, for example, during or at an RRC connection establishment, an RRC connection reestablishment, and/or a handover. The PCell may provide/configure the wireless device with NAS mobility information and the security input. Wireless devices may have different PCells. For the downlink, the carrier corresponding to the PCell may be referred to as the downlink primary CC (DL PCC). For the uplink, the carrier corresponding to the PCell may be referred to as the uplink primary CC (UL PCC). The other aggregated cells (e.g., associated with CCs other than the DL PCC and UL PCC) for the wireless device may be referred to as secondary cells (SCells). The SCells may be configured, for example, after the PCell is configured for the wireless device. An SCell may be configured via an RRC connection reconfiguration procedure. For the downlink, the carrier corresponding to an SCell may be referred to as a downlink secondary CC (DL SCC). For the uplink, the carrier corresponding to the SCell may be referred to as the uplink secondary CC (UL SCC).

Configured SCells for a wireless device may be activated or deactivated, for example, based on traffic and channel conditions. Deactivation of an SCell may cause the wireless device to stop PDCCH and PDSCH reception on the SCell and PUSCH, SRS, and CQI transmissions on the SCell. Configured SCells may be activated or deactivated, for example, using a MAC CE (e.g., the MAC CE described with respect to FIG. 4B). A MAC CE may use a bitmap (e.g., one bit per SCell) to indicate which SCells (e.g., in a subset of configured SCells) for the wireless device are activated or deactivated. Configured SCells may be deactivated, for example, based on (e.g., after or in response to) an expiration of an SCell deactivation timer (e.g., one SCell deactivation timer per SCell may be configured).

DCI may comprise control information for the downlink, such as scheduling assignments and scheduling grants, for a cell. DCI may be sent/transmitted via the cell corresponding to the scheduling assignments and/or scheduling grants, which may be referred to as a self-scheduling. DCI comprising control information for a cell may be sent/transmitted via another cell, which may be referred to as a cross-carrier scheduling. UCI may comprise control information for the uplink, such as HARQ acknowledgments and channel state feedback (e.g., CQI, PMI, and/or RI) for aggregated cells. UCI may be sent/transmitted via an uplink control channel (e.g., a PUCCH) of the PCell or a certain SCell (e.g., an SCell configured with PUCCH). For a larger number of aggregated downlink CCs, the PUCCH of the PCell may become overloaded. Cells may be divided into multiple PUCCH groups.

FIG. 10B shows example group of cells. Aggregated cells may be configured into one or more PUCCH groups (e.g., as shown in FIG. 10B). One or more cell groups or one or more uplink control channel groups (e.g., a PUCCH group 1010 and a PUCCH group 1050) may comprise one or more downlink CCs, respectively. The PUCCH group 1010 may comprise one or more downlink CCs, for example, three downlink CCs: a PCell 1011 (e.g., a DL PCC), an SCell 1012 (e.g., a DL SCC), and an SCell 1013 (e.g., a DL SCC). The PUCCH group 1050 may comprise one or more downlink CCs, for example, three downlink CCs: a PUCCH SCell (or PSCell) 1051 (e.g., a DL SCC), an SCell 1052 (e.g., a DL SCC), and an SCell 1053 (e.g., a DL SCC). One or more uplink CCs of the PUCCH group 1010 may be configured as a PCell 1021 (e.g., a UL PCC), an SCell 1022 (e.g., a UL SCC), and an SCell 1023 (e.g., a UL SCC). One or more uplink CCs of the PUCCH group 1050 may be configured as a PUCCH SCell (or PSCell) 1061 (e.g., a UL SCC), an SCell 1062 (e.g., a UL SCC), and an SCell 1063 (e.g., a UL SCC). UCI related to the downlink CCs of the PUCCH group 1010, shown as UCI 1031, UCI 1032, and UCI 1033, may be sent/transmitted via the uplink of the PCell 1021 (e.g., via the PUCCH of the PCell 1021). UCI related to the downlink CCs of the PUCCH group 1050, shown as UCI 1071, UCI 1072, and UCI 1073, may be sent/transmitted via the uplink of the PUCCH SCell (or PSCell) 1061 (e.g., via the PUCCH of the PUCCH SCell 1061). A single uplink PCell may be configured to send/transmit UCI relating to the six downlink CCs, for example, if the aggregated cells shown in FIG. 10B are not divided into the PUCCH group 1010 and the PUCCH group 1050. The PCell 1021 may become overloaded, for example, if the UCIs 1031, 1032, 1033, 1071, 1072, and 1073 are sent/transmitted via the PCell 1021. By dividing transmissions of UCI between the PCell 1021 and the PUCCH SCell (or PSCell) 1061, overloading may be prevented and/or reduced.

A PCell may comprise a downlink carrier (e.g., the PCell 1011) and an uplink carrier (e.g., the PCell 1021). An SCell may comprise only a downlink carrier. A cell, comprising a downlink carrier and optionally an uplink carrier, may be assigned with a physical cell ID and a cell index. The physical cell ID or the cell index may indicate/identify a downlink carrier and/or an uplink carrier of the cell, for example, depending on the context in which the physical cell ID is used. A physical cell ID may be determined, for example, using a synchronization signal (e.g., PSS and/or SSS) sent/transmitted via a downlink component carrier. A cell index may be determined, for example, using one or more RRC messages. A physical cell ID may be referred to as a carrier ID, and a cell index may be referred to as a carrier index. A first physical cell ID for a first downlink carrier may refer to the first physical cell ID for a cell comprising the first downlink carrier. Substantially the same/similar concept may use/apply to, for example, a carrier activation. Activation of a first carrier may refer to activation of a cell comprising the first carrier.

A multi-carrier nature of a PHY layer may be exposed/indicated to a MAC layer (e.g., in a CA configuration). A HARQ entity may operate on a serving cell. A transport block may be generated per assignment/grant per serving cell. A transport block and potential HARQ retransmissions of the transport block may be mapped to a serving cell.

For the downlink, a base station may send/transmit (e.g., unicast, multicast, and/or broadcast), to one or more wireless devices, one or more (RSs) (e.g., PSS, SSS, CSI-RS, DM-RS, and/or PT-RS). For the uplink, the one or more wireless devices may send/transmit one or more RSs to the base station (e.g., DM-RS, PT-RS, and/or SRS). The PSS and the SSS may be sent/transmitted by the base station and used by the one or more wireless devices to synchronize the one or more wireless devices with the base station. A synchronization signal (SS)/physical broadcast channel (PBCH) block may comprise the PSS, the SSS, and the PBCH. The base station may periodically send/transmit a burst of SS/PBCH blocks, which may be referred to as SSBs.

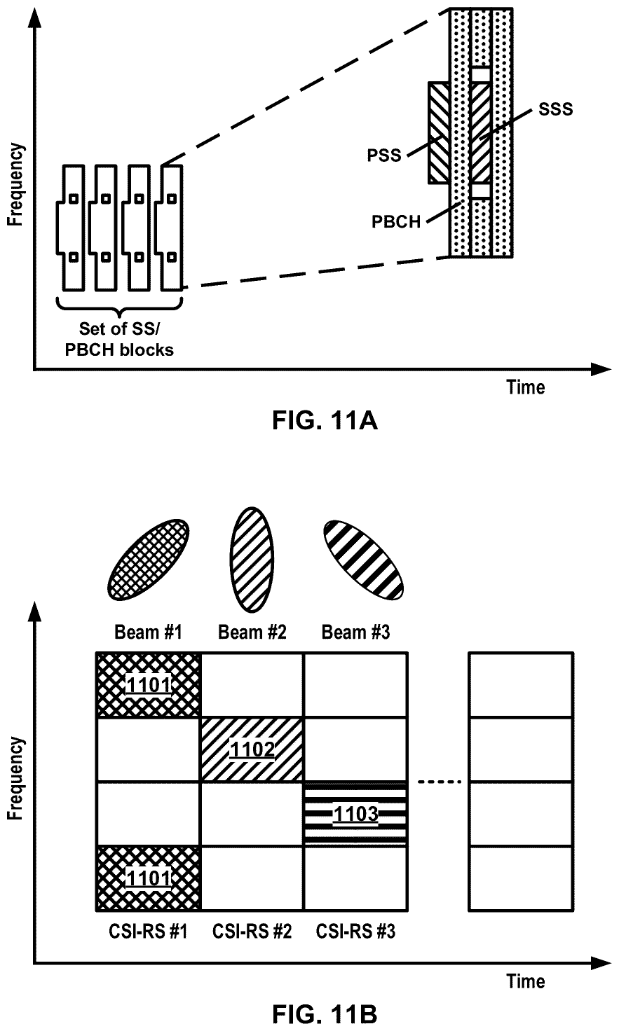

FIG. 11A shows an example mapping of one or more SS/PBCH blocks. A burst of SS/PBCH blocks may comprise one or more SS/PBCH blocks (e.g., 4 SS/PBCH blocks, as shown in FIG. 11A). Bursts may be sent/transmitted periodically (e.g., every 2 frames, 20 ms, or any other durations). A burst may be restricted to a half-frame (e.g., a first half-frame having a duration of 5 ms). Such parameters (e.g., the number of SS/PBCH blocks per burst, periodicity of bursts, position of the burst within the frame) may be configured, for example, based on at least one of: a carrier frequency of a cell in which the SS/PBCH block is sent/transmitted; a numerology or subcarrier spacing of the cell; a configuration by the network (e.g., using RRC signaling); and/or any other suitable factor(s). A wireless device may assume a subcarrier spacing for the SS/PBCH block based on the carrier frequency being monitored, for example, unless the radio network configured the wireless device to assume a different subcarrier spacing.

The SS/PBCH block may span one or more OFDM symbols in the time domain (e.g., 4 OFDM symbols, as shown in FIG. 11A or any other quantity/number of symbols) and may span one or more subcarriers in the frequency domain (e.g., 240 contiguous subcarriers or any other quantity/number of subcarriers). The PSS, the SSS, and the PBCH may have a common center frequency. The PSS may be sent/transmitted first and may span, for example, 1 OFDM symbol and 127 subcarriers. The SSS may be sent/transmitted after the PSS (e.g., two symbols later) and may span 1 OFDM symbol and 127 subcarriers. The PBCH may be sent/transmitted after the PSS (e.g., across the next 3 OFDM symbols) and may span 240 subcarriers (e.g., in the second and fourth OFDM symbols as shown in FIG. 11A) and/or may span fewer than 240 subcarriers (e.g., in the third OFDM symbols as shown in FIG. 11A).

The location of the SS/PBCH block in the time and frequency domains may not be known to the wireless device (e.g., if the wireless device is searching for the cell). The wireless device may monitor a carrier for the PSS, for example, to find and select the cell. The wireless device may monitor a frequency location within the carrier. The wireless device may search for the PSS at a different frequency location within the carrier, for example, if the PSS is not found after a certain duration (e.g., 20 ms). The wireless device may search for the PSS at a different frequency location within the carrier, for example, as indicated by a synchronization raster. The wireless device may determine the locations of the SSS and the PBCH, respectively, for example, based on a known structure of the SS/PBCH block if the PSS is found at a location in the time and frequency domains. The SS/PBCH block may be a cell-defining SS block (CD-SSB). A primary cell may be associated with a CD-SSB. The CD-SSB may be located on a synchronization raster. A cell selection/search and/or reselection may be based on the CD-SSB.

The SS/PBCH block may be used by the wireless device to determine one or more parameters of the cell. The wireless device may determine a physical cell identifier (PCI) of the cell, for example, based on the sequences of the PSS and the SSS, respectively. The wireless device may determine a location of a frame boundary of the cell, for example, based on the location of the SS/PBCH block. The SS/PBCH block may indicate that it has been sent/transmitted in accordance with a transmission pattern. An SS/PBCH block in the transmission pattern may be a known distance from the frame boundary (e.g., a predefined distance for a RAN configuration among one or more networks, one or more base stations, and one or more wireless devices).

The PBCH may use a QPSK modulation and/or forward error correction (FEC). The FEC may use polar coding. One or more symbols spanned by the PBCH may comprise/carry one or more DM-RSs for demodulation of the PBCH. The PBCH may comprise an indication of a current system frame number (SFN) of the cell and/or a SS/PBCH block timing index. These parameters may facilitate time synchronization of the wireless device to the base station. The PBCH may comprise a MIB used to send/transmit to the wireless device one or more parameters. The MIB may be used by the wireless device to locate remaining minimum system information (RMSI) associated with the cell. The RMSI may comprise a System Information Block Type 1 (SIB1). The SIB1 may comprise information for the wireless device to access the cell. The wireless device may use one or more parameters of the MIB to monitor a PDCCH, which may be used to schedule a PDSCH. The PDSCH may comprise the SIB1. The SIB1 may be decoded using parameters provided/comprised in the MIB. The PBCH may indicate an absence of SIB1. The wireless device may be pointed to a frequency, for example, based on the PBCH indicating the absence of SIB1. The wireless device may search for an SS/PBCH block at the frequency to which the wireless device is pointed.

The wireless device may assume that one or more SS/PBCH blocks sent/transmitted with a same SS/PBCH block index are quasi co-located (QCLed) (e.g., having substantially the same/similar Doppler spread, Doppler shift, average gain, average delay, and/or spatial receiving (Rx) parameters). The wireless device may not assume QCL for SS/PBCH block transmissions having different SS/PBCH block indices/indexes. SS/PBCH blocks (e.g., those within a half-frame) may be sent/transmitted in spatial directions (e.g., using different beams that span a coverage area of the cell). A first SS/PBCH block may be sent/transmitted in a first spatial direction using a first beam, a second SS/PBCH block may be sent/transmitted in a second spatial direction using a second beam, a third SS/PBCH block may be sent/transmitted in a third spatial direction using a third beam, a fourth SS/PBCH block may be sent/transmitted in a fourth spatial direction using a fourth beam, etc.

A base station may send/transmit a plurality of SS/PBCH blocks, for example, within a frequency span of a carrier. A first PCI of a first SS/PBCH block of the plurality of SS/PBCH blocks may be different from a second PCI of a second SS/PBCH block of the plurality of SS/PBCH blocks. The PCIs of SS/PBCH blocks sent/transmitted in different frequency locations may be different or substantially the same.

The CSI-RS may be sent/transmitted by the base station and used by the wireless device to acquire/obtain/determine CSI. The base station may configure the wireless device with one or more CSI-RSs for channel estimation or any other suitable purpose. The base station may configure a wireless device with one or more of substantially the same/similar CSI-RSs. The wireless device may measure the one or more CSI-RSs. The wireless device may estimate a downlink channel state and/or generate a CSI report, for example, based on the measuring of the one or more downlink CSI-RSs. The wireless device may send/transmit the CSI report to the base station (e.g., based on periodic CSI reporting, semi-persistent CSI reporting, and/or aperiodic CSI reporting). The base station may use feedback provided by the wireless device (e.g., the estimated downlink channel state) to perform a link adaptation.

The base station may semi-statically configure the wireless device with one or more CSI-RS resource sets. A CSI-RS resource may be associated with a location in the time and frequency domains and a periodicity. The base station may selectively activate and/or deactivate a CSI-RS resource. The base station may indicate to the wireless device that a CSI-RS resource in the CSI-RS resource set is activated and/or deactivated.

The base station may configure the wireless device to report CSI measurements. The base station may configure the wireless device to provide CSI reports periodically, aperiodically, or semi-persistently. For periodic CSI reporting, the wireless device may be configured with a timing and/or periodicity of a plurality of CSI reports. For aperiodic CSI reporting, the base station may request a CSI report. The base station may command the wireless device to measure a configured CSI-RS resource and provide a CSI report relating to the measurement(s). For semi-persistent CSI reporting, the base station may configure the wireless device to send/transmit periodically, and selectively activate or deactivate the periodic reporting (e.g., via one or more activation/deactivation MAC CEs and/or one or more DCIs). The base station may configure the wireless device with a CSI-RS resource set and CSI reports, for example, using RRC signaling.

The CSI-RS configuration may comprise one or more parameters indicating, for example, up to 32 antenna ports (or any other quantity of antenna ports). The wireless device may be configured to use/employ the same OFDM symbols for a downlink CSI-RS and a CORESET, for example, if the downlink CSI-RS and CORESET are spatially QCLed and resource elements associated with the downlink CSI-RS are outside of the physical resource blocks (PRBs) configured for the CORESET. The wireless device may be configured to use/employ the same OFDM symbols for a downlink CSI-RS and SS/PBCH blocks, for example, if the downlink CSI-RS and SS/PBCH blocks are spatially QCLed and resource elements associated with the downlink CSI-RS are outside of PRBs configured for the SS/PBCH blocks.

Downlink DM-RSs may be sent/transmitted by a base station and received/used by a wireless device for a channel estimation. The downlink DM-RSs may be used for coherent demodulation of one or more downlink physical channels (e.g., PDSCH). A network (e.g., an NR network) may support one or more variable and/or configurable DM-RS patterns for data demodulation. At least one downlink DM-RS configuration may support a front-loaded DM-RS pattern. A front-loaded DM-RS may be mapped over one or more OFDM symbols (e.g., one or two adjacent OFDM symbols). A base station may semi-statically configure the wireless device with a number/quantity (e.g. a maximum number/quantity) of front-loaded DM-RS symbols for a PDSCH. A DM-RS configuration may support one or more DM-RS ports. A DM-RS configuration may support up to eight orthogonal downlink DM-RS ports (or any other quantity of orthogonal downlink DM-RS ports) per wireless device (e.g., for single user-MIMO). A DM-RS configuration may support up to 4 orthogonal downlink DM-RS ports (or any other quantity of orthogonal downlink DM-RS ports) per wireless device (e.g., for multiuser-MIMO). A radio network may support (e.g., at least for CP-OFDM) a common DM-RS structure for downlink and uplink. A DM-RS location, a DM-RS pattern, and/or a scrambling sequence may be substantially the same or different. The base station may send/transmit a downlink DM-RS and a corresponding PDSCH, for example, using the same precoding matrix. The wireless device may use the one or more downlink DM-RSs for coherent demodulation/channel estimation of the PDSCH.

A transmitter (e.g., a transmitter of a base station) may use a precoder matrices for a part of a transmission bandwidth. The transmitter may use a first precoder matrix for a first bandwidth and a second precoder matrix for a second bandwidth. The first precoder matrix and the second precoder matrix may be different, for example, based on the first bandwidth being different from the second bandwidth. The wireless device may assume that a same precoding matrix is used across a set of PRBs. The set of PRBs may be determined/indicated/identified/denoted as a precoding resource block group (PRG).

A PDSCH may comprise one or more layers. The wireless device may assume that at least one symbol with DM-RS is present on a layer of the one or more layers of the PDSCH. A higher layer may configure one or more DM-RSs for a PDSCH (e.g., up to 3 DMRSs for the PDSCH). Downlink PT-RS may be sent/transmitted by a base station and used by a wireless device, for example, for a phase-noise compensation. Whether a downlink PT-RS is present or not may depend on an RRC configuration. The presence and/or the pattern of the downlink PT-RS may be configured on a wireless device-specific basis, for example, using a combination of RRC signaling and/or an association with one or more parameters used/employed for other purposes (e.g., modulation and coding scheme (MCS)), which may be indicated by DCI. A dynamic presence of a downlink PT-RS, if configured, may be associated with one or more DCI parameters comprising at least MCS. A network (e.g., an NR network) may support a plurality of PT-RS densities defined in the time and/or frequency domains. A frequency domain density (if configured/present) may be associated with at least one configuration of a scheduled bandwidth. The wireless device may assume a same precoding for a DM-RS port and a PT-RS port. The quantity/number of PT-RS ports may be fewer than the quantity/number of DM-RS ports in a scheduled resource. Downlink PT-RS may be configured/allocated/confined in the scheduled time/frequency duration for the wireless device. Downlink PT-RS may be sent/transmitted via symbols, for example, to facilitate a phase tracking at the receiver.

The wireless device may send/transmit an uplink DM-RS to a base station, for example, for a channel estimation. The base station may use the uplink DM-RS for coherent demodulation of one or more uplink physical channels. The wireless device may send/transmit an uplink DM-RS with a PUSCH and/or a PUCCH. The uplink DM-RS may span a range of frequencies that is similar to a range of frequencies associated with the corresponding physical channel. The base station may configure the wireless device with one or more uplink DM-RS configurations. At least one DM-RS configuration may support a front-loaded DM-RS pattern. The front-loaded DM-RS may be mapped over one or more OFDM symbols (e.g., one or two adjacent OFDM symbols). One or more uplink DM-RSs may be configured to send/transmit at one or more symbols of a PUSCH and/or a PUCCH. The base station may semi-statically configure the wireless device with a number/quantity (e.g. the maximum number/quantity) of front-loaded DM-RS symbols for the PUSCH and/or the PUCCH, which the wireless device may use to schedule a single-symbol DM-RS and/or a double-symbol DM-RS. A network (e.g., an NR network) may support (e.g., for cyclic prefix orthogonal frequency division multiplexing (CP-OFDM)) a common DM-RS structure for downlink and uplink. A DM-RS location, a DM-RS pattern, and/or a scrambling sequence for the DM-RS may be substantially the same or different.

A PUSCH may comprise one or more layers. A wireless device may send/transmit at least one symbol with DM-RS present on a layer of the one or more layers of the PUSCH. A higher layer may configure one or more DM-RSs (e.g., up to three DMRSs) for the PUSCH. Uplink PT-RS (which may be used by a base station for a phase tracking and/or a phase-noise compensation) may or may not be present, for example, depending on an RRC configuration of the wireless device. The presence and/or the pattern of an uplink PT-RS may be configured on a wireless device-specific basis (e.g., a UE-specific basis), for example, by a combination of RRC signaling and/or one or more parameters configured/employed for other purposes (e.g., MCS), which may be indicated by DCI. A dynamic presence of an uplink PT-RS, if configured, may be associated with one or more DCI parameters comprising at least MCS. A radio network may support a plurality of uplink PT-RS densities defined in time/frequency domain. A frequency domain density (if configured/present) may be associated with at least one configuration of a scheduled bandwidth. The wireless device may assume a same precoding for a DM-RS port and a PT-RS port. A quantity/number of PT-RS ports may be less than a quantity/number of DM-RS ports in a scheduled resource. An uplink PT-RS may be configured/allocated/confined in the scheduled time/frequency duration for the wireless device.

One or more SRSs may be sent/transmitted by a wireless device to a base station, for example, for a channel state estimation to support uplink channel dependent scheduling and/or a link adaptation. SRS sent/transmitted by the wireless device may enable/allow a base station to estimate an uplink channel state at one or more frequencies. A scheduler at the base station may use/employ the estimated uplink channel state to assign one or more resource blocks for an uplink PUSCH transmission for the wireless device. The base station may semi-statically configure the wireless device with one or more SRS resource sets. For an SRS resource set, the base station may configure the wireless device with one or more SRS resources. An SRS resource set applicability may be configured, for example, by a higher layer (e.g., RRC) parameter. An SRS resource in a SRS resource set of the one or more SRS resource sets (e.g., with substantially the same/similar time domain behavior, periodic, aperiodic, and/or the like) may be sent/transmitted at a time instant (e.g., simultaneously), for example, if a higher layer parameter indicates beam management. The wireless device may send/transmit one or more SRS resources in SRS resource sets. A network (e.g., an NR network) may support aperiodic, periodic, and/or semi-persistent SRS transmissions. The wireless device may send/transmit SRS resources, for example, based on one or more trigger types. The one or more trigger types may comprise higher layer signaling (e.g., RRC) and/or one or more DCI formats. At least one DCI format may be used/employed for the wireless device to select at least one of one or more configured SRS resource sets. An SRS trigger type 0 may refer to an SRS triggered based on higher layer signaling. An SRS trigger type 1 may refer to an SRS triggered based on one or more DCI formats. The wireless device may be configured to send/transmit an SRS, for example, after a transmission of a PUSCH and a corresponding uplink DM-RS if a PUSCH and an SRS are sent/transmitted in a same slot. A base station may semi-statically configure a wireless device with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; an offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port may be determined/defined such that the channel over which a symbol on the antenna port is conveyed can be inferred from the channel over which another symbol on the same antenna port is conveyed. The receiver may infer/determine the channel (e.g., fading gain, multipath delay, and/or the like) for conveying a second symbol on an antenna port, from the channel for conveying a first symbol on the antenna port, for example, if the first symbol and the second symbol are sent/transmitted on the same antenna port. A first antenna port and a second antenna port may be referred to as QCLed, for example, if one or more large-scale properties of the channel over which a first symbol on the first antenna port is conveyed may be inferred/determined from the channel over which a second symbol on a second antenna port is conveyed. The one or more large-scale properties may comprise at least one of: a delay spread; a Doppler spread; a Doppler shift; an average gain; an average delay; and/or spatial Rx parameters.

Channels that use beamforming may require beam management. Beam management may comprise a beam measurement, a beam selection, and/or a beam indication. A beam may be associated with one or more reference signals. A beam may be identified by one or more beamformed reference signals. The wireless device may perform a downlink beam measurement, for example, based on one or more downlink reference signals (e.g., a CSI-RS) and generate a beam measurement report. The wireless device may perform the downlink beam measurement procedure, for example, after an RRC connection is set up with a base station.

FIG. 11B shows an example mapping of one or more CSI-RSs. The CSI-RSs may be mapped in the time and frequency domains. Each rectangular block shown in FIG. 11B may correspond to a RB within a bandwidth of a cell. A base station may send/transmit one or more RRC messages comprising CSI-RS resource configuration parameters indicating one or more CSI-RSs. One or more of parameters may be configured by higher layer signaling (e.g., RRC and/or MAC signaling) for a CSI-RS resource configuration. The one or more of the parameters may comprise at least one of: a CSI-RS resource configuration identity, a number of CSI-RS ports, a CSI-RS configuration (e.g., symbol and RE locations in a subframe), a CSI-RS subframe configuration (e.g., a subframe location, an offset, and periodicity in a radio frame), a CSI-RS power parameter, a CSI-RS sequence parameter, a code division multiplexing (CDM) type parameter, a frequency density, a transmission comb, QCL parameters (e.g., QCL-scramblingidentity, crs-portscount, mbsfn-subframeconfiglist, csi-rs-configZPid, qcl-csi-rs-configNZPid), and/or other radio resource parameters.

One or more beams may be configured for a wireless device in a wireless device-specific configuration. Three beams may be shown in FIG. 11B (beam #1, beam #2, and beam #3), but more or fewer beams may be configured. Beam #1 may be allocated with CSI-RS 1101 that may be sent/transmitted in one or more subcarriers in an RB of a first symbol. Beam #2 may be allocated with CSI-RS 1102 that may be sent/transmitted in one or more subcarriers in an RB of a second symbol. Beam #3 may be allocated with CSI-RS 1103 that may be sent/transmitted in one or more subcarriers in an RB of a third symbol. A base station may use other subcarriers in the same RB (e.g., those that are not used to send/transmit CSI-RS 1101) to transmit another CSI-RS associated with a beam for another wireless device, for example, by using frequency division multiplexing (FDM). Beams used for a wireless device may be configured such that beams for the wireless device use symbols different from symbols used by beams of other wireless devices, for example, by using time domain multiplexing (TDM). A wireless device may be served with beams in orthogonal symbols (e.g., no overlapping symbols), for example, by using the TDM.

CSI-RSs (e.g., CSI-RSs 1101, 1102, 1103) may be sent/transmitted by the base station and used by the wireless device for one or more measurements. The wireless device may measure a reference signal received power (RSRP) of configured CSI-RS resources. The base station may configure the wireless device with a reporting configuration, and the wireless device may report the RSRP measurements to a network (e.g., via one or more base stations) based on the reporting configuration. The base station may determine, based on the reported measurement results, one or more transmission configuration indication (TCI) states comprising a number of reference signals. The base station may indicate one or more TCI states to the wireless device (e.g., via RRC signaling, a MAC CE, and/or DCI). The wireless device may receive a downlink transmission with an Rx beam determined based on the one or more TCI states. The wireless device may or may not have a capability of beam correspondence. The wireless device may determine a spatial domain filter of a transmit (Tx) beam, for example, based on a spatial domain filter of the corresponding Rx beam, if the wireless device has the capability of beam correspondence. The wireless device may perform an uplink beam selection procedure to determine the spatial domain filter of the Tx beam, for example, if the wireless device does not have the capability of beam correspondence. The wireless device may perform the uplink beam selection procedure, for example, based on one or more SRS resources configured to the wireless device by the base station. The base station may select and indicate uplink beams for the wireless device, for example, based on measurements of the one or more SRS resources sent/transmitted by the wireless device.

A wireless device may determine/assess (e.g., measure) a channel quality of one or more beam pair links, for example, in a beam management procedure. A beam pair link may comprise a Tx beam of a base station and an Rx beam of the wireless device. The Tx beam of the base station may send/transmit a downlink signal, and the Rx beam of the wireless device may receive the downlink signal. The wireless device may send/transmit a beam measurement report, for example, based on the assessment/determination. The beam measurement report may indicate one or more beam pair quality parameters comprising at least one of: one or more beam identifications (e.g., a beam index, a reference signal index, or the like), an RSRP, a PMI, a CQI, and/or a RI.

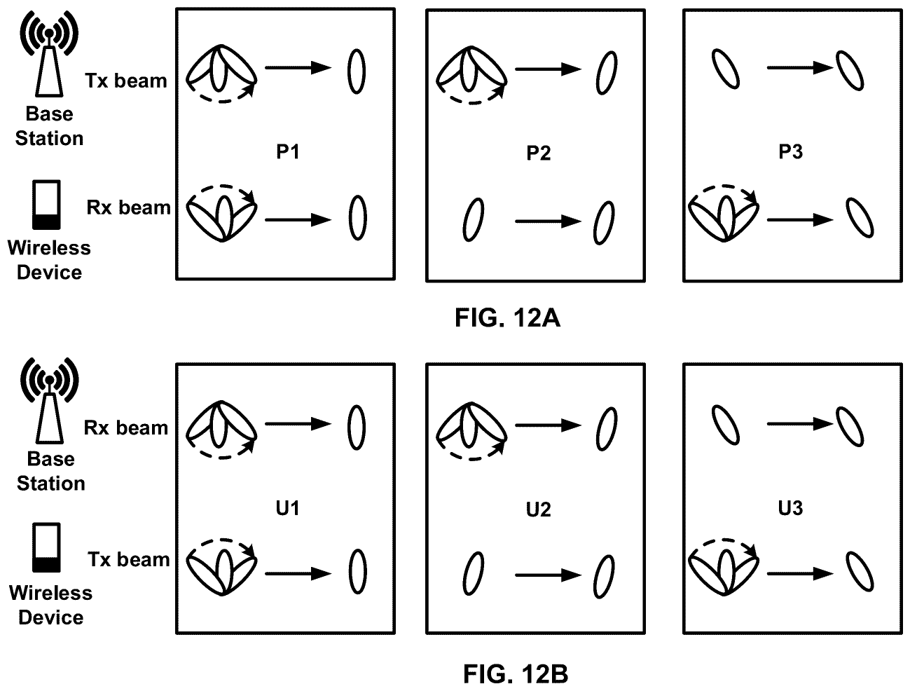

FIG. 12A shows examples of downlink beam management procedures. One or more downlink beam management procedures (e.g., downlink beam management procedures P1, P2, and P3) may be performed. Procedure P1 may enable a measurement (e.g., a wireless device measurement) on Tx beams of a TRP (or multiple TRPs) (e.g., to support a selection of one or more base station Tx beams and/or wireless device Rx beams). The Tx beams of a base station and the Rx beams of a wireless device are shown as ovals in the top row of P1 and bottom row of P1, respectively. Beamforming (e.g., at a TRP) may comprise a Tx beam sweep for a set of beams (e.g., the beam sweeps shown, in the top rows of P1 and P2, as ovals rotated in a counter-clockwise direction indicated by the dashed arrows). Beamforming (e.g., at a wireless device) may comprise an Rx beam sweep for a set of beams (e.g., the beam sweeps shown, in the bottom rows of P1 and P3, as ovals rotated in a clockwise direction indicated by the dashed arrows). Procedure P2 may be used to enable a measurement (e.g., a wireless device measurement) on Tx beams of a TRP (shown, in the top row of P2, as ovals rotated in a counter-clockwise direction indicated by the dashed arrow). The wireless device and/or the base station may perform procedure P2, for example, using a smaller set of beams than the set of beams used in procedure P1, or using narrower beams than the beams used in procedure P1. Procedure P2 may be referred to as a beam refinement. The wireless device may perform procedure P3 for an Rx beam determination, for example, by using the same Tx beam(s) of the base station and sweeping Rx beam(s) of the wireless device.

FIG. 12B shows examples of uplink beam management procedures. One or more uplink beam management procedures (e.g., uplink beam management procedures U1, U2, and U3) may be performed. Procedure U1 may be used to enable a base station to perform a measurement on Tx beams of a wireless device (e.g., to support a selection of one or more Tx beams of the wireless device and/or Rx beams of the base station). The Tx beams of the wireless device and the Rx beams of the base station are shown as ovals in the bottom row of U1 and top row of U1, respectively). Beamforming (e.g., at the wireless device) may comprise one or more beam sweeps, for example, a Tx beam sweep from a set of beams (shown, in the bottom rows of U1 and U3, as ovals rotated in a clockwise direction indicated by the dashed arrows). Beamforming (e.g., at the base station) may comprise one or more beam sweeps, for example, an Rx beam sweep from a set of beams (shown, in the top rows of U1 and U2, as ovals rotated in a counter-clockwise direction indicated by the dashed arrows). Procedure U2 may be used to enable the base station to adjust its Rx beam, for example, if the wireless device (e.g., UE) uses a fixed Tx beam. The wireless device and/or the base station may perform procedure U2, for example, using a smaller set of beams than the set of beams used in procedure P1, or using narrower beams than the beams used in procedure P1. Procedure U2 may be referred to as a beam refinement. The wireless device may perform procedure U3 to adjust its Tx beam, for example, if the base station uses a fixed Rx beam.

A wireless device may initiate/start/perform a beam failure recovery (BFR) procedure, for example, based on detecting a beam failure. The wireless device may send/transmit a BFR request (e.g., a preamble, UCI, an SR, a MAC CE, and/or the like), for example, based on the initiating the BFR procedure. The wireless device may detect the beam failure, for example, based on a determination that a quality of beam pair link(s) of an associated control channel is unsatisfactory (e.g., having an error rate higher than an error rate threshold, a received signal power lower than a received signal power threshold, an expiration of a timer, and/or the like).

The wireless device may measure a quality of a beam pair link, for example, using one or more RSs comprising one or more SS/PBCH blocks, one or more CSI-RS resources, and/or one or more DM-RSs. A quality of the beam pair link may be based on one or more of a block error rate (BLER), an RSRP value, a signal to interference plus noise ratio (SINR) value, an RSRQ value, and/or a CSI value measured on RS resources. The base station may indicate that an RS resource is QCLed with one or more DM-RSs of a channel (e.g., a control channel, a shared data channel, and/or the like). The RS resource and the one or more DM-RSs of the channel may be QCLed, for example, if the channel characteristics (e.g., Doppler shift, Doppler spread, an average delay, delay spread, a spatial Rx parameter, fading, and/or the like) from a transmission via the RS resource to the wireless device are substantially the same or similar as the channel characteristics from a transmission via the channel to the wireless device.

A network (e.g., an NR network comprising a base station/gNB and/or an ng-eNB) and/or the wireless device may initiate/start/perform a random access procedure. A wireless device in an RRC idle (e.g., an RRC_IDLE) state and/or an RRC inactive (e.g., an RRC_INACTIVE) state may initiate/perform the random access procedure to request a connection setup to a network. The wireless device may initiate/start/perform the random access procedure from an RRC connected (e.g., an RRC_CONNECTED) state. The wireless device may initiate/start/perform the random access procedure to request uplink resources (e.g., for uplink transmission of an SR if there is no PUCCH resource available) and/or acquire/obtain/determine an uplink timing (e.g., if an uplink synchronization status is non-synchronized). The wireless device may initiate/start/perform the random access procedure to request one or more SIBs (e.g., or any other system information blocks, such as SIB2, SIB3, and/or the like). The wireless device may initiate/start/perform the random access procedure for a beam failure recovery request. A network may initiate/start/perform a random access procedure, for example, for a handover and/or for establishing time alignment for an SCell addition.

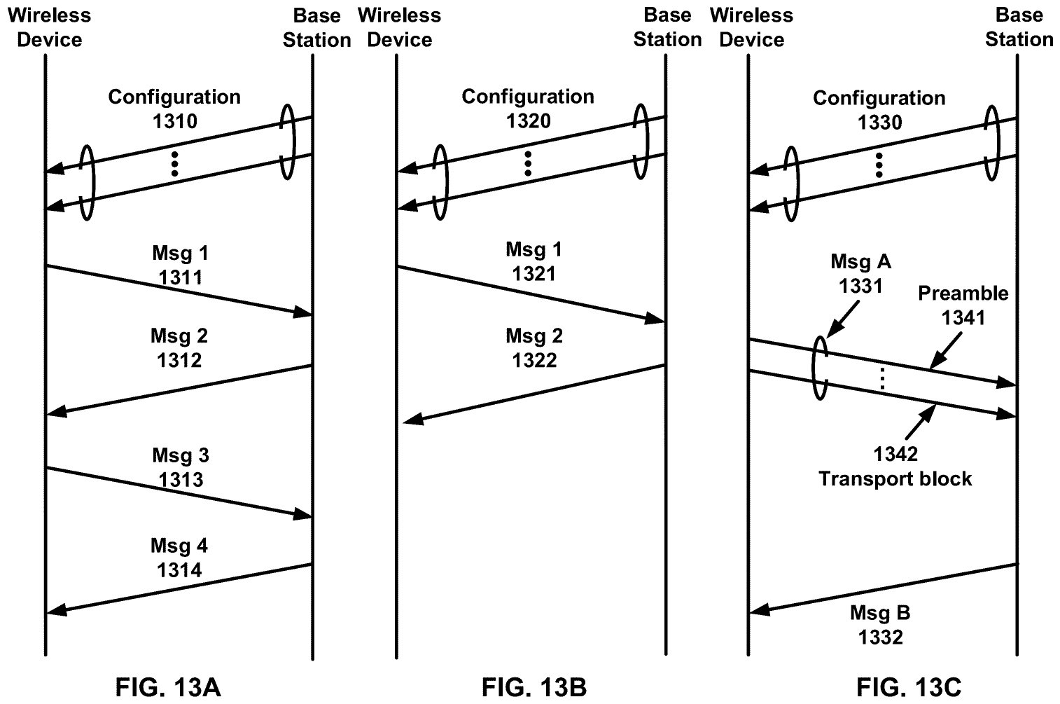

FIG. 13A shows an example four-step random access procedure. The four-step random access procedure may comprise a four-step contention-based random access procedure. A base station may send/transmit a configuration message 1310 to a wireless device, for example, before initiating the random access procedure. The four-step random access procedure may comprise transmissions of four messages comprising: a first message (e.g., Msg 1 1311), a second message (e.g., Msg 2 1312), a third message (e.g., Msg 3 1313), and a fourth message (e.g., Msg 4 1314). The first message (e.g., Msg 1 1311) may comprise a preamble (or a random access preamble). The first message (e.g., Msg 1 1311) may be referred to as a preamble. The second message (e.g., Msg 2 1312) may comprise as a random access response (RAR). The second message (e.g., Msg 2 1312) may be referred to as an RAR.

The configuration message 1310 may be sent/transmitted, for example, using one or more RRC messages. The one or more RRC messages may indicate one or more RACH parameters to the wireless device. The one or more RACH parameters may comprise at least one of: general parameters for one or more random access procedures (e.g., RACH-configGeneral); cell-specific parameters (e.g., RACH-ConfigCommon); and/or dedicated parameters (e.g., RACH-configDedicated). The base station may send/transmit (e.g., broadcast or multicast) the one or more RRC messages to one or more wireless devices. The one or more RRC messages may be wireless device-specific. The one or more RRC messages that are wireless device-specific may be, for example, dedicated RRC messages sent/transmitted to a wireless device in an RRC connected (e.g., an RRC_CONNECTED) state and/or in an RRC inactive (e.g., an RRC_INACTIVE) state. The wireless devices may determine, based on the one or more RACH parameters, a time-frequency resource and/or an uplink transmit power for transmission of the first message (e.g., Msg 1 1311) and/or the third message (e.g., Msg 3 1313). The wireless device may determine a reception timing and a downlink channel for receiving the second message (e.g., Msg 2 1312) and the fourth message (e.g., Msg 4 1314), for example, based on the one or more RACH parameters.

The one or more RACH parameters provided/configured/comprised in the configuration message 1310 may indicate one or more PRACH occasions available for transmission of the first message (e.g., Msg 1 1311). The one or more PRACH occasions may be predefined (e.g., by a network comprising one or more base stations). The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. The one or more RACH parameters may indicate a quantity/number of SS/PBCH blocks mapped to a PRACH occasion and/or a quantity/number of preambles mapped to a SS/PBCH blocks.

The one or more RACH parameters provided/configured/comprised in the configuration message 1310 may be used to determine an uplink transmit power of first message (e.g., Msg 1 1311) and/or third message (e.g., Msg 3 1313). The one or more RACH parameters may indicate a reference power for a preamble transmission (e.g., a received target power and/or an initial power of the preamble transmission). There may be one or more power offsets indicated by the one or more RACH parameters. The one or more RACH parameters may indicate: a power ramping step; a power offset between SSB and CSI-RS; a power offset between transmissions of the first message (e.g., Msg 1 1311) and the third message (e.g., Msg 3 1313); and/or a power offset value between preamble groups. The one or more RACH parameters may indicate one or more thresholds, for example, based on which the wireless device may determine at least one reference signal (e.g., an SSB and/or CSI-RS) and/or an uplink carrier (e.g., a normal uplink (NUL) carrier and/or a supplemental uplink (SUL) carrier).

The first message (e.g., Msg 1 1311) may comprise one or more preamble transmissions (e.g., a preamble transmission and one or more preamble retransmissions). An RRC message may be used to configure one or more preamble groups (e.g., group A and/or group B). A preamble group may comprise one or more preambles. The wireless device may determine the preamble group, for example, based on a pathloss measurement and/or a size of the third message (e.g., Msg 3 1313). The wireless device may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The wireless device may select at least one preamble associated with the one or more reference signals and/or a selected preamble group, for example, if the association between the one or more preambles and the at least one reference signal is configured by an RRC message.

The wireless device may determine the preamble, for example, based on the one or more RACH parameters provided/configured/comprised in the configuration message 1310. The wireless device may determine the preamble, for example, based on a pathloss measurement, an RSRP measurement, and/or a size of the third message (e.g., Msg 3 1313). The one or more RACH parameters may indicate at least one of: a preamble format; a maximum quantity/number of preamble transmissions; and/or one or more thresholds for determining one or more preamble groups (e.g., group A and group B). A base station may use the one or more RACH parameters to configure the wireless device with an association between one or more preambles and one or more reference signals (e.g., SSBs and/or CSI-RSs). The wireless device may determine the preamble to be comprised in first message (e.g., Msg 1 1311), for example, based on the association if the association is configured. The first message (e.g., Msg 1 1311) may be sent/transmitted to the base station via one or more PRACH occasions. The wireless device may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The wireless device may perform a preamble retransmission, for example, if no response is received based on (e.g., after or in response to) a preamble transmission (e.g., for a period of time, such as a monitoring window for monitoring an RAR). The wireless device may increase an uplink transmit power for the preamble retransmission. The wireless device may select an initial preamble transmit power, for example, based on a pathloss measurement and/or a target received preamble power configured by the network. The wireless device may determine to resend/retransmit a preamble and may ramp up the uplink transmit power. The wireless device may receive one or more RACH parameters (e.g., PREAMBLE_POWER_RAMPING_STEP) indicating a ramping step for the preamble retransmission. The ramping step may be an amount of incremental increase in uplink transmit power for a retransmission. The wireless device may ramp up the uplink transmit power, for example, if the wireless device determines a reference signal (e.g., SSB and/or CSI-RS) that is the same as a previous preamble transmission. The wireless device may count the quantity/number of preamble transmissions and/or retransmissions, for example, using a counter parameter (e.g., PREAMBLE_TRANSMISSION_COUNTER). The wireless device may determine that a random access procedure has been completed unsuccessfully, for example, if the quantity/number of preamble transmissions exceeds a threshold configured by the one or more RACH parameters (e.g., preambleTransMax) without receiving a successful response (e.g., an RAR).

The second message (e.g., Msg 2 1312) (e.g., received by the wireless device) may comprise an RAR. The second message (e.g., Msg 2 1312) may comprise multiple RARs corresponding to multiple wireless devices. The second message (e.g., Msg 2 1312) may be received, for example, based on (e.g., after or in response to) the sending/transmitting of the first message (e.g., Msg 1 1311). The second message (e.g., Msg 2 1312) may be scheduled on the DL-SCH and may be indicated by a PDCCH, for example, using a random access radio network temporary identifier (RA RNTI). The second message (e.g., Msg 2 1312) may indicate that the first message (e.g., Msg 1 1311) was received by the base station. The second message (e.g., Msg 2 1312) may comprise a time-alignment command that may be used by the wireless device to adjust the transmission timing of the wireless device, a scheduling grant for transmission of the third message (e.g., Msg 3 1313), and/or a Temporary Cell RNTI (TC-RNTI). The wireless device may determine/start a time window (e.g., ra-ResponseWindow) to monitor a PDCCH for the second message (e.g., Msg 2 1312), for example, after sending/transmitting the first message (e.g., Msg 1 1311) (e.g., a preamble). The wireless device may determine the start time of the time window, for example, based on a PRACH occasion that the wireless device uses to send/transmit the first message (e.g., Msg 1 1311) (e.g., the preamble). The wireless device may start the time window one or more symbols after the last symbol of the first message (e.g., Msg 1 1311) comprising the preamble (e.g., the symbol in which the first message (e.g., Msg 1 1311) comprising the preamble transmission was completed or at a first PDCCH occasion from an end of a preamble transmission). The one or more symbols may be determined based on a numerology. The PDCCH may be mapped in a common search space (e.g., a Type1-PDCCH common search space) configured by an RRC message. The wireless device may identify/determine the RAR, for example, based on an RNTI. RNTIs may be used depending on one or more events initiating/starting the random access procedure. The wireless device may use a RA-RNTI, for example, for one or more communications associated with random access or any other purpose. The RA-RNTI may be associated with PRACH occasions in which the wireless device sends/transmits a preamble. The wireless device may determine the RA-RNTI, for example, based on at least one of: an OFDM symbol index; a slot index; a frequency domain index; and/or a UL carrier indicator of the PRACH occasions. An example RA-RNTI may be determined as follows:
RA-RNTI=1+s_id+14×t_id+14×80 xf_id+14×80×8×ul_carrier_id, where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The wireless device may send/transmit the third message (e.g., Msg 3 1313), for example, based on (e.g., after or in response to) a successful reception of the second message (e.g., Msg 2 1312) (e.g., using resources identified in the Msg 2 1312). The third message (e.g., Msg 3 1313) may be used, for example, for contention resolution in the contention-based random access procedure. A plurality of wireless devices may send/transmit the same preamble to a base station, and the base station may send/transmit an RAR that corresponds to a wireless device. Collisions may occur, for example, if the plurality of wireless device interpret the RAR as corresponding to themselves. Contention resolution (e.g., using the third message (e.g., Msg 3 1313) and the fourth message (e.g., Msg 4 1314)) may be used to increase the likelihood that the wireless device does not incorrectly use an identity of another wireless device. The wireless device may comprise a device identifier in the third message (e.g., Msg 3 1313) (e.g., a C-RNTI if assigned, a TC RNTI comprised in the second message (e.g., Msg 2 1312), and/or any other suitable identifier), for example, to perform contention resolution.

The fourth message (e.g., Msg 4 1314) may be received, for example, based on (e.g., after or in response to) the sending/transmitting of the third message (e.g., Msg 3 1313). The base station may address the wireless device on the PDCCH (e.g., the base station may send the PDCCH to the wireless device) using a C-RNTI, for example, if the C-RNTI was included in the third message (e.g., Msg 3 1313). The random access procedure may be determined to be successfully completed, for example, if the unique C-RNTI of the wireless device is detected on the PDCCH (e.g., the PDCCH is scrambled by the C-RNTI). The fourth message (e.g., Msg 4 1314) may be received using a DL-SCH associated with a TC-RNTI, for example, if the TC RNTI is comprised in the third message (e.g., Msg 3 1313) (e.g., if the wireless device is in an RRC idle (e.g., an RRC_IDLE) state or not otherwise connected to the base station). The wireless device may determine that the contention resolution is successful and/or the wireless device may determine that the random access procedure is successfully completed, for example, if a MAC PDU is successfully decoded and a MAC PDU comprises the wireless device contention resolution identity MAC CE that matches or otherwise corresponds with the CCCH SDU sent/transmitted in third message (e.g., Msg 3 1313).

The wireless device may be configured with an SUL carrier and/or an NUL carrier. An initial access (e.g., random access) may be supported via an uplink carrier. A base station may configure the wireless device with multiple RACH configurations (e.g., two separate RACH configurations comprising: one for an SUL carrier and the other for an NUL carrier). For random access in a cell configured with an SUL carrier, the network may indicate which carrier to use (NUL or SUL). The wireless device may determine to use the SUL carrier, for example, if a measured quality of one or more reference signals (e.g., one or more reference signals associated with the NUL carrier) is lower than a broadcast threshold. Uplink transmissions of the random access procedure (e.g., the first message (e.g., Msg 1 1311) and/or the third message (e.g., Msg 3 1313)) may remain on, or may be performed via, the selected carrier. The wireless device may switch an uplink carrier during the random access procedure (e.g., for the first message (e.g., Msg 1 1311) and/or the third message (e.g., Msg 3 1313)). The wireless device may determine and/or switch an uplink carrier for the first message (e.g., Msg 1 1311) and/or the third message (e.g., Msg 3 1313), for example, based on a channel clear assessment (e.g., a listen-before-talk).

FIG. 13B shows a two-step random access procedure. The two-step random access procedure may comprise a two-step contention-free random access procedure. Similar to the four-step contention-based random access procedure, a base station may, prior to initiation of the procedure, send/transmit a configuration message 1320 to the wireless device. The configuration message 1320 may be analogous in some respects to the configuration message 1310. The procedure shown in FIG. 13B may comprise transmissions of two messages: a first message (e.g., Msg 1 1321) and a second message (e.g., Msg 2 1322). The first message (e.g., Msg 1 1321) and the second message (e.g., Msg 2 1322) may be analogous in some respects to the first message (e.g., Msg 1 1311) and a second message (e.g., Msg 2 1312), respectively. The two-step contention-free random access procedure may not comprise messages analogous to the third message (e.g., Msg 3 1313) and/or the fourth message (e.g., Msg 4 1314).

The two-step (e.g., contention-free) random access procedure may be configured/initiated for a beam failure recovery, other SI request, an SCell addition, and/or a handover. A base station may indicate, or assign to, the wireless device a preamble to be used for the first message (e.g., Msg 1 1321). The wireless device may receive, from the base station via a PDCCH and/or an RRC, an indication of the preamble (e.g., ra-PreambleIndex).

The wireless device may start a time window (e.g., ra-Response Window) to monitor a PDCCH for the RAR, for example, based on (e.g., after or in response to) sending/transmitting the preamble. The base station may configure the wireless device with one or more beam failure recovery parameters, such as a separate time window and/or a separate PDCCH in a search space indicated by an RRC message (e.g., recoverySearchSpaceld). The base station may configure the one or more beam failure recovery parameters, for example, in association with a beam failure recovery request. The separate time window for monitoring the PDCCH and/or an RAR may be configured to start after sending/transmitting a beam failure recovery request (e.g., the window may start any quantity of symbols and/or slots after sending/transmitting the beam failure recovery request). The wireless device may monitor for a PDCCH transmission addressed to a Cell RNTI (C-RNTI) on the search space. During the two-step (e.g., contention-free) random access procedure, the wireless device may determine that a random access procedure is successful, for example, based on (e.g., after or in response to) sending/transmitting first message (e.g., Msg 1 1321) and receiving a corresponding second message (e.g., Msg 2 1322). The wireless device may determine that a random access procedure has successfully been completed, for example, if a PDCCH transmission is addressed to a corresponding C-RNTI. The wireless device may determine that a random access procedure has successfully been completed, for example, if the wireless device receives an RAR comprising a preamble identifier corresponding to a preamble sent/transmitted by the wireless device and/or the RAR comprises a MAC sub-PDU with the preamble identifier. The wireless device may determine the response as an indication of an acknowledgement for an SI request.

FIG. 13C shows an example two-step random access procedure. Similar to the random access procedures shown in FIGS. 13A and 13B, a base station may, prior to initiation of the procedure, send/transmit a configuration message 1330 to the wireless device. The configuration message 1330 may be analogous in some respects to the configuration message 1310 and/or the configuration message 1320. The procedure shown in FIG. 13C may comprise transmissions of multiple messages (e.g., two messages comprising: a first message (e.g., Msg A 1331) and a second message (e.g., Msg B 1332)).

The first message (e.g., Msg A 1331) may be sent/transmitted in an uplink transmission by the wireless device. The first message (e.g., Msg A 1331) may comprise one or more transmissions of a preamble 1341 and/or one or more transmissions of a transport block 1342. The transport block 1342 may comprise contents that are similar and/or equivalent to the contents of the third message (e.g., Msg 3 1313) (e.g., shown in FIG. 13A). The transport block 1342 may comprise UCI (e.g., an SR, a HARQ ACK/NACK, and/or the like). The wireless device may receive the second message (e.g., Msg B 1332), for example, based on (e.g., after or in response to) sending/transmitting the first message (e.g., Msg A 1331). The second message (e.g., Msg B 1332) may comprise contents that are similar and/or equivalent to the contents of the second message (e.g., Msg 2 1312) (e.g., an RAR shown in FIG. 13A), the contents of the second message (e.g., Msg 2 1322) (e.g., an RAR shown in FIG. 13B) and/or the fourth message (e.g., Msg 4 1314) (e.g., shown in FIG. 13A).

The wireless device may start/initiate the two-step random access procedure (e.g., the two-step random access procedure shown in FIG. 13C) for a licensed spectrum and/or an unlicensed spectrum. The wireless device may determine, based on one or more factors, whether to start/initiate the two-step random access procedure. The one or more factors may comprise at least one of: a radio access technology in use (e.g., LTE, NR, and/or the like); whether the wireless device has a valid TA or not; a cell size; the RRC state of the wireless device; a type of spectrum (e.g., licensed vs. unlicensed); and/or any other suitable factors.

The wireless device may determine, based on two-step RACH parameters comprised in the configuration message 1330, a radio resource and/or an uplink transmit power for the preamble 1341 and/or the transport block 1342 (e.g., comprised in the first message (e.g., Msg A 1331)). The RACH parameters may indicate an MCS, a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the wireless device to determine a reception timing and a downlink channel for monitoring for and/or receiving second message (e.g., Msg B 1332).

The transport block 1342 may comprise data (e.g., delay-sensitive data), an identifier of the wireless device, security information, and/or device information (e.g., an International Mobile Subscriber Identity (IMSI)). The base station may send/transmit the second message (e.g., Msg B 1332) as a response to the first message (e.g., Msg A 1331). The second message (e.g., Msg B 1332) may comprise at least one of: a preamble identifier; a timing advance command; a power control command; an uplink grant (e.g., a radio resource assignment and/or an MCS); a wireless device identifier (e.g., a UE identifier for contention resolution); and/or an RNTI (e.g., a C-RNTI or a TC-RNTI). The wireless device may determine that the two-step random access procedure is successfully completed, for example, if a preamble identifier in the second message (e.g., Msg B 1332) corresponds to, or is matched to, a preamble sent/transmitted by the wireless device and/or the identifier of the wireless device in second message (e.g., Msg B 1332) corresponds to, or is matched to, the identifier of the wireless device in the first message (e.g., Msg A 1331) (e.g., the transport block 1342).

A wireless device and a base station may exchange control signaling (e.g., control information). The control signaling may be referred to as layer 1 or layer 2 (e.g., L1 or L2, Layer 1/Layer 2, L1/L2, Layer 1 or layer 2, Layer 1 or Layer 2, L½, Layer ½, layer ½ etc.)) control signaling and may originate from the PHY layer (e.g., layer 1) and/or the MAC layer (e.g., layer 2) of the wireless device or the base station. The control signaling may comprise downlink control signaling sent/transmitted from the base station to the wireless device and/or uplink control signaling sent/transmitted from the wireless device to the base station.

The downlink control signaling may comprise at least one of: a downlink scheduling assignment; an uplink scheduling grant indicating uplink radio resources and/or a transport format; slot format information; a preemption indication; a power control command; and/or any other suitable signaling. The wireless device may receive the downlink control signaling in a payload sent/transmitted by the base station via a PDCCH. The payload sent/transmitted via the PDCCH may be referred to as DCI. The PDCCH may be a group common PDCCH (GC-PDCCH) that is common to a group of wireless devices. The GC-PDCCH may be scrambled by a group common RNTI.

A base station may attach one or more cyclic redundancy check (CRC) parity bits to DCI, for example, in order to facilitate detection of transmission errors. The base station may scramble the CRC parity bits with an identifier of a wireless device (or an identifier of a group of wireless devices), for example, if the DCI is intended for the wireless device (or the group of the wireless devices). Scrambling the CRC parity bits with the identifier may comprise Modulo-2 addition (or an exclusive-OR operation) of the identifier value and the CRC parity bits. The identifier may comprise a 16-bit value of an RNTI.

DCIs may be used for different purposes. A purpose may be indicated by the type of an RNTI used to scramble the CRC parity bits. DCI having CRC parity bits scrambled with a paging RNTI (P-RNTI) may indicate paging information and/or a system information change notification. The P-RNTI may be predefined as “FFFE” in hexadecimal. DCI having CRC parity bits scrambled with a system information RNTI (SI-RNTI) may indicate a broadcast transmission of the system information. The SI-RNTI may be predefined as “FFFF” in hexadecimal. DCI having CRC parity bits scrambled with a random access RNTI (RA-RNTI) may indicate a random access response (RAR). DCI having CRC parity bits scrambled with a cell RNTI (C-RNTI) may indicate a dynamically scheduled unicast transmission and/or a triggering of PDCCH-ordered random access. DCI having CRC parity bits scrambled with a temporary cell RNTI (TC-RNTI) may indicate a contention resolution (e.g., a Msg 3 analogous to the Msg 3 1313 shown in FIG. 13A). Other RNTIs configured for a wireless device by a base station may comprise a Configured Scheduling RNTI (CS RNTI), a Transmit Power Control-PUCCH RNTI (TPC PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C RNTI), and/or the like.

A base station may send/transmit DCIs with one or more DCI formats, for example, depending on the purpose and/or content of the DCIs. DCI format 0_0 may be used for scheduling of a PUSCH in a cell. DCI format 0_0 may be a fallback DCI format (e.g., with compact DCI payloads). DCI format 0_1 may be used for scheduling of a PUSCH in a cell (e.g., with more DCI payloads than DCI format 0_0). DCI format 1_0 may be used for scheduling of a PDSCH in a cell. DCI format 1_0 may be a fallback DCI format (e.g., with compact DCI payloads). DCI format 1_1 may be used for scheduling of a PDSCH in a cell (e.g., with more DCI payloads than DCI format 1_0). DCI format 2_0 may be used for providing a slot format indication to a group of wireless devices. DCI format 2_1 may be used for informing/notifying a group of wireless devices of a physical resource block and/or an OFDM symbol where the group of wireless devices may assume no transmission is intended to the group of wireless devices. DCI format 2_2 may be used for transmission of a transmit power control (TPC) command for PUCCH or PUSCH. DCI format 2_3 may be used for transmission of a group of TPC commands for SRS transmissions by one or more wireless devices. DCI format(s) for new functions may be defined in future releases. DCI formats may have different DCI sizes, or may share the same DCI size.

The base station may process the DCI with channel coding (e.g., polar coding), rate matching, scrambling and/or QPSK modulation, for example, after scrambling the DCI with an RNTI. A base station may map the coded and modulated DCI on resource elements used and/or configured for a PDCCH. The base station may send/transmit the DCI via a PDCCH occupying a number of contiguous control channel elements (CCEs), for example, based on a payload size of the DCI and/or a coverage of the base station. The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

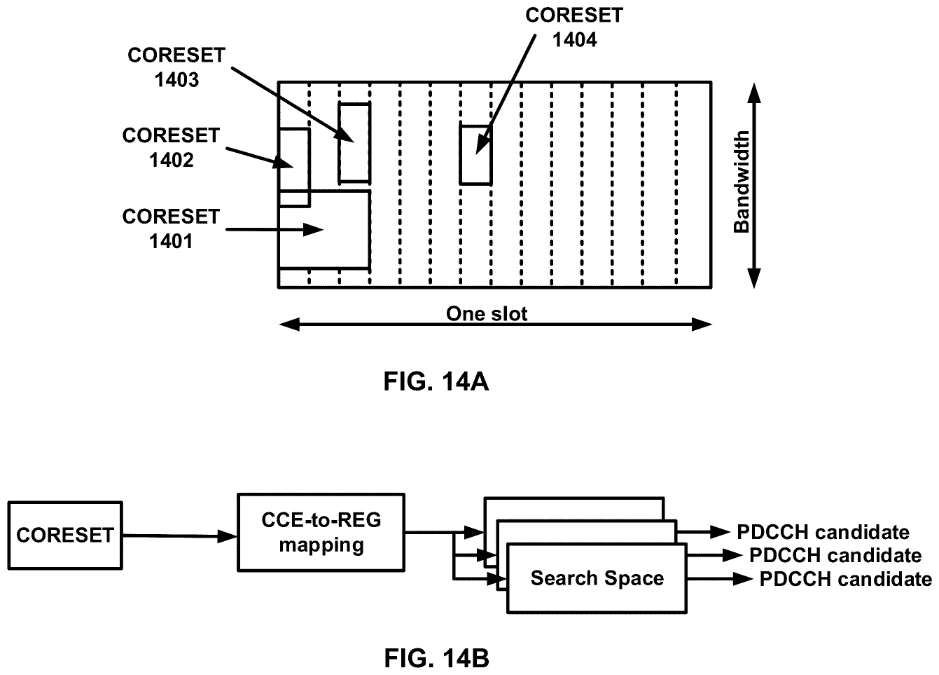

FIG. 14A shows an example of CORESET configurations. The CORESET configurations may be for a bandwidth part or any other frequency bands. The base station may send/transmit DCI via a PDCCH on one or more CORESETs. A CORESET may comprise a time-frequency resource in which the wireless device attempts/tries to decode DCI using one or more search spaces. The base station may configure a size and a location of the CORESET in the time-frequency domain. A first CORESET 1401 and a second CORESET 1402 may occur or may be set/configured at the first symbol in a slot. The first CORESET 1401 may overlap with the second CORESET 1402 in the frequency domain. A third CORESET 1403 may occur or may be set/configured at a third symbol in the slot. A fourth CORESET 1404 may occur or may be set/configured at the seventh symbol in the slot. CORESETs may have a different number of resource blocks in frequency domain.

FIG. 14B shows an example of a CCE-to-REG mapping. The CCE-to-REG mapping may be performed for DCI transmission via a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping (e.g., by an RRC configuration). A CORESET may be configured with an antenna port QCL parameter. The antenna port QCL parameter may indicate QCL information of a DM-RS for a PDCCH reception via the CORESET.

The base station may send/transmit, to the wireless device, one or more RRC messages comprising configuration parameters of one or more CORESETs and one or more search space sets. The configuration parameters may indicate an association between a search space set and a CORESET. A search space set may comprise a set of PDCCH candidates formed by CCEs (e.g., at a given aggregation level). The configuration parameters may indicate at least one of: a number of PDCCH candidates to be monitored per aggregation level; a PDCCH monitoring periodicity and a PDCCH monitoring pattern; one or more DCI formats to be monitored by the wireless device; and/or whether a search space set is a common search space set or a wireless device-specific search space set (e.g., a UE-specific search space set). A set of CCEs in the common search space set may be predefined and known to the wireless device. A set of CCEs in the wireless device-specific search space set (e.g., the UE-specific search space set) may be configured, for example, based on the identity of the wireless device (e.g., C-RNTI).

As shown in FIG. 14B, the wireless device may determine a time-frequency resource for a CORESET based on one or more RRC messages. The wireless device may determine a CCE-to-REG mapping (e.g., interleaved or non-interleaved, and/or mapping parameters) for the CORESET, for example, based on configuration parameters of the CORESET. The wireless device may determine a quantity/number (e.g., at most 10) of search space sets configured on/for the CORESET, for example, based on the one or more RRC messages. The wireless device may monitor a set of PDCCH candidates according to configuration parameters of a search space set. The wireless device may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding DCI content of one or more PDCCH candidates with possible (or configured) PDCCH locations, possible (or configured) PDCCH formats (e.g., the quantity/number of CCEs, the quantity/number of PDCCH candidates in common search spaces, and/or the quantity/number of PDCCH candidates in the wireless device-specific search spaces) and possible (or configured) DCI formats. The decoding may be referred to as blind decoding. The wireless device may determine DCI as valid for the wireless device, for example, based on (e.g., after or in response to) CRC checking (e.g., scrambled bits for CRC parity bits of the DCI matching an RNTI value). The wireless device may process information comprised in the DCI (e.g., a scheduling assignment, an uplink grant, power control, a slot format indication, a downlink preemption, and/or the like).

The wireless device may send/transmit uplink control signaling (e.g., UCI) to a base station. The uplink control signaling may comprise HARQ acknowledgements for received DL-SCH transport blocks. The wireless device may send/transmit the HARQ acknowledgements, for example, based on (e.g., after or in response to) receiving a DL-SCH transport block. Uplink control signaling may comprise CSI indicating a channel quality of a physical downlink channel. The wireless device may send/transmit the CSI to the base station. The base station, based on the received CSI, may determine transmission format parameters (e.g., comprising multi-antenna and beamforming schemes) for downlink transmission(s). Uplink control signaling may comprise SR. The wireless device may send/transmit an SR indicating that uplink data is available for transmission to the base station. The wireless device may send/transmit UCI (e.g., HARQ acknowledgements (HARQ-ACK), CSI report, SR, and the like) via a PUCCH or a PUSCH. The wireless device may send/transmit the uplink control signaling via a PUCCH using one of several PUCCH formats.

There may be multiple PUCCH formats (e.g., five PUCCH formats). A wireless device may determine a PUCCH format, for example, based on a size of UCI (e.g., a quantity/number of uplink symbols of UCI transmission and a quantity/number of UCI bits). PUCCH format 0 may have a length of one or two OFDM symbols and may comprise two or fewer bits. The wireless device may send/transmit UCI via a PUCCH resource, for example, using PUCCH format 0 if the transmission is over/via one or two symbols and the quantity/number of HARQ-ACK information bits with positive or negative SR (HARQ-ACK/SR bits) is one or two. PUCCH format 1 may occupy a quantity/number of OFDM symbols (e.g., between four and fourteen OFDM symbols) and may comprise two or fewer bits. The wireless device may use PUCCH format 1, for example, if the transmission is over/via four or more symbols and the quantity/number of HARQ-ACK/SR bits is one or two. PUCCH format 2 may occupy one or two OFDM symbols and may comprise more than two bits. The wireless device may use PUCCH format 2, for example, if the transmission is over/via one or two symbols and the quantity/number of UCI bits is two or more. PUCCH format 3 may occupy a quantity/number of OFDM symbols (e.g., between four and fourteen OFDM symbols) and may comprise more than two bits. The wireless device may use PUCCH format 3, for example, if the transmission is four or more symbols, the quantity/number of UCI bits is two or more, and the PUCCH resource does not comprise an orthogonal cover code (OCC). PUCCH format 4 may occupy a quantity/number of OFDM symbols (e.g., between four and fourteen OFDM symbols) and may comprise more than two bits. The wireless device may use PUCCH format 4, for example, if the transmission is four or more symbols, the quantity/number of UCI bits is two or more, and the PUCCH resource comprises an OCC.

The base station may send/transmit configuration parameters to the wireless device for a plurality of PUCCH resource sets, for example, using an RRC message. The plurality of PUCCH resource sets (e.g., up to four sets in NR, or up to any other quantity of sets in other systems) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a quantity/number (e.g. a maximum number) of UCI information bits the wireless device may send/transmit using one of the plurality of PUCCH resources in the PUCCH resource set. The wireless device may select one of the plurality of PUCCH resource sets, for example, based on a total bit length of the UCI information bits (e.g., HARQ-ACK, SR, and/or CSI) if configured with a plurality of PUCCH resource sets. The wireless device may select a first PUCCH resource set having a PUCCH resource set index equal to “0,” for example, if the total bit length of UCI information bits is two or fewer. The wireless device may select a second PUCCH resource set having a PUCCH resource set index equal to “1,” for example, if the total bit length of UCI information bits is greater than two and less than or equal to a first configured value. The wireless device may select a third PUCCH resource set having a PUCCH resource set index equal to “2,” for example, if the total bit length of UCI information bits is greater than the first configured value and less than or equal to a second configured value. The wireless device may select a fourth PUCCH resource set having a PUCCH resource set index equal to “3,” for example, if the total bit length of UCI information bits is greater than the second configured value and less than or equal to a third value (e.g., 1406, 1706, or any other quantity of bits).

The wireless device may determine a PUCCH resource from a PUCCH resource set for UCI (HARQ-ACK, CSI, and/or SR) transmission, for example, after determining the PUCCH resource set from a plurality of PUCCH resource sets. The wireless device may determine the PUCCH resource, for example, based on a PUCCH resource indicator in DCI (e.g., with DCI format 1_0 or DCI for 1_1) received on/via a PDCCH. An n-bit (e.g., a three-bit) PUCCH resource indicator in the DCI may indicate one of multiple (e.g., eight) PUCCH resources in the PUCCH resource set. The wireless device may send/transmit the UCI (HARQ-ACK, CSI and/or SR) using a PUCCH resource indicated by the PUCCH resource indicator in the DCI, for example, based on the PUCCH resource indicator.

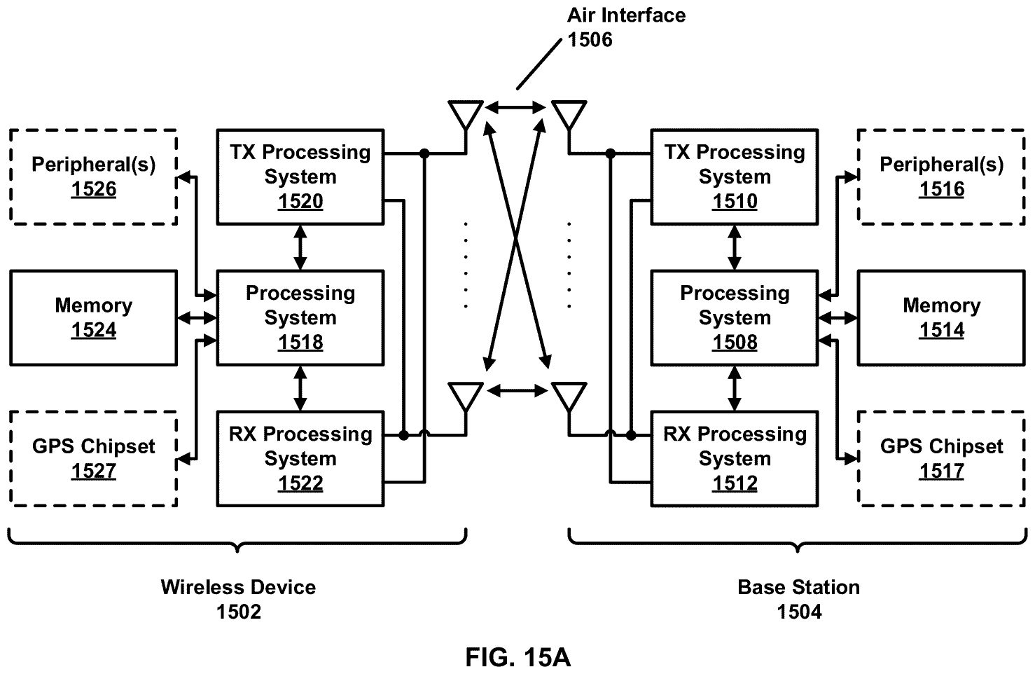

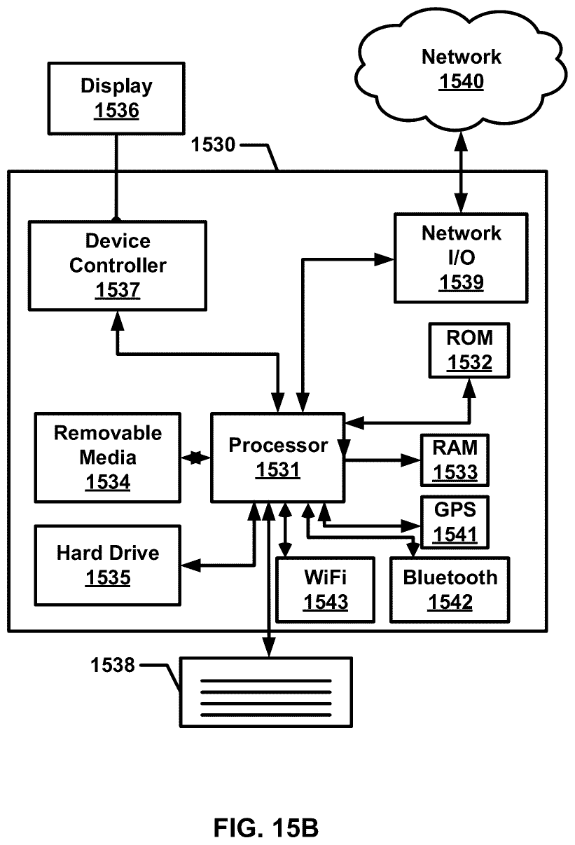

FIG. 15A shows an example of communications between a wireless device and a base station. A wireless device 1502 and a base station 1504 may be part of a communication network, such as the communication network 100 shown in FIG. 1A, the communication network 150 shown in FIG. 1B, or any other communication network. A communication network may comprise more than one wireless device and/or more than one base station, with substantially the same or similar configurations as those shown in FIG. 15A.

The base station 1504 may connect the wireless device 1502 to a core network (not shown) via radio communications over the air interface (or radio interface) 1506. The communication direction from the base station 1504 to the wireless device 1502 over the air interface 1506 may be referred to as the downlink. The communication direction from the wireless device 1502 to the base station 1504 over the air interface may be referred to as the uplink. Downlink transmissions may be separated from uplink transmissions, for example, using various duplex schemes (e.g., FDD, TDD, and/or some combination of the duplexing techniques).

For the downlink, data to be sent to the wireless device 1502 from the base station 1504 may be provided/transferred/sent to the processing system 1508 of the base station 1504. The data may be provided/transferred/sent to the processing system 1508 by, for example, a core network. For the uplink, data to be sent to the base station 1504 from the wireless device 1502 may be provided/transferred/sent to the processing system 1518 of the wireless device 1502. The processing system 1508 and the processing system 1518 may implement layer 3 and layer 2 OSI functionality to process the data for transmission. Layer 2 may comprise an SDAP layer, a PDCP layer, an RLC layer, and a MAC layer, for example, described with respect to FIG. 2A, FIG. 2B, FIG. 3, and FIG. 4A. Layer 3 may comprise an RRC layer, for example, described with respect to FIG. 2B.

The data to be sent to the wireless device 1502 may be provided/transferred/sent to a transmission processing system 1510 of base station 1504, for example, after being processed by the processing system 1508. The data to be sent to base station 1504 may be provided/transferred/sent to a transmission processing system 1520 of the wireless device 1502, for example, after being processed by the processing system 1518. The transmission processing system 1510 and the transmission processing system 1520 may implement layer 1 OSI functionality. Layer 1 may comprise a PHY layer, for example, described with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

A reception processing system 1512 of the base station 1504 may receive the uplink transmission from the wireless device 1502. The reception processing system 1512 of the base station 1504 may comprise one or more TRPs. A reception processing system 1522 of the wireless device 1502 may receive the downlink transmission from the base station 1504. The reception processing system 1522 of the wireless device 1502 may comprise one or more antenna panels. The reception processing system 1512 and the reception processing system 1522 may implement layer 1 OSI functionality. Layer 1 may include a PHY layer, for example, described with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

The base station 1504 may comprise multiple antennas (e.g., multiple antenna panels, multiple TRPs, etc.). The wireless device 1502 may comprise multiple antennas (e.g., multiple antenna panels, etc.). The multiple antennas may be used to perform one or more MIMO or multi-antenna techniques, such as spatial multiplexing (e.g., single-user MIMO or multi-user MIMO), transmit/receive diversity, and/or beamforming. The wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518, respectively, to carry out one or more of the functionalities (e.g., one or more functionalities described herein and other functionalities of general computers, processors, memories, and/or other peripherals). The transmission processing system 1510 and/or the reception processing system 1512 may be coupled to the memory 1514 and/or another memory (e.g., one or more non-transitory computer readable mediums) storing computer program instructions or code that may be executed to carry out one or more of their respective functionalities. The transmission processing system 1520 and/or the reception processing system 1522 may be coupled to the memory 1524 and/or another memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and/or the base station 1504 to operate in a wireless environment.

The processing system 1508 may be connected to one or more peripherals 1516. The processing system 1518 may be connected to one or more peripherals 1526. The one or more peripherals 1516 and the one or more peripherals 1526 may comprise software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive input data (e.g., user input data) from, and/or provide output data (e.g., user output data) to, the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 may be connected to a Global Positioning System (GPS) chipset 1517. The processing system 1518 may be connected to a Global Positioning System (GPS) chipset 1527. The GPS chipset 1517 and the GPS chipset 1527 may be configured to determine and provide geographic location information of the wireless device 1502 and the base station 1504, respectively.

FIG. 15B shows example elements of a computing device that may be used to implement any of the various devices described herein, including, for example, the base station 160A, 160B, 162A, 162B, 220, 1504, 2200, 3300, and/or 3700, the wireless device 106, 156A, 156B, 210, 1502, 2201, 3301, and/or 3701 or any other base station, wireless device, AMF, UPF, network device, or computing device described herein. The computing device 1530 may include one or more processors 1531, which may execute instructions stored in the random-access memory (RAM) 1533, the removable media 1534 (such as a USB drive, compact disk (CD) or digital versatile disk (DVD), or floppy disk drive), or any other desired storage medium. Instructions may also be stored in an attached (or internal) hard drive 1535. The computing device 1530 may also include a security processor (not shown), which may execute instructions of one or more computer programs to monitor the processes executing on the processor 1531 and any process that requests access to any hardware and/or software components of the computing device 1530 (e.g., ROM 1532, RAM 1533, the removable media 1534, the hard drive 1535, the device controller 1537, a network interface 1539, a GPS 1541, a Bluetooth interface 1542, a WiFi interface 1543, etc.). The computing device 1530 may include one or more output devices, such as the display 1536 (e.g., a screen, a display device, a monitor, a television, etc.), and may include one or more output device controllers 1537, such as a video processor. There may also be one or more user input devices 1538, such as a remote control, keyboard, mouse, touch screen, microphone, etc. The computing device 1530 may also include one or more network interfaces, such as a network interface 1539, which may be a wired interface, a wireless interface, or a combination of the two. The network interface 1539 may provide an interface for the computing device 1530 to communicate with a network 1540 (e.g., a RAN, or any other network). The network interface 1539 may include a modem (e.g., a cable modem), and the external network 1540 may include communication links, an external network, an in-home network, a provider's wireless, coaxial, fiber, or hybrid fiber/coaxial distribution system (e.g., a DOCSIS network), or any other desired network. Additionally, the computing device 1530 may include a location-detecting device, such as a GPS microprocessor 1541, which may be configured to receive and process global positioning signals and determine, with possible assistance from an external server and antenna, a geographic position of the computing device 1530.

The example in FIG. 15B may be a hardware configuration, although the components shown may be implemented as software as well. Modifications may be made to add, remove, combine, divide, etc. components of the computing device 1530 as desired. Additionally, the components may be implemented using basic computing devices and components, and the same components (e.g., processor 1531, ROM storage 1532, display 1536, etc.) may be used to implement any of the other computing devices and components described herein. For example, the various components described herein may be implemented using computing devices having components such as a processor executing computer-executable instructions stored on a computer-readable medium, as shown in FIG. 15B. Some or all of the entities described herein may be software based, and may co-exist in a common physical platform (e.g., a requesting entity may be a separate software process and program from a dependent entity, both of which may be executed as software on a common computing device).

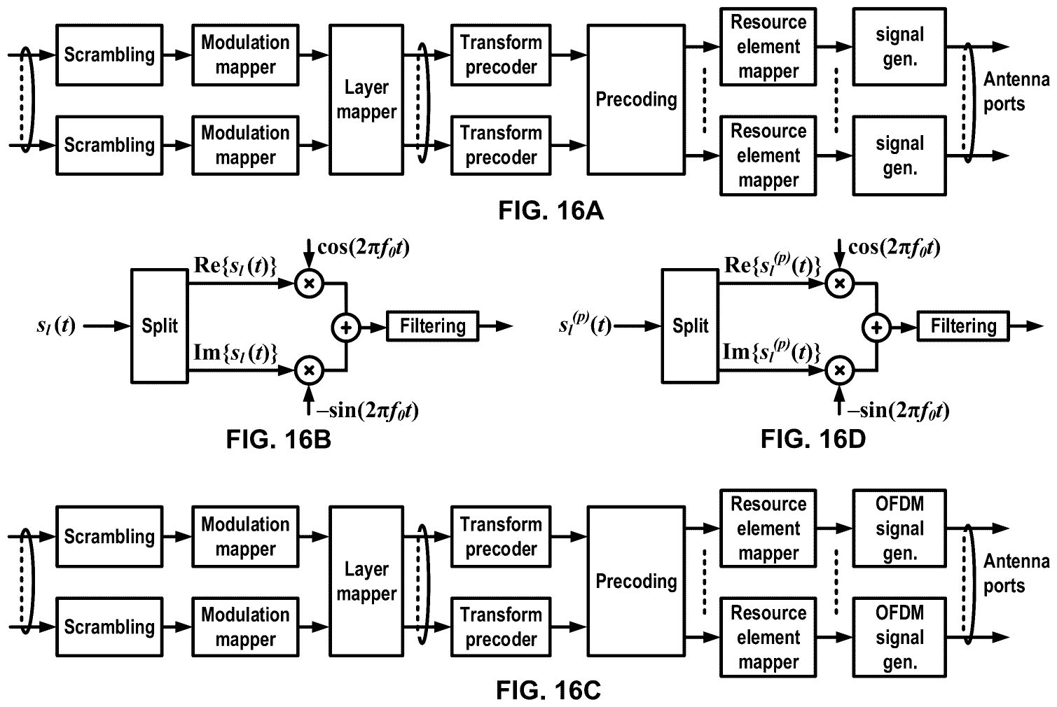

FIG. 16A shows an example structure for uplink transmission. Processing of a baseband signal representing a physical uplink shared channel may comprise/perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA), CP-OFDM signal for an antenna port, or any other signals; and/or the like. An SC-FDMA signal for uplink transmission may be generated, for example, if transform precoding is enabled. A CP-OFDM signal for uplink transmission may be generated, for example, if transform precoding is not enabled (e.g., as shown in FIG. 16A). These functions are examples and other mechanisms for uplink transmission may be implemented.

FIG. 16B shows an example structure for modulation and up-conversion of a baseband signal to a carrier frequency. The baseband signal may be a complex-valued SC-FDMA, CP-OFDM baseband signal (or any other baseband signals) for an antenna port and/or a complex-valued Physical Random Access Channel (PRACH) baseband signal. Filtering may be performed/employed, for example, prior to transmission.

FIG. 16C shows an example structure for downlink transmissions. Processing of a baseband signal representing a physical downlink channel may comprise/perform one or more functions. The one or more functions may comprise: scrambling of coded bits in a codeword to be sent/transmitted on/via a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are examples and other mechanisms for downlink transmission may be implemented.

FIG. 16D shows an example structure for modulation and up-conversion of a baseband signal to a carrier frequency. The baseband signal may be a complex-valued OFDM baseband signal for an antenna port or any other signal. Filtering may be performed/employed, for example, prior to transmission.

A wireless device may receive, from a base station, one or more messages (e.g. RRC messages) comprising configuration parameters of a plurality of cells (e.g., a primary cell, one or more secondary cells). The wireless device may communicate with at least one base station (e.g., two or more base stations in dual-connectivity) via the plurality of cells. The one or more messages (e.g. as a part of the configuration parameters) may comprise parameters of PHY, MAC, RLC, PCDP, SDAP, RRC layers for configuring the wireless device. The configuration parameters may comprise parameters for configuring PHY and MAC layer channels, bearers, etc. The configuration parameters may comprise parameters indicating values of timers for PHY, MAC, RLC, PCDP, SDAP, RRC layers, and/or communication channels.

A timer may begin running, for example, after it is started and continue running until it is stopped or until it expires. A timer may be started, for example, if it is not running or restarted if it is running. A timer may be associated with a value (e.g., the timer may be started or restarted from a value or may be started from zero and expire after it reaches the value). The duration of a timer may not be updated, for example, until the timer is stopped or expires (e.g., due to BWP switching). A timer may be used to measure a time period/window for a process. With respect to an implementation and/or procedure related to one or more timers or other parameters, it will be understood that there may be multiple ways to implement the one or more timers or other parameters. One or more of the multiple ways to implement a timer may be used to measure a time period/window for the procedure. A random access response window timer may be used for measuring a window of time for receiving a random access response. The time difference between two time stamps may be used, for example, instead of starting a random access response window timer and determine the expiration of the timer. A process for measuring a time window may be restarted, for example, if a timer is restarted. Other example implementations may be configured/provided to restart a measurement of a time window.

A base station may communicate with a wireless device via a wireless network (e.g., a communication network). The communications may use/employ one or more radio technologies (e.g., new radio technologies, legacy radio technologies, and/or a combination thereof). The one or more radio technologies may comprise at least one of: one or multiple technologies related to a physical layer; one or multiple technologies related to a medium access control layer; and/or one or multiple technologies related to a radio resource control layer. One or more enhanced radio technologies described herein may improve performance of a wireless network. System throughput, transmission efficiencies of a wireless network, and/or data rate of transmission may be improved, for example, based on one or more configurations described herein. Battery consumption of a wireless device may be reduced, for example, based on one or more configurations described herein. Latency of data transmission between a base station and a wireless device may be improved, for example, based on one or more configurations described herein. A network coverage of a wireless network may increase, for example, based on one or more configurations described herein.

A base station may send/transmit one or more MAC PDUs to a wireless device. A MAC PDU may be a bit string that is byte aligned (e.g., aligned to a multiple of eight bits) in length. Bit strings may be represented by one or more tables in which the most significant bit may be the leftmost bit of the first line of a table, and the least significant bit may be the rightmost bit on the last line of the table. The bit string may be read from left to right and then in the reading order of the lines (e.g., from the topmost line of the table to the bottommost line of the table). The bit order of a parameter field within a MAC PDU may be represented with the first and most significant bit in the leftmost bit and the last and least significant bit in the rightmost bit.

A MAC SDU may be a bit string that is byte aligned (e.g., aligned to a multiple of eight bits) in length. A MAC SDU may be comprised in a MAC PDU from the first bit onward. A MAC CE may be a bit string that is byte aligned (e.g., aligned to a multiple of eight bits) in length. A MAC subheader may be a bit string that is byte aligned (e.g., aligned to a multiple of eight bits) in length. A MAC subheader may be placed immediately in front of a corresponding MAC SDU, MAC CE, or padding. A wireless device (e.g., the MAC entity of the wireless device) may ignore a value of reserved bits in a downlink (DL) MAC PDU.

A MAC PDU may comprise one or more MAC subPDUs. A MAC subPDU of the one or more MAC subPDUs may comprise: a MAC subheader only (including padding); a MAC subheader and a MAC SDU; a MAC subheader and a MAC CE; a MAC subheader and padding, and/or a combination thereof. The MAC SDU may be of variable size. A MAC subheader may correspond to a MAC SDU, a MAC CE, or padding.

A MAC subheader may comprise: an R field with a one-bit length; an F field with a one-bit length; an LCID field with a multi-bit length; an L field with a multi-bit length; and/or a combination thereof, for example, if the MAC subheader corresponds to a MAC SDU, a variable-sized MAC CE, or padding.

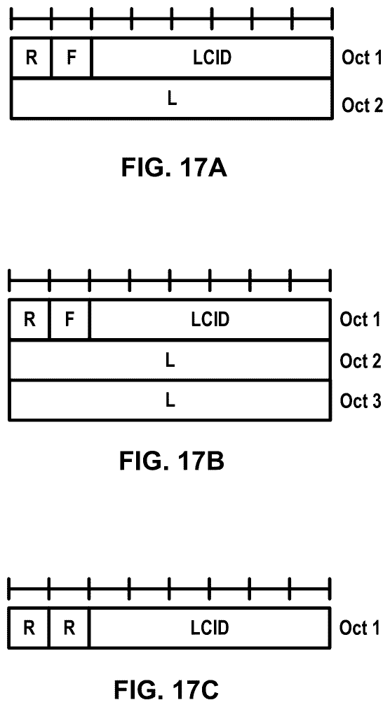

FIG. 17A shows an example of a MAC subheader. The MAC subheader may comprise an R field, an F field, an LCID field, and/or an L field. The LCID field may be six bits in length (or any other quantity of bits). The L field may be eight bits in length (or any other quantity of bits). Each of the R field and the F field may be one bit in length (or any other quantity of bits). FIG. 17B shows an example of a MAC subheader. The MAC subheader may comprise an R field, an F field, an LCID field, and/or an L field. Similar to the MAC subheader shown in FIG. 17A, the LCID field may be six bits in length (or any other quantity of bits), the R field may be one bit in length (or any other quantity of bits), and the F field may be one bit in length (or any other quantity of bits). The L field may be sixteen bits in length (or any other quantity of bits, such as greater than sixteen bits in length). A MAC subheader may comprise: an R field with a two-bit length (or any other quantity of bits) and/or an LCID field with a multi-bit length (or single bit length), for example, if the MAC subheader corresponds to a fixed sized MAC CE or padding. FIG. 17C shows an example of a MAC subheader. In the example MAC subheader shown in FIG. 17C, the LCID field may be six bits in length (or any other quantity of bits), and the R field may be two bits in length (or any other quantity of bits).

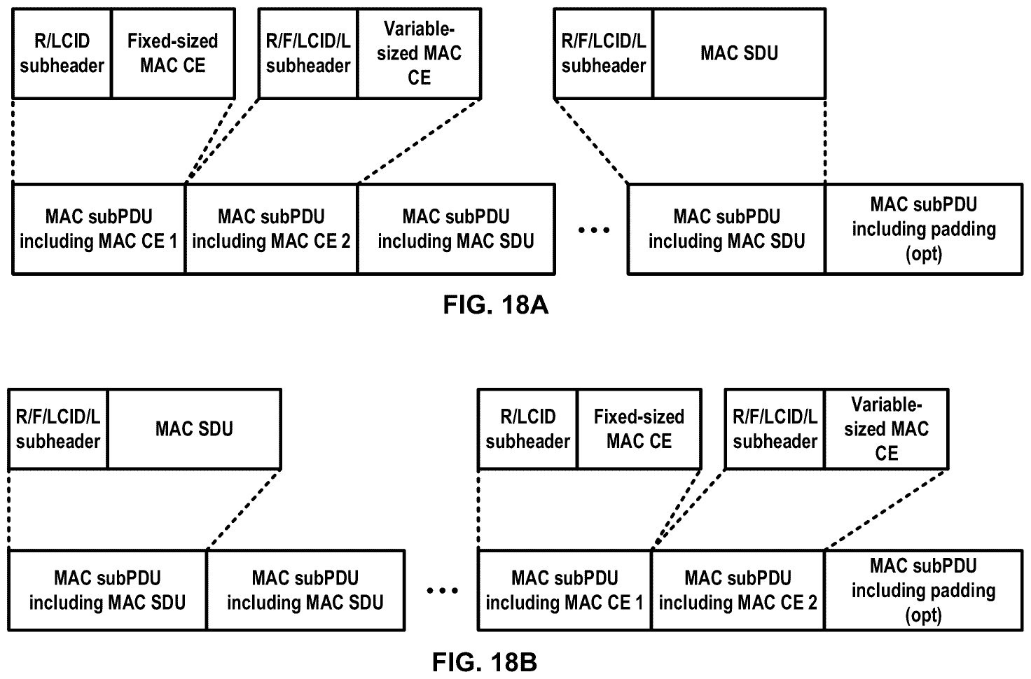

FIG. 18A shows an example of a MAC PDU (e.g., a DL MAC PDU). Multiple MAC CEs, such as MAC CE 1 and 2 shown in FIG. 18A, may be placed together (e.g., located within the same MAC PDU). A MAC subPDU comprising a MAC CE may be placed (e.g., located within a MAC PDU) before any MAC subPDU comprising a MAC SDU or a MAC subPDU comprising padding. MAC CE 1 may be a fixed-sized MAC CE that follows a first-type MAC subheader. The first-type MAC subheader may comprise an R field and an LCID field (e.g., similar to the MAC CE shown in FIG. 17C). MAC CE 2 may be a variable-sized MAC CE that follows a second-type MAC subheader. The second-type MAC subheader may comprise an R field, an F field, an LCID field and an L field (e.g., similar to the MAC CEs shown in FIG. 17A or FIG. 17B). The size of a MAC SDU that follows the second-type MAC subheader may vary.

FIG. 18B shows an example of a MAC PDU (e.g., a UL MAC PDU). Multiple MAC CEs, such as MAC CE 1 and 2 shown in FIG. 18B, may be placed together (e.g., located within the same MAC PDU). A MAC subPDU comprising a MAC CE may be placed (e.g., located within a MAC PDU) after all MAC subPDUs comprising a MAC SDU. The MAC subPDU and/or the MAC subPDU comprising a MAC CE may be placed (e.g., located within a MAC PDU) before a MAC subPDU comprising padding. Similar to the MAC CEs shown in FIG. 18A, MAC CE 1 shown in FIG. 18B may be a fixed-sized MAC CE that follows a first-type MAC subheader. The first-type MAC subheader may comprise an R field and an LCID field (e.g., similar to the MAC CE shown in FIG. 17C). Similar to the MAC CEs shown in FIG. 18A, MAC CE 2 shown in FIG. 18B may be a variable-sized MAC CE that follows a second-type MAC subheader. The second-type MAC subheader may comprise an R field, an F field, an LCID field and an L field (e.g., similar to the MAC CEs shown in FIG. 17A or FIG. 17B). The size of a MAC SDU that follows the second-type MAC subheader may vary.

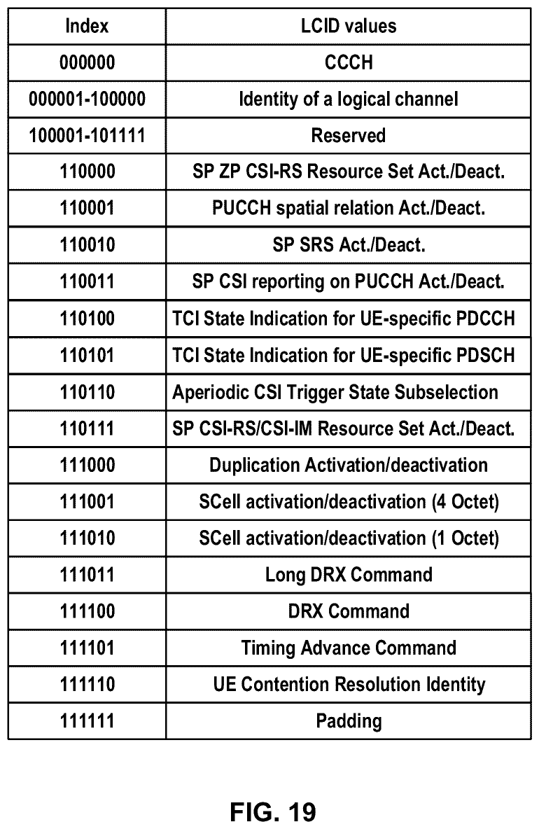

A base station (e.g., the MAC entity of a base station) may send/transmit one or more MAC CEs to a wireless device (e.g., a MAC entity of a wireless device). FIG. 19 shows example LCID values. The LCID values may be associated with one or more MAC CEs. The LCID values may be associated with a downlink channel, such as a DL-SCH. The one or more MAC CEs may comprise at least one of: an semi-persistent zero power CSI-RS (SP ZP CSI-RS) Resource Set Activation/Deactivation MAC CE, a PUCCH spatial relation Activation/Deactivation MAC CE, an SP SRS Activation/Deactivation MAC CE, an SP CSI reporting on PUCCH Activation/Deactivation MAC CE, a TCI State Indication for wireless device-specific (e.g., UE-specific) PDCCH MAC CE, a TCI State Indication for wireless device-specific (e.g., UE-specific) PDSCH MAC CE, an Aperiodic CSI Trigger State Subselection MAC CE, an SP CSI-RS/CSI interference measurement (CSI-IM) Resource Set Activation/Deactivation MAC CE, a wireless device (e.g., UE) contention resolution identity MAC CE, a timing advance command MAC CE, a DRX command MAC CE, a Long DRX command MAC CE, an SCell activation/deactivation MAC CE (e.g., 1 Octet), an SCell activation/deactivation MAC CE (e.g., 4 Octet), and/or a duplication activation/deactivation MAC CE. A MAC CE, such as a MAC CE sent/transmitted by a base station (e.g., a MAC entity of a base station) to a wireless device (e.g., a MAC entity of a wireless device), may be associated with (e.g., correspond to) an LCID in the MAC subheader corresponding to the MAC CE. Different MAC CEs may correspond to a different LCID in the MAC subheader corresponding to the MAC CE. An LCID having an index value “111011” in a MAC subheader may indicate that a MAC CE associated with the MAC subheader is a long DRX command MAC CE, for example, for a MAC CE associated with the downlink.

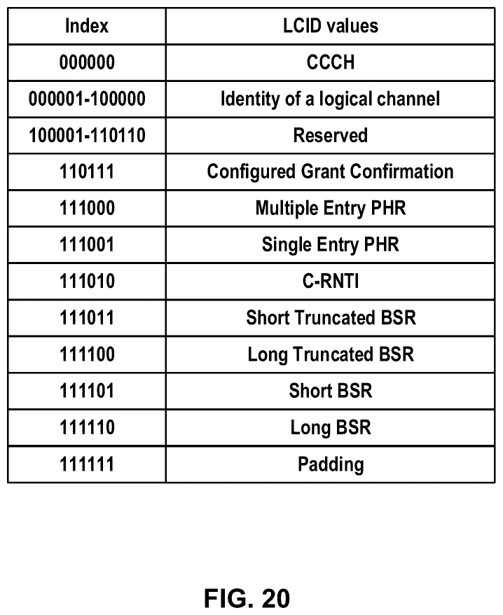

A wireless device (e.g., a MAC entity of a wireless device) may send/transmit to a base station (e.g., a MAC entity of a base station) one or more MAC CEs. FIG. 20 shows an example LCID values that may be associated with the one or more MAC CEs. The LCID values may be associated with an uplink channel, such as a UL-SCH. The one or more MAC CEs may comprise at least one of: a short buffer status report (BSR) MAC CE, a beam failure recovery (BFR) MAC CE, a truncated BFR MAC CE, a truncated enhanced BFR MAC CE, a long BSR MAC CE, a C-RNTI MAC CE, a configured grant confirmation MAC CE, a single entry power headroom report (PHR) MAC CE, a multiple entry PHR MAC CE, a short truncated BSR, and/or a long truncated BSR. A MAC CE may be associated with (e.g., correspond to) an LCID in the MAC subheader corresponding to the MAC CE. Different MAC CEs may correspond to a different LCID in the MAC subheader corresponding to the MAC CE. An LCID having an index value “111011” in a MAC subheader may indicate that a MAC CE associated with the MAC subheader is a short-truncated command MAC CE, for example, for a MAC CE associated with the uplink.

Two or more CCs may be aggregated, such as in carrier aggregation (CA). A wireless device may simultaneously receive and/or transmit data via one or more CCs, for example, depending on capabilities of the wireless device (e.g., using the technique of CA). A wireless device may support CA for contiguous CCs and/or for non-contiguous CCs. CCs may be organized into cells. CCs may be organized into one PCell and one or more SCells.

A wireless device may have an RRC connection (e.g., one RRC connection) with a network, for example, if the wireless device is configured with CA. During an RRC connection establishment/re-establishment/handover, a cell providing/sending/configuring NAS mobility information may be a serving cell. During an RRC connection re-establishment/handover procedure, a cell providing/sending/configuring a security input may be a serving cell. The serving cell may be a PCell. A base station may send/transmit, to a wireless device, one or more messages comprising configuration parameters of a plurality of SCells, for example, depending on capabilities of the wireless device.

A base station and/or a wireless device may use/employ an activation/deactivation mechanism of an SCell, for example, if configured with CA. The base station and/or the wireless device may use/employ an activation/deactivation mechanism of an SCell, for example, to improve battery use and/or power consumption of the wireless device. A base station may activate or deactivate at least one of one or more SCells, for example, if a wireless device is configured with the one or more SCells. An SCell may be deactivated unless an SCell state associated with the SCell is set to an activated state (e.g., “activated”) or a dormant state (e.g., “dormant”), for example, after configuring the SCell.

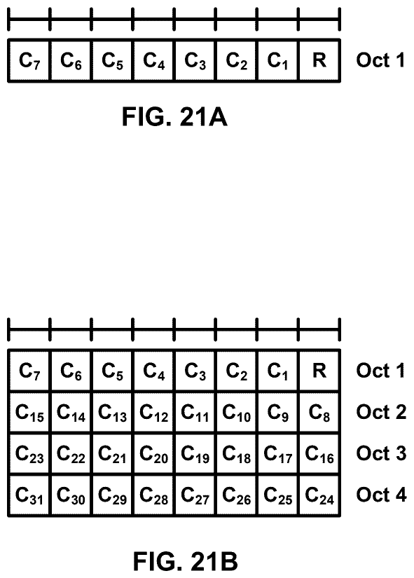

A wireless device may activate/deactivate an SCell. A wireless device may activate/deactivate a cell, for example, based on (e.g., after or in response to) receiving an SCell Activation/Deactivation MAC CE (e.g., as shown in FIG. 21A and/or FIG. 21B which will be described herein). The SCell Activation/Deactivation MAC CE may comprise one or more fields associated with one or more SCells, respectively, to indicate activation or deactivation of the one or more SCells. The SCell Activation/Deactivation MAC CE may correspond to one octet comprising seven fields associated with up to seven SCells, respectively, for example, if the aggregated cell has less than eight SCells. The SCell Activation/Deactivation MAC CE may comprise an R field. The SCell Activation/Deactivation MAC CE may comprise a plurality of octets comprising more than seven fields associated with more than seven SCells, for example, if the aggregated cell has more than seven SCells. A base station may send (e.g., transmit), to a wireless device, one or more messages comprising an SCell timer (e.g., sCellDeactivationTimer). A wireless device may deactivate an SCell, for example, based on (e.g., after or in response to) an expiry of the SCell timer.

A wireless device may perform operations, for example, based on (e.g., after or in response to) activating the SCell. The operations may comprise: SRS transmissions on the SCell; CQI/PMI/RI/CRI reporting for the SCell; PDCCH monitoring on the SCell; PDCCH monitoring for the SCell; and/or PUCCH transmissions on the SCell. The wireless device may start or restart a first SCell timer (e.g., sCellDeactivationTimer) associated with the SCell, for example, based on (e.g., after or in response to) activating the SCell. The wireless device may start or restart the first SCell timer in the slot when the SCell Activation/Deactivation MAC CE activating the SCell has been received. The wireless device may (re-) initialize one or more suspended configured uplink grants of a configured grant Type 1 associated with the SCell according to a stored configuration, for example, based on (e.g., after or in response to) the activating the SCell. The wireless device may trigger PHR, for example, based on (e.g., after or in response to) activating the SCell.

A wireless device may deactivate an activated SCell, for example, if/when the wireless device receives an SCell Activation/Deactivation MAC CE deactivating an activated SCell. The wireless device may deactivate the activated SCell, for example, if/when a first SCell timer (e.g., sCellDeactivationTimer) associated with an activated SCell expires. The wireless device may stop the first SCell timer associated with the activated SCell, for example, based on (e.g., after or in response to) the deactivating the activated SCell. The wireless device may clear one or more configured downlink assignments and/or one or more configured uplink grants of a configured uplink grant Type 2 associated with the activated SCell, for example, based on (e.g., after or in response to) the deactivating the activated SCell. The wireless device may: suspend one or more configured uplink grants of a configured uplink grant Type 1 associated with the activated SCell; and/or flush HARQ buffers associated with the activated SCell, for example, based on (e.g., after or in response to) the deactivating the activated SCell.

A wireless device may not perform operations, for example, if/when an SCell is deactivated. The operations may comprise: transmitting SRS on the SCell; reporting CQI/PMI/RI/CRI for the SCell; transmitting on UL-SCH on the SCell; transmitting on RACH on the SCell; monitoring at least one first PDCCH on the SCell; monitoring at least one second PDCCH for the SCell; and/or transmitting a PUCCH on the SCell. A wireless device may restart a first SCell timer (e.g., sCellDeactivationTimer) associated with the activated SCell, for example, if/when at least one first PDCCH on an activated SCell indicates an uplink grant or a downlink assignment. A wireless device may restart the first SCell timer (e.g., sCellDeactivationTimer) associated with the activated SCell, for example, if/when at least one second PDCCH on a serving cell (e.g., a PCell or an SCell configured with PUCCH, i.e., PUCCH SCell) scheduling the activated SCell indicates an uplink grant or a downlink assignment for the activated SCell. A wireless device may abort the ongoing random access procedure on the SCell, for example, if/when an SCell is deactivated, if there is an ongoing random access procedure on the SCell.

FIG. 21A shows an example SCell Activation/Deactivation MAC CE of one octet. A first MAC PDU subheader comprising a first LCID (e.g., ‘111010’ as shown in FIG. 19) may indicate/identify the SCell Activation/Deactivation MAC CE of one octet. The SCell Activation/Deactivation MAC CE of one octet may have a fixed size. The SCell Activation/Deactivation MAC CE of one octet may comprise a single octet. The single octet may comprise a first quantity/number of C-fields (e.g., seven or any other quantity/number) and a second quantity/number of R-fields (e.g., one or any other quantity/number).

FIG. 21B shows an example SCell Activation/Deactivation MAC CE of four octets. A second MAC PDU subheader comprising a second LCID (e.g., ‘111001’ as shown in FIG. 19) may indicate/identify the SCell Activation/Deactivation MAC CE of four octets. The SCell Activation/Deactivation MAC CE of four octets may have a fixed size. The SCell Activation/Deactivation MAC CE of four octets may comprise four octets. The four octets may comprise a third quantity/number of C-fields (e.g., 31 or any other quantity/number) and a fourth quantity/number of R-fields (e.g., 1 or any other quantity/number).

As shown in FIG. 21A and/or FIG. 21B, a Ci field may indicate an activation/deactivation status of an SCell with/corresponding to an SCell index i, for example, if an SCell with/corresponding to SCell index i is configured. An SCell with an SCell index i may be activated, for example, if the Ci field is set to one. An SCell with an SCell index i may be deactivated, for example, if the Ci field is set to zero. The wireless device may ignore the Ci field, for example, if there is no SCell configured with SCell index i. An R field may indicate a reserved bit. The R field may be set to zero or any other value (e.g., for other purposes).

A base station may configure a wireless device with uplink (UL) BWPs and downlink (DL) BWPs to enable bandwidth adaptation (BA) on a PCell. The base station may further configure the wireless device with at least DL BWP(s) (i.e., there may be no UL BWPs in the UL) to enable BA on an SCell, for example, if carrier aggregation is configured. An initial active BWP may be a first BWP used for initial access, for example, for a PCell. A first active BWP may be a second BWP configured for the wireless device to operate on a SCell upon the SCell being activated. A base station and/or a wireless device may independently switch a DL BWP and an UL BWP, for example, in paired spectrum (e.g., FDD). A base station and/or a wireless device may simultaneously switch a DL BWP and an UL BWP, for example, in unpaired spectrum (e.g., TDD).

A base station and/or a wireless device may switch a BWP between configured BWPs using a DCI message or a BWP inactivity timer. The base station and/or the wireless device may switch an active BWP to a default BWP based on (e.g., after or in response to) an expiry of the BWP inactivity timer associated with the serving cell, for example, if the BWP inactivity timer is configured for a serving cell. The default BWP may be configured by the network. One UL BWP for an uplink carrier (e.g., each uplink carrier) and one DL BWP may be active at a time in an active serving cell, for example, if FDD systems are configured with BA. One DL/UL BWP pair may be active at a time in an active serving cell, for example, for TDD systems. Operating on the one UL BWP and the one DL BWP (or the one DL/UL pair) may improve wireless device battery consumption. BWPs other than the one active UL BWP and the one active DL BWP that the wireless device may work on may be deactivated. The wireless device may not monitor PDCCH transmission, for example, on deactivated BWPs. The wireless device may not send (e.g., transmit) on PUCCH, PRACH, and UL-SCH, for example, on deactivated BWPs.

A serving cell may be configured with at most a first number/quantity (e.g., four) of BWPs. There may be one active BWP at any point in time, for example, for an activated serving cell. A BWP switching for a serving cell may be used to activate an inactive BWP and deactivate an active BWP at a time. The BWP switching may be controlled by a PDCCH transmission indicating a downlink assignment or an uplink grant. The BWP switching may be controlled by a BWP inactivity timer (e.g., bwp-InactivityTimer). The BWP switching may be controlled by a wireless device (e.g., a MAC entity of the wireless device) based on (e.g., after or in response to) initiating a Random Access procedure. One BWP may be initially active without receiving a PDCCH transmission indicating a downlink assignment or an uplink grant, for example, upon addition of an SpCell or activation of an SCell. The active BWP for a serving cell may be indicated by configuration parameter(s) (e.g., parameters of RRC message) and/or PDCCH transmission. A DL BWP may be paired with a UL BWP for unpaired spectrum, and BWP switching may be common for both UL and DL.

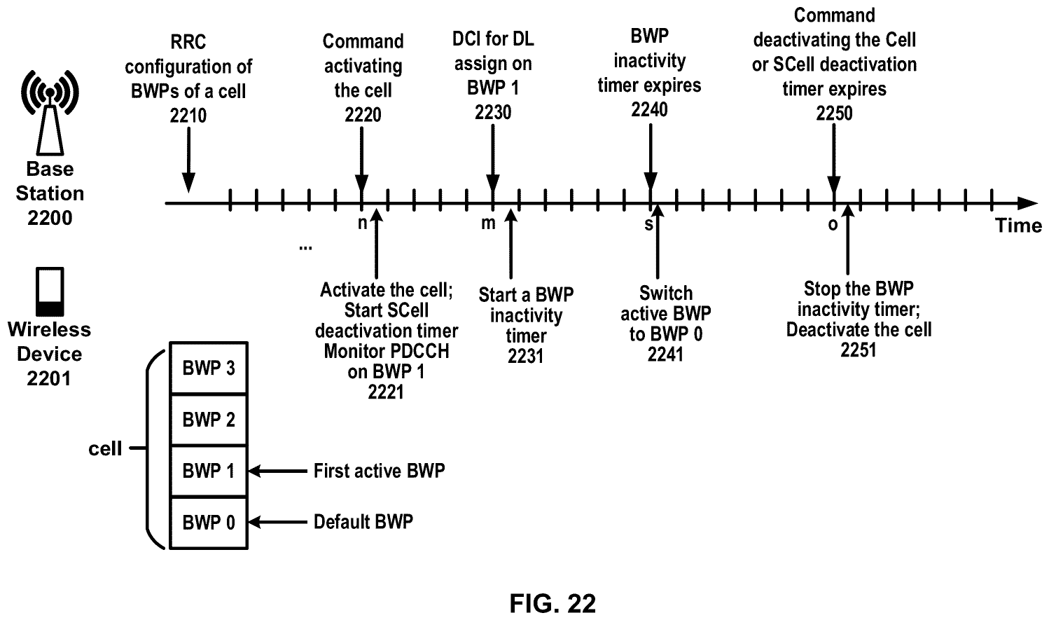

FIG. 22 shows an example of BWP activation/deactivation. The BWP activation/deactivation may be on a cell (e.g., PCell or SCell). The BWP activation/deactivation may be associated with BWP switching (e.g., BWP switching may comprise the BWP activation/deactivation). A wireless device 2201 may receive (e.g., detect) at step 2210, (e.g., from a base station 2200), at least one message (e.g., RRC message) comprising parameters of a cell and one or more BWPs associated with the cell. The RRC message may comprise at least one of: RRC connection reconfiguration message (e.g., RRCReconfiguration), RRC connection reestablishment message (e.g., RRCReestablishment), and/or RRC connection setup message (e.g., RRCSetup). Among the one or more BWPs, at least one BWP may be configured as the first active BWP (e.g., BWP 1), one BWP as the default BWP (e.g., BWP 0). The wireless device 2201 may receive (e.g., detect) a command at step 2220 (e.g., RRC message, MAC CE or DCI message) to activate the cell at an nth slot. The wireless device 2201 may not receive (e.g., detect) a command activating a cell, for example, a PCell. The wireless device 2201 may activate the PCell at step 2221, for example, after the wireless device 2201 receives/detects RRC message comprising configuration parameters of the PCell. The wireless device 2201 may start monitoring a PDCCH transmission on BWP 1 based on (e.g., after or in response to) activating the PCell at step 2221.

The wireless device 2201 may start (or restart) at step 2231, a BWP inactivity timer (e.g., bwp-InactivityTimer) at an mth slot based on (e.g., after or in response to) receiving a DCI message 2230 indicating DL assignment on BWP 1. The wireless device 2201 may switch back at step 2241 to the default BWP (e.g., BWP 0) as an active BWP, for example, if the BWP inactivity timer expires at step 2240, at sth slot. At step 2251, the wireless device 2201 may deactivate the cell and/or stop the BWP inactivity timer, for example, if a secondary cell deactivation timer (e.g., sCellDeactivationTimer) expires at step 2250 (e.g., if the cell is a SCell). The wireless device 2201 may not deactivate the cell and may not apply or use a secondary cell deactivation timer (e.g., sCellDeactivationTimer) on the PCell, for example, based on the cell being a PCell.

A wireless device (e.g., a MAC entity of the wireless device) may apply or use various operations on an active BWP for an activated serving cell configured with a BWP. The various operations may comprise at least one of: sending (e.g., transmitting) on UL-SCH, sending (e.g., transmitting) on RACH, monitoring a PDCCH transmission, sending (e.g., transmitting) PUCCH, receiving DL-SCH, and/or (re-) initializing any suspended configured uplink grants of configured grant Type 1 according to a stored configuration, if any.

A wireless device (e.g., a MAC entity of the wireless device) may not perform certain operations, for example, on an inactive BWP for an activated serving cell (e.g., each activated serving cell) configured with a BWP. The certain operations may include at least one of sending (e.g., transmit) on UL-SCH, sending (e.g., transmit) on RACH, monitoring a PDCCH transmission, sending (e.g., transmit) PUCCH, sending (e.g., transmit) SRS, or receiving DL-SCH. The wireless device (e.g., the MAC entity of the wireless device) may clear any configured downlink assignment and configured uplink grant of configured grant Type 2, and/or suspend any configured uplink grant of configured Type 1, for example, on the inactive BWP for the activated serving cell (e.g., each activated serving cell) configured with the BWP.

A wireless device may perform a BWP switching of a serving cell to a BWP indicated by a PDCCH transmission, for example, if a wireless device (e.g., a MAC entity of the wireless device) receives/detects the PDCCH transmission for the BWP switching and a random access procedure associated with the serving cell is not ongoing. A bandwidth part indicator field value may indicate the active DL BWP, from the configured DL BWP set, for DL receptions, for example, if the bandwidth part indicator field is configured in DCI format 1_1. A bandwidth part indicator field value may indicate the active UL BWP, from the configured UL BWP set, for UL transmissions, for example, if the bandwidth part indicator field is configured in DCI format 0_1.

A wireless device may be provided by a higher layer parameter such as a default DL BWP (e.g., Default-DL-BWP) among the configured DL BWPs, for example, for a primary cell. A default DL BWP may be the initial active DL BWP, for example, if a wireless device is not provided with the default DL BWP by the higher layer parameter (e.g., Default-DL-BWP). A wireless device may be provided with a higher layer parameter such as a value of a timer for the primary cell (e.g., bwp-InactivityTimer). The wireless device may increment the timer, if running, every interval of 1 millisecond for frequency range 1 or every 0.5 milliseconds for frequency range 2, for example, if the wireless device may not detect a DCI format 1_1 for paired spectrum operation or if the wireless device may not detect a DCI format 1_1 or DCI format 0_1 for unpaired spectrum operation during the interval.

Procedures of a wireless device on the secondary cell may be substantially the same as on the primary cell using a timer value for a secondary cell and the default DL BWP for the secondary cell, for example, if the wireless device is configured for the secondary cell with a higher layer parameter (e.g., Default-DL-BWP) indicating a default DL BWP among the configured DL BWPs and the wireless device is configured with a higher layer parameter (e.g., bwp-InactivityTimer) indicating the timer value. A wireless device may use an indicated DL BWP and an indicated UL BWP on a secondary cell respectively as a first active DL BWP and a first active UL BWP on the secondary cell or carrier, for example, if the wireless device is configured by a higher layer parameter (e.g., Active-BWP-DL-SCell) associated with the first active DL BWP and by a higher layer parameter (e.g., Active-BWP-UL-SCell) associated with the first active UL BWP on the secondary cell or carrier.

A set of PDCCH candidates for a wireless device to monitor may be referred to as PDCCH search space sets. A search space set may comprise a CSS set or a USS set. A wireless device may monitor PDCCH transmission candidates in one or more of the following search spaces sets: a Type0-PDCCH CSS set configured by pdcch-ConfigSIB1 in MIB or by searchSpaceSIB1 in PDCCH-ConfigCommon or by searchSpaceZero in PDCCH-ConfigCommon for a DCI format with CRC scrambled by a SI-RNTI on the primary cell of the MCG, a Type0A-PDCCH CSS set configured by searchSpaceOtherSystemInformation in PDCCH-ConfigCommon for a DCI format with CRC scrambled by a SI-RNTI on the primary cell of the MCG, a Type1-PDCCH CSS set configured by ra-SearchSpace in PDCCH-ConfigCommon for a DCI format with CRC scrambled by a RA-RNTI, a MsgB-RNTI, or a TC-RNTI on the primary cell, a Type2-PDCCH CSS set configured by pagingSearchSpace in PDCCH-ConfigCommon for a DCI format with CRC scrambled by a P-RNTI on the primary cell of the MCG, a Type3-PDCCH CSS set configured by SearchSpace in PDCCH-Config with searchSpaceType=common for DCI formats with CRC scrambled by INT-RNTI, SFI-RNTI, TPC-PUSCH-RNTI, TPC-PUCCH-RNTI, TPC-SRS-RNTI, CI-RNTI, or PS-RNTI and, for the primary cell, C-RNTI, MCS-C-RNTI, or CS-RNTI(s), and a USS set configured by SearchSpace in PDCCH-Config with searchSpaceType=ue-Specific for DCI formats with CRC scrambled by C-RNTI, MCS-C-RNTI, SP-CSI-RNTI, CS-RNTI(s), SL-RNTI, SL-CS-RNTI, or SL-L-CS-RNTI.

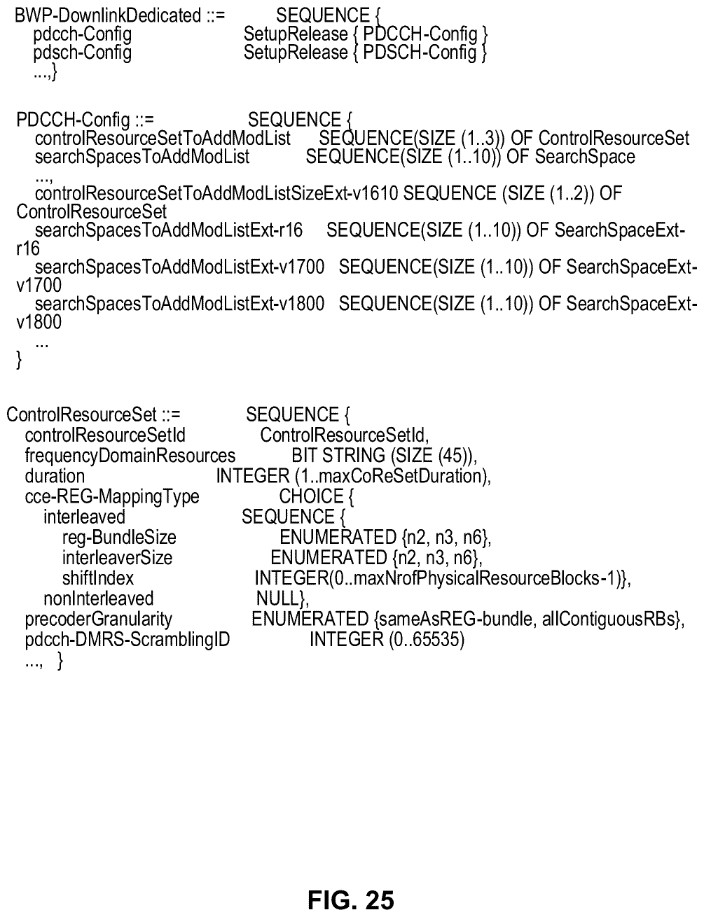

A wireless device may determine a PDCCH transmission monitoring occasion on an active DL BWP based on one or more PDCCH transmission configuration parameters (e.g., as described with respect to FIG. 25) comprising at least one of: a PDCCH transmission monitoring periodicity, a PDCCH transmission monitoring offset, or a PDCCH transmission monitoring pattern within a slot. For a search space set (SS s), the wireless device may determine that a PDCCH transmission monitoring occasion(s) exists in a slot with number/quantity n_{s,f}^{μ} in a frame with number/quantity n_{f} if (n_{f}·Nₛₗₒₜ^{frame,μ}n_{s,f}^{μ}−oₛ)mod kₛ=0. Nₛₗₒₜ^{frame,μ} may be a number/quantity of slots in a frame if numerology μ is configured. oₛ may be a slot offset indicated in the PDCCH transmission configuration parameters. kₛ may be a PDCCH transmission monitoring periodicity indicated in the PDCCH transmission configuration parameters. The wireless device may monitor PDCCH transmission candidates for the search space set for Tₛ consecutive slots, starting from slot n_{s,f}^{μ}, and may not monitor PDCCH transmission candidates for search space set s for the next kₛ−Tₛ consecutive slots. A USS at CCE aggregation level L ∈ {1, 2, 4, 8, 16} may be defined by a set of PDCCH transmission candidates for CCE aggregation level L.

A wireless device may decide, for a search space set s associated with CORESET p, CCE indexes for aggregation level L corresponding to PDCCH transmission candidate m_{s,n}_{_{Cl}} of the search space set in slot n_{s,f}^{μ} for an active DL BWP of a serving cell corresponding to carrier indicator field value n_{Cl} as

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , ma x}^{( L )}} ⌋ + {n}_{CI} ) mod ⌊ {N}_{CCE , p} / L ⌋ \} + i ,$$

where,

$${Y}_{p , {n}_{s , f}^{μ}} = 0$$

### for any CSS;

$${Y}_{p , {n}_{s , f}^{μ}} = ( {A}_{p} \cdot {Y}_{p , {n}_{s , f}^{μ} - 1} )$$

mod D for a USS, Y_{p,-1}=N_{RNTI}≠0, Aₚ=39827 for p mod 3=0, Aₚ=39829 for p mod 3=1, Aₚ=39839 for p mod 3=2, and D=65537; i=0, . . . , L−1; N_{CCE,p} is the number/quantity of CCEs, numbered/quantified from 0 to N_{CCE,p}−1, in CORESET p; n_{Cl} is the carrier indicator field value if the wireless device is configured with a carrier indicator field by CrossCarrierSchedulingConfig for the serving cell on which PDCCH transmission is monitored; otherwise, including for any CSS, n_{Cl}=0; m_{s,n}_{_{Cl}}=0, . . . ,

$${M}_{s , {n}_{CI}}^{( L )} - 1 ,$$

where

$${M}_{s , {n}_{CI}}^{( L )}$$

is the number/quantity of PDCCH transmission candidates the wireless device is configured to monitor for aggregation level L of a search space set s for a serving cell corresponding to n_{Cl}; for any CSS,

$${M}_{s , m ax}^{( L )} = {M}_{s , 0}^{( L )} ;$$

### for a USS,

$${M}_{s , m ax}^{( L )}$$

is the maximum of

$${M}_{s , {n}_{CI}}^{( L )}$$

over configured n_{Cl} values for a CCE aggregation level L of search space set s; and the RNTI value used for n_{RNTI} is the C-RNTI.

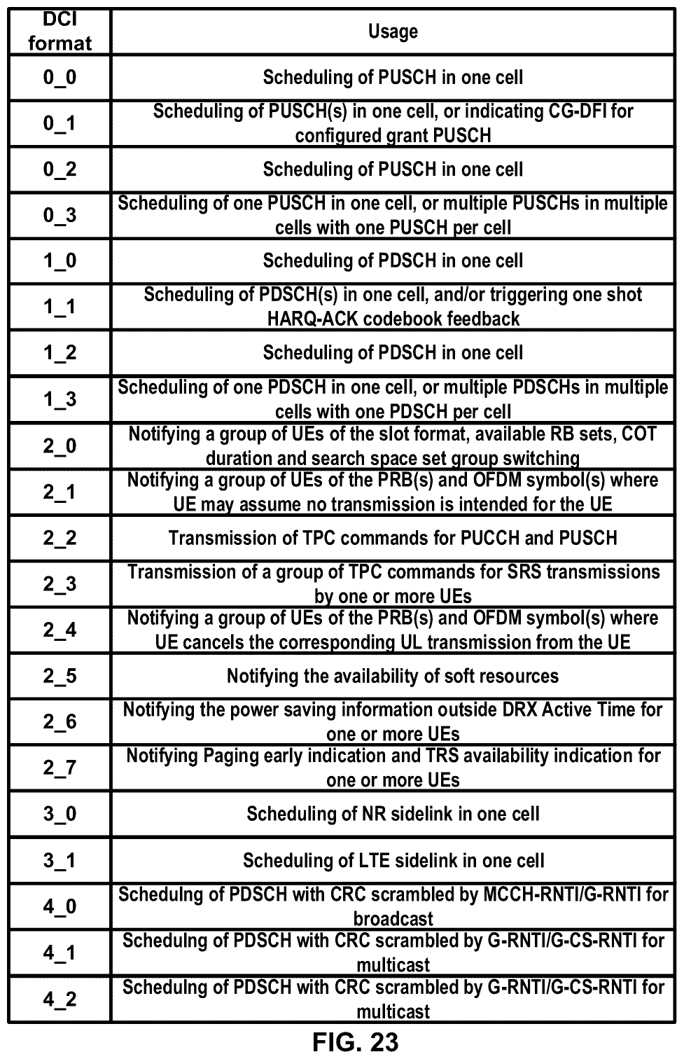

A wireless device may monitor a set of PDCCH transmission candidates according to configuration parameters of a search space set comprising a plurality of search spaces. The wireless device may monitor a set of PDCCH transmission candidates in one or more CORESETs for detecting one or more DCI messages. A CORESET may be configured, for example, as described with respect to FIG. 25. Monitoring may comprise decoding one or more PDCCH transmission candidates of the set of the PDCCH transmission candidates according to the monitored DCI formats. Monitoring may comprise decoding DCI content of one or more PDCCH transmission candidates with possible (or configured) PDCCH transmission locations, possible (or configured) PDCCH transmission formats (e.g., number/quantity of CCEs, number/quantity of PDCCH transmission candidates in common search spaces, and/or number/quantity of PDCCH transmission candidates in the wireless device-specific search spaces (e.g., the UE-specific search spaces)) and possible (or configured) DCI formats. The decoding may be referred to as blind decoding. The possible DCI formats may be based on examples of FIG. 23.

FIG. 23 shows examples of various DCI formats. The various DCI formats may be used, for example, by a base station to send (e.g., transmit) control information (e.g., to a wireless device and/or to be used by the wireless device) for PDCCH transmission monitoring. Different DCI formats may comprise different DCI fields and/or have different DCI payload sizes. Different DCI formats may have different signaling purposes. DCI format 0_0 may be used to schedule PUSCH transmission in one cell. DCI format 0_1 may be used to schedule one or multiple PUSCH transmissions in one cell or indicate CG-DFI (configured grant-Downlink Feedback Information) for configured grant PUSCH transmission, etc. The DCI format(s), that the wireless device may monitor for reception via a search space, may be configured. DCI format 0_3 may be used to schedule one PUSCH in one cell, or multiple PUSCHs in multiple cells with one PUSCH per cell. DCI format 1_3 may be used to schedule one PDSCH in one cell, or multiple PDSCHs in multiple cells with one PDSCH per cell.

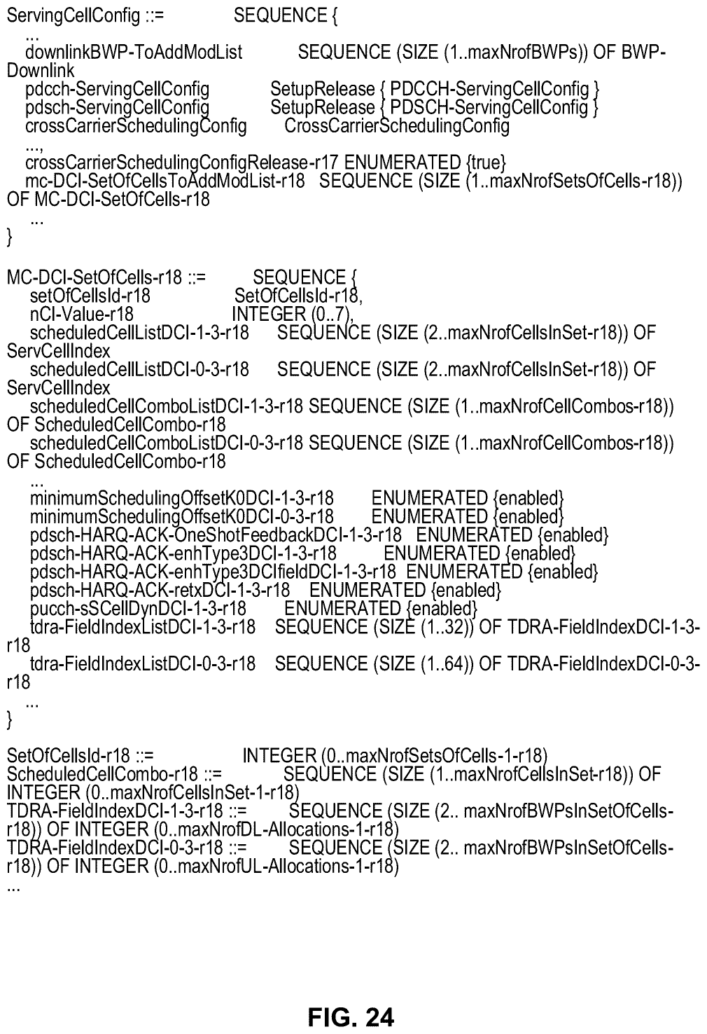

FIG. 24 shows an example of RRC configuration of a serving cell. A base station may send (e.g., transmit), to a wireless device, one or more RRC messages comprising configuration parameters of a serving cell, for example, in a serving cell configuration information element (e.g., ServingCellConfig IE). A serving cell configuration information element (e.g., ServingCellConfig IE) may be used to configure (e.g., add or modify) the wireless device with a serving cell. The serving cell may be the special cell (SpCell) or a secondary cell (SCell) of an master cell group (MCG) or secondary cell group (SCG). The configuration parameters may be specific to (e.g., mostly) the wireless device. The configuration parameters may be specific to (e.g., partly, or part of) the cell. For example, the configuration parameters may be specific to the cell in additionally configured bandwidth parts. Reconfiguration between a PUCCH-carrying SCell and PUCCH-less SCell may be realized (e.g., only supported), for example, using an SCell release and addition.

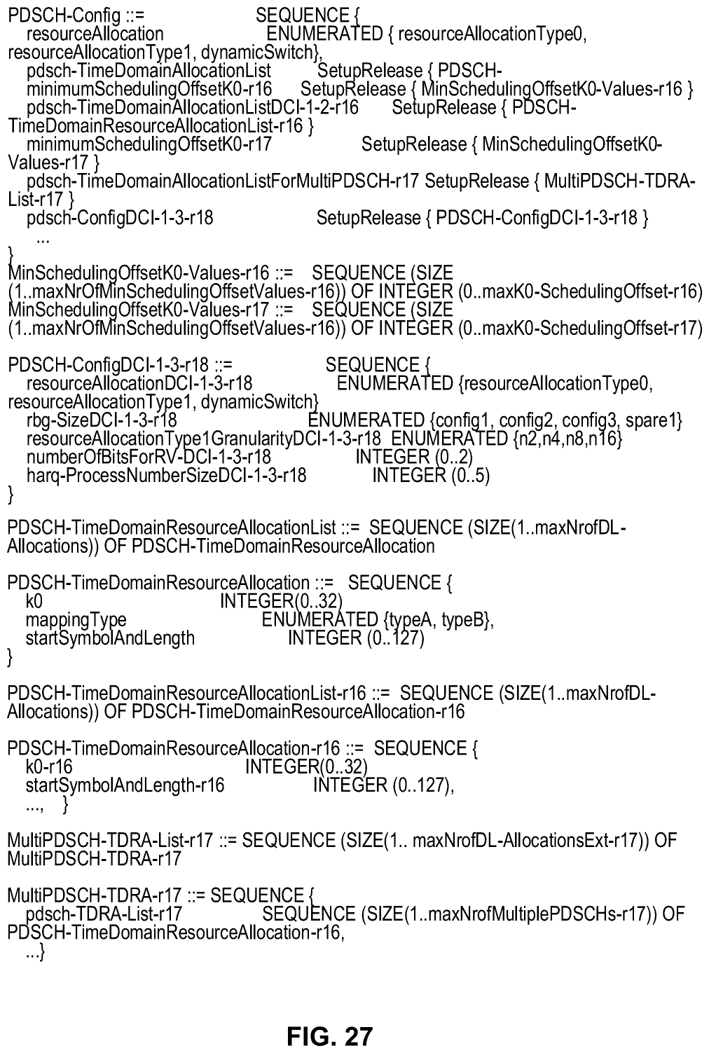

One or more parameters configured in a serving cell configuration information element (e.g., ServingCellConfig) may indicate a plurality of BWPs (e.g., downlink BWPs and/or uplink BWPs) of the cell, PDSCH configuration (e.g., pdsch-ServingCellConfig), PUSCH configuration (e.g., pdcch-ServingCellConfig), cross carrier scheduling configuration (e.g., crossCarrierSchedulingConfigRelease-r17) for single-cell cross-carrier scheduling, and/or multi-cell scheduling (e.g., mc-DCI-SetOfCellsToAddModList-r18), for example, as shown in FIG. 24. A (e.g., each) downlink BWP of the serving cell may be associated with BWP-specific PDCCH/PDSCH parameters. BWP-specific PDCCH/PDSCH parameters may be configured in information elements such as PDCCH-Config and/or PDSCH-Config as shown in FIG. 25 and/or FIG. 27 (which will be described later). A BWP may be activated or deactivated, for example, based on examples of FIG. 22.

An information element (e.g., mc-DCI-SetOfCellsToAddModList-r18 in FIG. 24) for a 3GPP Release (e.g., 3GPP Release 18) multi-carrier/cell scheduling may comprise a plurality of carrier/cell sets, for multi-cell PDSCH/PUSCH scheduling from the serving cell. Each set may comprise a number/quantity of carriers/cells defined by an information element (e.g., MC-DCI-SetOfCells-r18 in FIG. 24). The maximum number/quantity of sets may be equal to or less than a value of an information element (e.g., maxNrofSetsOfCells-r18 in FIG. 24). The value of the information element (e.g., maxNrofSetsOfCells-r18 in FIG. 24) may be considered (e.g., reported) as UE capability. Up to 4 (or any other number/quantity) sets of cells may be configured per PUCCH group. PUCCH transmissions for cells configured with the same PUCCH group may be sent (e.g., transmitted) via the same PUCCH cell. Primary cell (PCell) cannot be included in either information element ScheduledCellListDCI-1-3 or information element ScheduledCellListDCI-0-3, for example, if/when the information element (e.g., mc-DCI-SetOfCellsToAddModList-r18) for 3GPP Release 18 multi-carrier/cell scheduling is configured to/for a SCell.

An information element (e.g., MC-DCI-SetOfCells-r18 in FIG. 24) may comprise a cell/carrier set ID (e.g., setOfCellsld-r18 in FIG. 24) identifying the cell set, a value (e.g., nCI value, e.g., nCI-Value-r18 in FIG. 24) identifying the cell set for search space candidate determination, a list of scheduled cells (e.g., scheduledCellListDCI-1-3-r18 for PDSCH scheduling, and/or scheduledCellListDCI-0-3-r18 for PUSCH scheduling), a list of scheduled cell combo (e.g., scheduledCellComboListDCI-1-3-r18 for PDSCH scheduling, and/or scheduledCellComboListDCI-0-3-r18 for PUSCH scheduling), a PDSCH TDRA field index list (e.g., tdra-FieldIndexListDCI-1-3-r18 in FIG. 24), a PUSCH TDRA field index list (e.g., tdra-FieldIndexListDCI-0-3-r18 in FIG. 24), etc. Each of the scheduled cells may be identified by a respective serving cell index. Each of the scheduled cell combo may be identified by a respective serving cell index.

An information element (e.g., scheduledCellListDCI-1-3-r18 and/or scheduledCellListDCI-0-3-r18 in FIG. 24) for multi-cell scheduling via DCI may configure a list of (e.g., possible) co-scheduled cells in the set for DL scheduling (e.g., via DCI format 1_3 and/or DCI format 0_3, respectively). The co-scheduled cells may be scheduled cells via/by the same DCI. The serving cells in the list may be in an ascending order of serving cell indices/indexes and/or may be mapped to index (e.g., {0, 1, 2, 3}) in the set. Total number/quantity of cells within the same set of cells (e.g., in scheduledCellListDCI-1-3 and/or scheduledCellListDCI-0-3) may be up to 4 (or any other number/quantity). An information element (e.g., scheduledCellComboListDCI-1-3-r18 and/or scheduledCellComboListDCI-0-3-r18 in FIG. 24) may configure a table for combinations of co-scheduled cells for DL scheduling (e.g., via DCI format 1_3 and/or DCI format 0_3, respectively).

An information element (e.g., tdra-FieldIndexListDCI-1-3-r18 in FIG. 24) may configure one or more rows (e.g., each row) of a joint TDRA field table for DL scheduling (e.g., via DCI format 1_3) containing applicable TDRA field indexes (or TDRA indexes) for multiple BWPs/cells. The TDRA index for a BWP of a cell may point to a corresponding TDRA in a TDRA table (e.g., a TDRA table applicable for DCI format 1_1). The order of TDRA index in each row may refer to an BWP ID (e.g., BWP-Id) for a cell and the order of cells in an information element (e.g., scheduledCellListDCI-1-3). For example, a first TDRA index in a row may be for the smallest BWP ID (e.g., BWP-Id) that may be scheduled (e.g., by the DCI format 1_3, as specified in TS 38.212) of the first cell in the information element (e.g., scheduledCellListDCI-1-3). A second TDRA index in a row may be for the second smallest BWP ID (e.g., BWP-Id) that may be scheduled (e.g., by the DCI format 1_3, as specified in 38.212) of the first cell, and so on. The number/quantity of TDRA indices/indexes in a row (e.g., of TDRA-FieldIndexDCI-1-3) may be the same as the total number/quantity of BWPs that may be scheduled (e.g., by the DCI format 1_3, as specified in 38.212) across cells included in the information element (e.g., scheduledCellListDCI-1-3).

An information element (e.g., tdra-FieldIndexListDCI-0-3-r18 in FIG. 24) may configure one or more rows (e.g., each row) of a joint TDRA field table for UL scheduling (e.g., via DCI format 0_3) containing applicable TDRA field indexes for multiple BWPs/cells. The TDRA index for a BWP of a cell may point to a corresponding TDRA in a TDRA table (e.g., a TDRA table applicable for DCI format 0_1). The order of TDRA index in each row may refer to an BWP ID (e.g., BWP-Id) for a cell and the order of cells in an information element (e.g., scheduledCellListDCI-0-3). For example, a first TDRA index in a row may be for the smallest BWP ID (e.g., BWP-Id) that may be scheduled (e.g., by the DCI format 0_3, as specified in TS 38.212) of the first cell in the information element (e.g., scheduledCellListDCI-0-3). A second TDRA index in a row may be for the second smallest BWP ID (e.g., BWP-Id) that may be scheduled (e.g., by the DCI format 0_3, as specified in 38.212) of the first cell, and so on. The number/quantity of TDRA indices/indexes in a row (e.g., of TDRA-FieldIndexDCI-01-3) may be the same as the total number/quantity of BWPs that may be scheduled (e.g., by the DCI format 0_3, as specified in 38.212) across cells included in the information element (e.g., scheduledCellListDCI-0-3).

FIG. 25 shows an example of PDCCH configuration parameters associated with a BWP of a serving cell. A base station may send (e.g., transmit), to a wireless device, one or more RRC messages comprising configuration parameters of a BWP of a serving cell, for example, in an information element (e.g., BWP-DownlinkDedicated) for a downlink BWP that is dedicated to the wireless device. The information element (e.g., BWP-DownlinkDedicated) may be used to configure the common parameters of a downlink BWP. The common parameters may be cell-specific. The network may enable (e.g., necessary) alignment with corresponding parameters of other wireless devices. The common parameters of an initial bandwidth part of the PCell may be provided via system information. For (e.g., all) other serving cells, the network may provide the common parameters via dedicated signaling. The information element (e.g., BWP-DownlinkDedicated) of a BWP may be associated with BWP-specific PDCCH configuration (e.g., pdcch-Config) and/or BWP-specific PDSCH configuration (e.g., pdsch-Config). The information element pdsch-Config will be described herein with respect to FIG. 27.

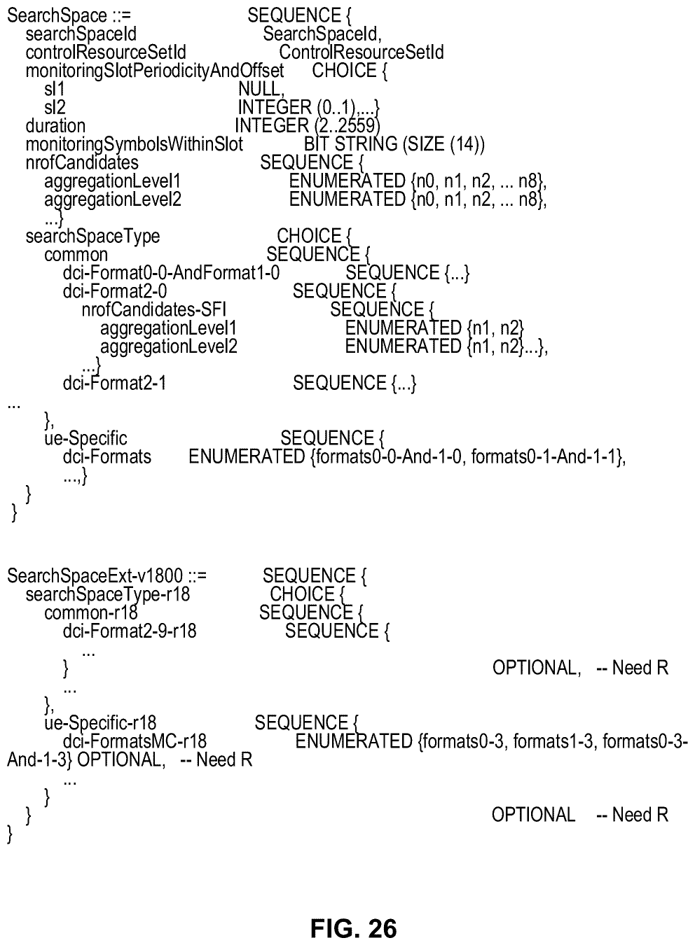

The PDCCH configuration information element (e.g., pdcch-Config in FIG. 25) may configure/indicate a plurality of control resources sets (e.g., controlResourceSetToAddModList) for PDCCH monitoring on the BWP and/or a plurality of search spaces (e.g., searchSpaceToAddList). A search space may be configured as shown in FIG. 26 which will be described herein.

A control resource set may be configured by a control resource set information element (e.g., ControlResourceSet in FIG. 25). The control resource set may be associated with a control resource set identifier, frequency domain resource indication, time domain duration, and/or CCE-to-REG mapping type indication, etc.

FIG. 26 shows an example of search space configuration parameters. A base station may send (e.g., transmit), to a wireless device, one or more RRC messages comprising configuration parameters of a search space of a BWP of a serving cell, for example, in an information element (e.g., SearchSpace). The information element (e.g., SearchSpace) may be used to define/indicate/configure how/where to search for PDCCH candidates. A (e.g., each) search space may be associated with a control resource set information element (e.g., one ControlResourceSet). Optional fields (e.g., all optional fields except for nrofCandidates) may be absent, for example, for a scheduled SCell in the case of cross carrier scheduling. The optional fields may be absent, for example, regardless of their presence conditions. Optional fields (e.g., all optional fields except for nrofCandidates) of the search space in the scheduled SpCell may be absent, for example, for a scheduled SpCell in the case of the cross carrier scheduling. Optional fields (e.g., all optional fields except for nrofCandidates) of the search space in the scheduled SpCell may be absent, for example, if the search space may be linked to another search space in the scheduling SCell. Optional fields (e.g., all optional fields except for nrofCandidates) of the search space in the scheduled SpCell may be absent, for example, regardless of their presence conditions.

A search space may be configured with DCI formats for multi-cell scheduling. The DCI formats for the multi-cell scheduling may be indicated by an information element (e.g., dci-FormatsMC-r18 in FIG. 26). The information element (e.g., dci-FormatsMC-r18) may indicate whether DCI format 0_3 only, DCI format 1_3 only, or both DCI format 0_3 and 1_3 may be supported on the BWP of the serving cell.

FIG. 27 shows an example of PDSCH configuration parameters of a BWP of a serving cell. A base station may send (e.g., transmit), to a wireless device, one or more RRC messages comprising configuration parameters of a PDSCH of a BWP of a serving cell, for example, in an information element (e.g., PDSCH-Config).

The information element (e.g., PDSCH-Config in FIG. 27) of a BWP may indicate a resource allocation type (e.g., resourceAllocation) for the PDSCH of the BWP, a plurality of PDSCH time domain allocation lists (e.g., pdsch-TimeDomainAllocationList, pdsch-Time DomainAllocationList-r16, pdsch-TimeDomainAllocationListDCI-1-2-r16, pdsch-TimeDomainAllocationListForMultiPDSCH-r17 in FIG. 27) for time-domain configurations for timing of DL assignment to DL data, and/or a PDSCH configuration for DCI format 1_3 (e.g., pdsch-ConfigDCI-1-3-r18 in FIG. 27), etc.

The field pdsch-Time DomainAllocationList (with or without suffix) may apply to (e.g., be used for) DCI format 1_0, DCI format 1_1, and/or DCI format 1_3. The field pdsch-TimeDomainAllocationList (with or without suffix) may apply to (e.g., be used for) DCI format 1_2, for example, if the field pdsch-Time DomainAllocationListDCI-1-2 is not configured. The field pdsch-TimeDomainAllocationList (with or without suffix) may apply to (e.g., be used for) DCI format 1_2, for example, if the field pdsch-TimeDomainAllocationListDCI-1-2 is configured. The field pdsch-TimeDomainAllocationListForMultiPDSCH may apply to (e.g., be used for) DCI format 1_1.

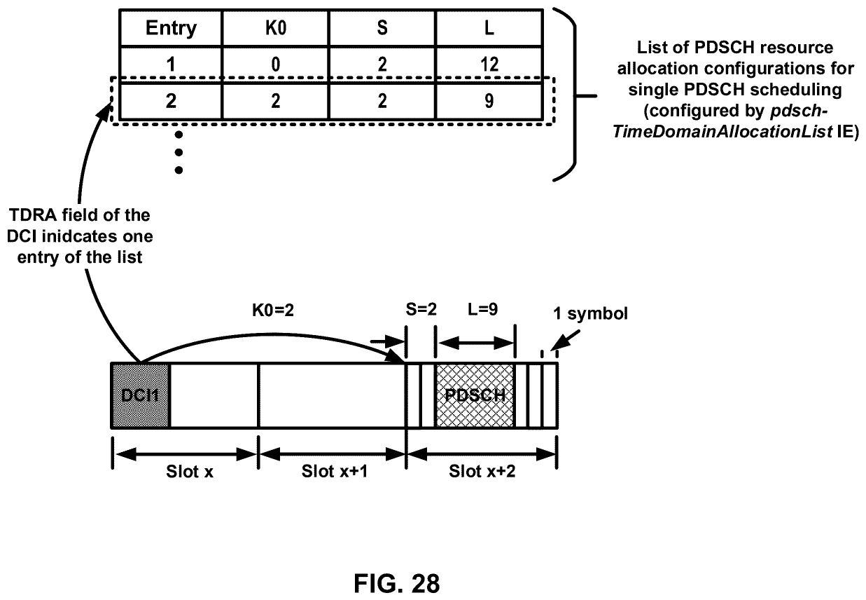

The field pdsch-TimeDomainAllocationList may comprise a plurality of PDSCH time domain allocations (e.g., pdsch-TimeDomainAllocation in FIG. 27). Each PDSCH time domain allocation (e.g., pdsch-TimeDomainAllocation) may be associated with K0, mapping type indication, and/or start/starting symbol and length (e.g., startingSymbolAndLength) indication. The field pdsch-TimeDomainAllocationList may be used for single-PDSCH scheduling, for example, based on examples of FIG. 28 which will be described herein.

The field pdsch-TimeDomainAllocationList-r16 may comprise a plurality of PDSCH time domain allocations from Release 16 (e.g., pdsch-TimeDomainAllocation-r16). Each PDSCH time domain allocation from Release 16 (e.g., pdsch-TimeDomainAllocation-r16) may be associated with K0, mapping type indication, and/or starting symbol and length (e.g., startingSymbolAndLength) indication. The field pdsch-TimeDomainAllocationList-16 may be used for single-PDSCH scheduling, for example, based on examples of FIG. 28 which will be described herein.

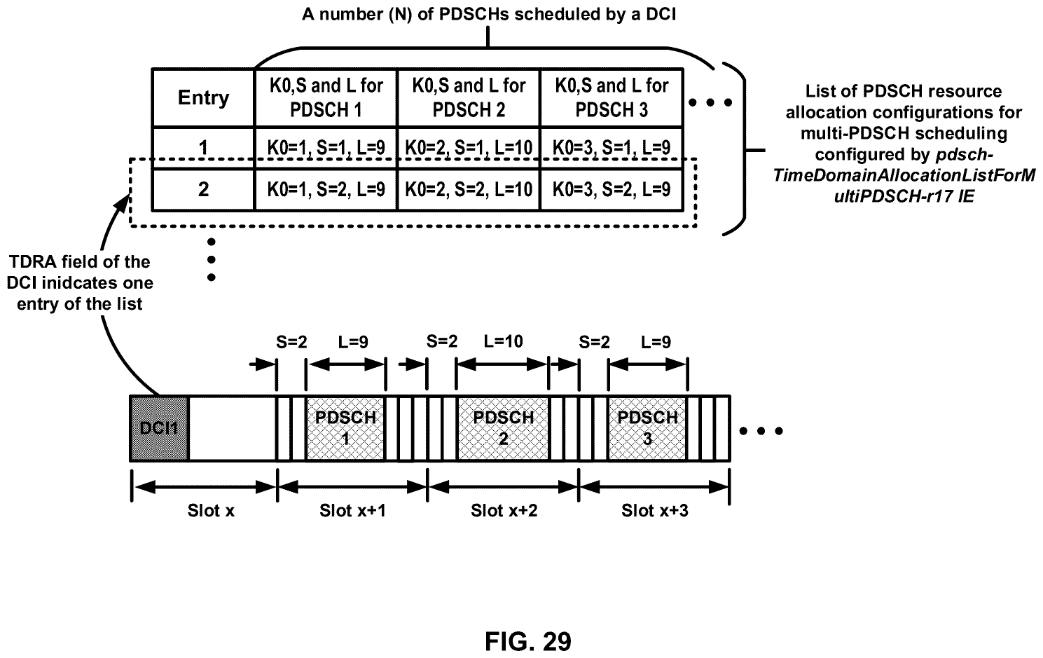

The field pdsch-TimeDomainAllocationListForMultiPDSCH-r17 may be used to set up or release a multiple PDSCH TDRA list from Release 17 (e.g., MultiPDSCH-TDRA-List-r17). The multiple PDSCH TDRA list from Release 17 (e.g., MultiPDSCH-TDRA-List-r17) may comprise a list of multiple PDSCH TDRAs (e.g., multiPDSCH-TDRA-r17). Each entry of the list may comprise a plurality of PDSCH TDRA configurations. Each PDSCH TDRA configuration may correspond to a respective PDSCH of multiple PDSCHs scheduled for the BWP of the serving cell. Each PDSCH TDRA configuration may be indicated by the information element of PDSCH time domain allocation from Release 16 (e.g., pdsch-TimeDomainAllocation-r16). The field pdsch-TimeDomainAllocationListForMultiPDSCH-r17 may be used for multi-PDSCH scheduling, for example, based on examples of FIG. 29 which will be described herein.

The field pdsch-ConfigDCI-1-3-r18 may be used to configure PDSCH configurations of the BWP of the serving cell for multi-cell scheduling from another serving cell or a scheduling cell. The field pdsch-ConfigDCI-1-3-r18 may comprise a resource allocation type (e.g., resourceAllocationDCI-1-3-r18) of the PDSCH allocation if/when scheduled by DCI format 1_3, a number/quantity of bits for RV (e.g., numberOfBitsForRV-DCI-1-3-r18) in DCI format 1_3 scheduling the PDSCH of this BWP of this co-scheduled cell, and/or a number/quantity of bits for HARQ process number (e.g., harq-ProcessNumberSizeDCI-1-3-r18) in DCI format 1_3 scheduling the PDSCH of this BWP of this co-scheduled cell, etc.

FIG. 28 shows an example of single PDSCH scheduling on a serving cell. A base station may send (e.g., transmit), to a wireless device, RRC message(s) comprising configuration parameters of a PDSCH on a BWP of a cell. The configuration parameters may comprise a list of PDSCH resource allocation configurations (e.g., pdsch-TimeDomainAllocationList or pdsch-TimeDomainAllocationList-r16 as shown in FIG. 27) for single-PDSCH scheduling on the BWP.

The list may comprise a number/quantity of entries indicating PDSCH time domain resource allocations in a slot, for example, as shown in FIG. 28. Each entry of the list may comprise a value (e.g., K0 value) indicating a slot offset. The slot offset may be for a second slot on which a PDSCH may be sent (e.g., transmitted), from a first slot on which DCI corresponding to the PDSCH may be sent (e.g., transmitted). Each entry of the list may comprise one or more starting symbol and length indications indicating a starting symbol(S) of the slot of the PDSCH and a length (L) of a number/quantity of symbols of the PDSCH in the slot. The total number/quantity of the entries in the list may be 4, 8, 16, 32, 64, or any other number/quantity.

A base station may send (e.g., transmit), to a wireless device, DCI (e.g., DCI format 0_1/1_1/1_2 . . . ) comprising a time domain resource allocation (TDRA) field indicating an entry of the list for PDSCH time domain resource indication. The TDRA field may have a number/quantity of bits corresponding to the number/quantity of the entries. For example, the TDRA field may have 2 bits if the total number/quantity of the entries is 4, 3 bits if the total number is 8, 4 bits if the total number is 16, etc.

DCI (e.g., DCI1) may comprise an TDRA field indicating the second entry of the list, for example, as shown in FIG. 28. The second entry of the list may indicate K0=2, S=2 and L=9. The wireless device may determine PDSCH scheduled by the DCI (e.g., DCI1), for example, based on (e.g., after or in response to) receiving the DCI (e.g., DCI1) with the TDRA field (e.g., in slot x). For example, the wireless device may determine PDSCH scheduled by the DCI1 is in slot x+2 (e.g., K0=2), with 2nd symbol (e.g., S=2) of the slot as starting symbol of the PDSCH and a total number/quantity of symbols of the PDSCH as 9 (e.g., L=9). The wireless device may receive the TB via the PDSCH resources, for example, based on determined PDSCH resources (e.g., in slot x+2).

FIG. 29 shows an example of multiple-PDSCH scheduling on a serving cell. A base station may send (e.g., transmit), to a wireless device, RRC message(s) comprising configuration parameters of a PDSCH on a BWP of a cell. The configuration parameters may comprise a list of PDSCH resource allocation configurations (e.g., pdsch-TimeDomainAllocaitonListForMultiPDSCH-r17 as shown in FIG. 27) for multi-PDSCH scheduling on the BWP.

The list may comprise a first number/quantity of entries indicating PDSCH time domain resource allocations in a second number/quantity of (e.g., consecutive or non-consecutive) slots, for example, as shown in FIG. 29. The total (the first) number/quantity of the entries in the list may be 4, 8, 16, 32, 64, or any other number/quantity. Each entry of the list may comprise, for each PDSCH of the multiple PDSCHs, a value (e.g., K0 value) indicating a slot offset. The slot offset may be for a starting slot on which a corresponding PDSCH may be sent (e.g., transmitted), from/after a first slot on which DCI scheduling the multiple PDSCHs of a serving cell may be sent (e.g., transmitted). Each entry of the list may comprise, for each PDSCH of the multiple PDSCHs, a starting symbol and a length indication. Each starting symbol and length indication may indicate a starting symbol(S) of a slot of a corresponding PDSCH and a length (L) of a number/quantity of symbols of the PDSCH in the slot. The wireless device may determine whether the PDSCH is configured with normal CP or extended CP, and/or indicated S and L, a combination of S and L as valid PDSCH allocation, for example, based on a PDSCH mapping type. The wireless device may determine whether the PDSCH is configured with normal CP or extended CP, and/or indicated S and L, a combination of S and L as valid PDSCH allocation, for example, based on some predefined criteria (e.g., based on Table 5.1.2.1-1 of TS 38.214).

The second number/quantity may indicate how many PDSCHs DCI may schedule on the serving cell. The second number/quantity may be configured in the RRC messages (or predefined as a fixed value) for PDSCH configuration. The second number/quantity may be determined, for example, based on the maximum number/quantity of schedulable (or valid) PDSCHs among all entries of the list.

Each entry of the list may comprise, for each PDSCH, a value (e.g., K0 value) indicating a slot offset, a starting symbol (e.g., S) of a slot of the corresponding PDSCH, and a length (e.g., L) of a number/quantity of symbols of the PDSCH in the slot. For example, as shown in FIG. 29, the first set {K0, S, L} of entry 1, may indicate, K0=1, S=1, and L=9 for PDSCH 1. The second set {K0, S, L} of entry 1, may indicate, K0=2, S=1, and L=10 for PDSCH 2. The third set {K0, S, L} of entry 1, may indicate, K0=3, S=1, and L=9 for PDSCH 3 . . . , etc. The first set {K0, S, L} of entry 2, may indicate, K0=1, S=2, and L=9 for PDSCH 1. The second set {K0, S, L} of entry 2, may indicate, K0=2, S=2, and L=10 for PDSCH 2. The third set {K0, S, L} of entry 2, may indicate, K0-3, S=2, and L=9 for PDSCH 3 . . . , etc.

A base station may send (e.g., transmit), to a wireless device, DCI (e.g., DCI1 in FIG. 29) scheduling multiple PDSCHs on a serving cell. The DCI may comprise a TDRA field indicating an entry of a list for PDSCH time domain resource indication. The TDRA field may have a number/quantity of bits corresponding to a total number/quantity of the entries. For example, the TDRA field may have 2 bits if the total number/quantity of the entries is 4, 3 bits if the total number is 8, 4 bits if the total number is 16, etc. The DCI may be with a DCI format 1_1 for multiple PDSCH scheduling on a serving cell. The DCI may be with a DCI format 0_1 for multiple PUSCH scheduling on a serving cell. Different DCI formats may be implemented, for example, based on examples of FIG. 23.

The DCI (e.g., DCI1) may comprise the TDRA field indicating an (e.g., the second) entry of the list. For example, as shown in FIG. 29, the second entry of the list may indicate K0=1, S=2 and L=9 for PDSCH 1, K0-2, S=2 and L=10 for PDSCH 2, K0=3, S=2 and L=9 for PDSCH 3, etc. The wireless device may determine slots associated with multiple PDSCHs scheduled by DCI (e.g., DCI1), for example, based on (e.g., after or in response to) receiving the DCI (e.g., DCI1) with the TDRA field (e.g., in slot x). The wireless device may determine that the slots associated with multiple PDSCHs scheduled by DCI may comprise slot x+1, x+2, x+3, etc. (e.g., K0=1 for PDSCH 1, K0=2 for PDSCH 2, and K0=3 for PDSCH 3).

In the example of FIG. 29, the first PDSCH (or PDSCH 1) of the multiple PDSCHs may be in slot x+1. A starting symbol of the first PDSCH may be the 2nd symbol (e.g., S=2) of slot x+1. A total number/quantity of symbols of the first PDSCH may be 9 (e.g., L=9). The second PDSCH (or PDSCH 2) of the multiple PDSCHs may be in slot x+2, with the 2nd symbol (e.g., S=2) of slot x+2 as the starting symbol of the second PDSCH and a total number/quantity of symbols of the second PDSCH as 10 (e.g., L=10). The third PDSCH (or PDSCH 3) of the multiple PDSCHs may be in slot x+3, with the 2nd symbol (e.g., S=2) of slot x+3 as the starting symbol of the third PDSCH and a total number/quantity of symbols of the third PDSCH as 9 (e.g., L=9).

The wireless device may receive a plurality of TBs via the determined multiple PDSCHs of the serving cell. Each TB may be received in a corresponding PDSCH of the multiple PDSCHs.

A TB (e.g., each TB) may be associated with a respective HARQ process number. The HARQ process number may be indicated by the DCI. The HARQ process number may be applied to (e.g., used for) the first PDSCH (or PDSCH 1). PDSCH 2 may be associated with the HARQ process number+1 (plus one). PDSCH 3 may be associated with the HARQ process number+2 (plus two), etc.

The wireless device may receive TBs in corresponding PDSCHs in corresponding slots. For example, the wireless device may receive a first TB in PDSCH 1 in slot x+1, a second TB in PDSCH 2 in slot x+2, a third TB in PDSCH 3 in slot x+3, etc.

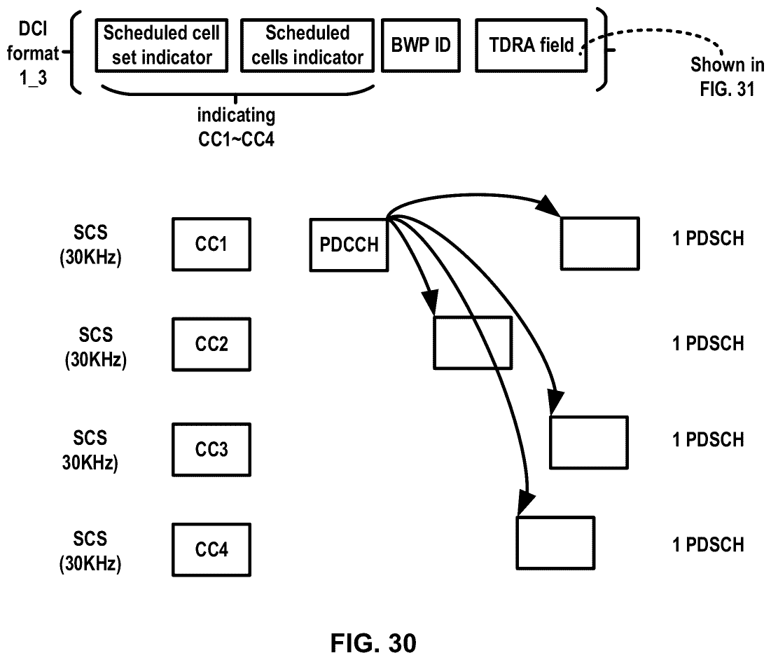

FIG. 30 shows an example of multiple PDSCH scheduling on multiple cells with one PDSCH per cell. Supporting multiple PDSCH scheduling on multiple cells with one PDSCH per cell may be similar to supporting for multiple PUSCH scheduling on multiple cells with one PUSCH per cell. A base station may configure PDCCH/PDSCH parameters on a serving/scheduling cell and/or one or more co-scheduled cells, for example, to support multiple PDSCH scheduling on multiple cells with one PDSCH per cell. A base station may configure PDCCH/PDSCH parameters on a serving/scheduling cell and/or one or more co-scheduled cells, for example, based on examples of FIG. 24, FIG. 25, FIG. 26 and/or FIG. 27. For example, the serving/scheduling cell may be configured with information element MC-DCI-SetOfCells-r18 (e.g., based on examples of FIG. 24). A BWP of the serving/scheduling cell may be associated with a search space (e.g., configured with dci-FormatsMC-r18 based on examples of FIG. 26). PDSCH configuration of one or more BWPs of each co-scheduled cell may be associated with information element PDSCH-ConfigDCI-1-3-r18 (e.g., based on examples of FIG. 27).

A base station may send (e.g., transmit), to a wireless device, DCI with DCI format 1_3 scheduling multiple PDSCHs on multiple cells with one PDSCH per cell, for example, as shown in FIG. 30. The DCI format 1_3 may comprise a plurality of DCI fields. The plurality of DCI fields may comprise a scheduled cell set indicator, a scheduled cells indicator, a BWP ID, and/or a time domain resource allocation/assignment (TDRA) field. The plurality of DCI fields may comprise a NDI field, a RV field, and/or a HARQ process number field, etc.

The scheduled cell set indicator, of the DCI format, may comprise a number/quantity of bits that may be determined, for example, based on the number/quantity of cell sets configured to be scheduled (e.g., by DCI format 0_3/1_3). The scheduled cell set indicator may comprise, for example, [log₂ Nₛₑₜ] bits, where Nₛₑₜ is the number/quantity of cell sets which may be configured by an information element (e.g., MC-DCI-SetofCellsToAddModList as shown in FIG. 24) to be respectively scheduled by a DCI format (e.g., DCI format 0_3/1_3) from the cell on which this format is carried by PDCCH. The scheduled cell set indicator field may be used to indicate the scheduled cell set (e.g., according to Table 7.3.1.1.4-1 of TS 38.212), for example, if this field is present. The scheduled cell set may be the cell set configured to be scheduled by DCI format 0_3/1_3 from the cell by the information element (e.g., MC-DCI-SetofCellsToAddModList), for example, if the scheduled cell set indicator field is not present. The scheduled cell set indicator mapped to 0 (zero, or any other number) may indicate that the cells configured by the 1^{st} entry in an information element (e.g., scheduledCellComboListDCI-1-3, e.g., configured on the serving/scheduling cell as shown in FIG. 24) are indicated. The scheduled cell set indicator mapped to 1 (one, or any other number) may indicate that the cells configured by the 2nd entry in the information element (e.g., scheduledCellComboListDCI-1-3) are indicated, and so on.

The scheduled cells indicator, of the DCI format, may comprise a number/quantity of bits that may be determined, for example, based on the number/quantity of entries in a list of multi-cell scheduling via a DCI format (e.g., based on information element scheduledCellComboListDCI-1-3 as shown in FIG. 24). The scheduled cells indicator may indicate the scheduled cells in the scheduled cell set indicated by the scheduled cell set indicator. The scheduled cells indicator, of the DCI format, may comprise, for example, [log₂ I_{DL}] bits indicating the scheduled cells in the scheduled cell set indicated by the scheduled cell set indicator, where I_{DL} is the number/quantity of entries in the list of multi-cell scheduling via a DCI format (e.g., based on information element scheduledCellComboListDCI-1-3 as shown in FIG. 24). The scheduled cells may be the cells configured by the information element scheduledCellComboListDCI-1-3, for example, if only one entry is configured in the information element scheduledCellComboListDCI-1-3. The scheduled cells indicator may be zero bit (or be absent in DCI format 1_3), for example, if the information element scheduledCellComboListDCI-1-3 for the scheduled cell set is not configured.

The BWP ID, of the DCI format, may comprise a number/quantity of bits that may be determined, for example, based on maximum number/quantity of DL BWPs. For example, the number/quantity of bits may be determined as [log₂ n_{BWP,max}], where

$${n}_{B W P , ma x} = {n}_{BWP , RRC}^{ma x} + 1$$

if

$${n}_{B W P , R R C}^{ma x} \leq 3 ,$$

$${n}_{BWP , RRC}^{ma x}$$

is the maximum number/quantity of DL BWPs configured by higher layers, excluding the initial DL bandwidth part, across all the cells configured by higher layer parameter (e.g., scheduledCellListDCI-1-3) in the scheduled cell set. The bandwidth part indicator may be equivalent to an ascending order of the higher layer parameter BWP-Id. Otherwise (if

$${n}_{BWP , RRC}^{m ax} > 3 ) ,$$

$${n}_{B W P , ma x} = {n}_{BWP , RRC}^{ma x} ,$$

in which case the bandwidth part indicator is defined in Table 7.3.1.1.2-1 of TS 38.212. The BWP ID field may be (e.g., only) applied to (e.g., used for) a scheduled cell with the number/quantity of configured DL BWPs larger than 1 (one), including the initial DL bandwidth part. The BWP ID field may be applied to (e.g., used for) applicable scheduled cells in the scheduled cell set (e.g., independently). The wireless device may ignore the BWP ID field, for example, if the wireless device does not support active BWP change via DCI. The wireless device may ignore the BWP ID field for the scheduled cell, and/or may operate on the active BWP of the scheduled cell, for example, if this field may indicate a code point that does not correspond to a configured BWP of a scheduled cell.

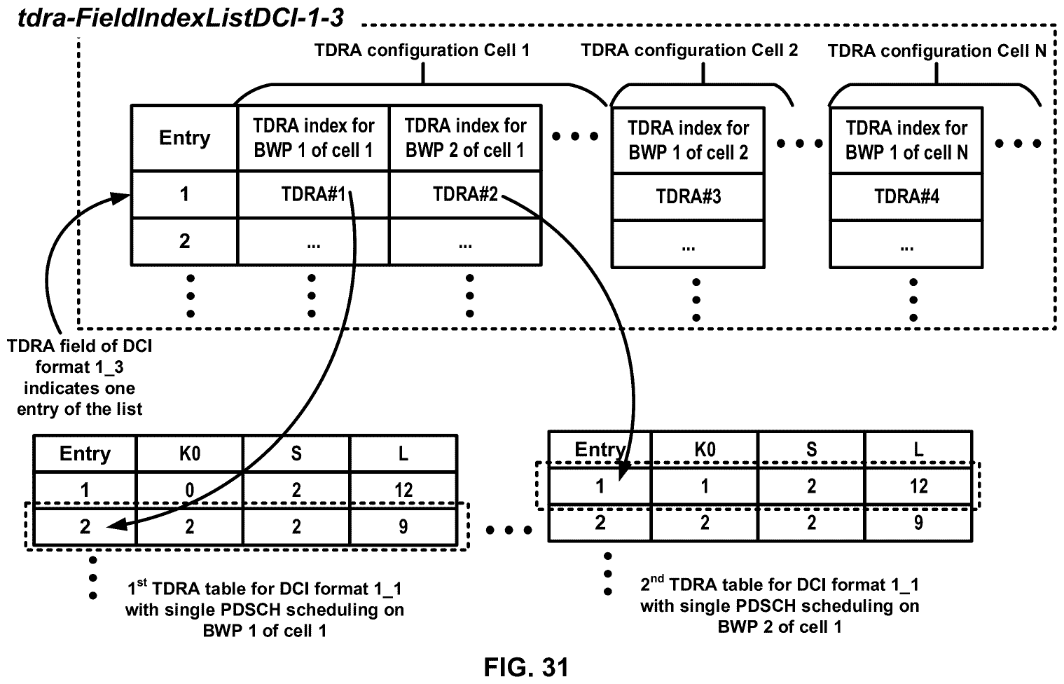

The TDRA field, of the DCI format, may comprise a number/quantity of bits that may be determined, for example, based on the number/quantity of entries in TDRA field index list (e.g., tdra-FieldIndexListDCI-1-3 as shown in FIG. 24). The TDRA field may comprise [log₂ (I_{TDRA})] bits, where I_{TDRA} may be the number/quantity of entries in the TDRA field index list (e.g., tdra-FieldIndexListDCI-1-3 as shown in FIG. 24). The TDRA field may be used to indicate an entry in the TDRA field index list (e.g., tdra-FieldIndexListDCI-1-3 according to Table 7.3.1.2.4-2 of TS 38.212). Each entry in the TDRA field index list (e.g., tdra-FieldIndexListDCI-1-3) may contain the TDRA index for each BWP of each cell in the scheduled cell set. The TDRA indexes for all the cells may be placed according to an ascending order of a serving cell index. The TDRA indexes for all the BWPs of a cell may be placed according to an ascending order of the higher layer parameter BWP-Id. PDSCH TDRA table determination based on the TDRA field for DCI format 1_3 will be shown and/or described with respect to FIG. 31.

A wireless device may receive multiple PDSCHs on co-scheduled cells (e.g., as shown in FIG. 30), for example, if/when the wireless device receives the DCI format 1_3. A (e.g., each) co-scheduled cell may be scheduled with at most one PDSCH. The PDSCH for a (e.g., each) co-scheduled cell may be determined, for example, based on the TDRA field of DCI format 1_3 as shown FIG. 31.

FIG. 31 shows an example of TDRA determination for multiple PDSCH scheduling on multiple cells with one PDSCH per cell., The information element MC-DCI-SetOfCells-r18 of a serving/scheduling cell may be configured with a TDRA field index list (e.g., tdra-FieldIndexListDCI-1-3-r18 IE as shown in FIG. 24), for example, in the example of FIG. 31, and based on examples of FIG. 24.

An entry (e.g., each entry) in the TDRA field index list (e.g., tdra-FieldIndexListDCI-1-3) may comprise the TDRA index for a (e.g., each) BWP of a (e.g., each) cell in the scheduled cell set, for example, as shown in FIG. 31. The TDRA indexes for all the cells may be placed, for example, according to an ascending order of a serving cell index. The TDRA indexes for all the BWPs of a cell may be placed, for example, according to an ascending order of the higher layer parameter BWP ID (e.g., BWP-Id). In the example FIG. 31, the first TDRA index (TDRA #1), located on the leftmost of each entry, may be used for TDRA index indication for BWP 1 of cell 1. The second TDRA index (TDRA #2), located on the second leftmost of each entry, may be used for TDRA index indication for BWP 2 of cell 1, etc.

A wireless device may determine an entry (e.g., K0, S and L) for PDSCH reception on an active BWP of a (e.g., each) co-scheduled cell (e.g., as shown in FIG. 31), for example, if/when the wireless device receives the DCI format 1_3 (e.g., as shown in FIG. 30). For example, the wireless device may use the TDRA table configured for DCI format 1_1 (e.g., scheduling a single PDSCH on a cell) for an active BWP of a cell. The wireless device may use the TDRA table configured for DCI format 1_1 (e.g., scheduling a single PDSCH on cell 1) on BWP 1 of cell 1, for example, if/when the TDRA field may indicate entry 1 of the TDRA field index list (e.g., tdra-FieldIndexListDCI-1-3), and if the active BWP of cell 1 is BWP 1. The BWP ID of DCI format 1_3 may indicate that the active BWP of cell 1 is BWP 1. The TDRA table may be the 1^{st} TDRA table as shown in FIG. 31. The TDRA table may be a PDSCH time domain allocation list (e.g., pdsch-TimeDomainAllocationList based on examples of FIG. 27). The wireless device may determine an entry (e.g., K0, S and L), for example, based on a TDRA index indicated for the active BWP of a cell. For example, the wireless device may determine an entry (e.g., K0, S and L), for example, based on a first TDRA index (e.g., TDRA #1) indicated for BWP1 of Cell 1 in entry 1 of the TDRA field index list (e.g., tdra-FieldIndexListDCI-1-3). The wireless device may determine that K0=2, S=2 and L=9 for PDSCH reception on BWP 1 of cell 1, for example, if/when TDRA #1 indicates the 2nd entry. The wireless device may use the TDRA table configured for DCI format 1_1 (e.g., scheduling a single PDSCH on cell 1) on BWP 2 of cell 1, for example, if the active BWP of cell 1 is BWP 2 (e.g., as indicated by the BWP ID of DCI format 1_3). The TDRA table may be the 2nd TDRA table as shown in FIG. 31. The TDRA table may be a PDSCH time domain allocation list (e.g., pdsch-TimeDomainAllocationList based on examples of FIG. 27). The wireless device may determine an entry (e.g., K0, S and L), for example, based on a second TDRA index (e.g., TDRA #2) indicated for BWP2 of Cell 1 in entry 1 of the TDRA field index list (e.g., tdra-FieldIndexListDCI-1-3). The wireless device may determine that K0=1, S=2 and L=12 for PDSCH reception on BWP 2 of cell 1, for example, if/when TDRA #2 indicates the 1^{st} entry. The wireless device may determine an entry (e.g., K0, S and L) for a PDSCH reception and/or an active BWP on/of a (e.g., each) co-scheduled cell, for example, based on the examples described herein.

In at least some wireless communications, a base station may configure, for a wireless device, multiple PDSCH TDRA tables/lists indicating time-domain configurations for timing of DL assignment to DL data (e.g., pdsch-TimeDomainAllocationList, pdsch-Time DomainAllocationListDCI-1-2-r16, pdsch-Time DomainAllocationList-r16, pdsch-TimeDomainAllocationListForMultiPDSCH-r17, etc., as shown in FIG. 27) for different DCI formats scheduling PDSCH(s) on a BWP of a serving cell. The field pdsch-TimeDomainAllocationList (with or without suffix) may apply to (e.g., be used for) DCI format 1_0, DCI format 1_1 and/or DCI format 1_3. The field pdsch-TimeDomainAllocationList (with or without suffix) may apply to (e.g., be used for) DCI format 1_2, for example, if the field pdsch-TimeDomainAllocationListDCI-1-2 is not configured. The field pdsch-TimeDomainAllocationList (with or without suffix) may apply to (e.g., be used for) DCI format 1_2, for example, if the field pdsch-TimeDomainAllocationListDCI-1-2 is configured. The field pdsch-TimeDomainAllocationListForMultiPDSCH may apply to (e.g., be used for) DCI format 1_1. The network may not configure the PDSCH time domain allocation list from Release 16 (e.g., pdsch-TimeDomainAllocationList-r16) simultaneously with the PDSCH time domain allocation list that is independent of release version (e.g., pdsch-Time DomainAllocationList (without suffix)) in the same PDSCH configuration (e.g., PDSCH-Config).

Type 1 multi-cell scheduling as described herein may comprise scheduling, by single DCI with a DCI format (e.g., received via a serving/scheduling cell), multiple PDSCHs/PUSCHs on multiple cells with one PDSCH/PUSCH per cell. The multiple cells may have the same subcarrier spacing (SCS) and/or may be the same carrier type (e.g., licensed/unlicensed, FR1/FR2/FR2-2)). The DCI format may comprise DCI format 1_3 for PDSCH scheduling and/or DCI format 0_3 for PUSCH scheduling, for example, as described in 3GPP Release 18 specification.

At least some use cases (e.g., important use cases) may be excluded from 3GPP Release 18 (or other 3GPP Releases), for example, due to limited time unit for 3GPP Release 18 multi-carrier scheduling. Examples of these use cases may include different SCSs among co-scheduled cells, different carrier types among co-scheduled cells, etc. These use cases such as co-scheduled carriers with different SCSs may have high commercial needs for operators. An example may be 3.5 GHz TDD+Sub-3 GHz FDD, FR1+FR2, etc.

Type 1 multi-cell scheduling may use DCI formats including DCI format 0_3 and DCI format 1_3 (e.g., as introduced in 3GPP Release 18 or other 3GPP Releases). DCI format 0_3 or 1_3 may schedule up to 4 cells with limitation of a single PUSCH or PDSCH per scheduled cell. For FR2 with high SCS, multi-PDSCH/PUSCH scheduling may be introduced (e.g., in 3GPP Release 17). For example, up to 8 PUSCHs or PDSCHs on a single serving cell may be scheduled by a single DCI format 0_1 or 1_1. Power consumption of a wireless device may be saved. PDCCH overhead may be reduced.

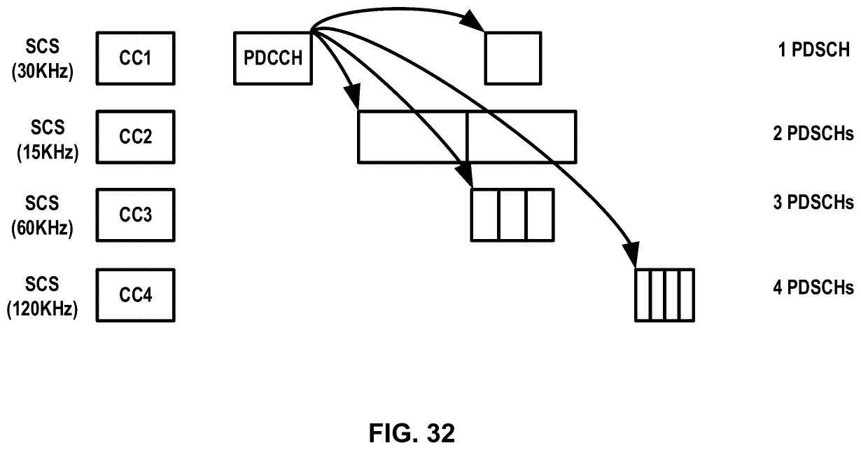

Multiple-cell multi-PDSCH/PUSCH scheduling may be supported without (or by removing) the limitations of at least some wireless communications (e.g., 3GPP Release 18 multi-cell scheduling), for example, in 3GPP Release 19 or other 3GPP Releases. Example of 3GPP Release 19 multi-cell multi-PDSCH/PUSCH scheduling may be shown and/or described with respect to FIG. 32.

FIG. 32 shows an example of multi-cell multi-PDSCH/PUSCH scheduling. More specifically, FIG. 32 shows an example of multi-cell multi-PDSCH/PUSCH scheduling with different SCSs. A serving/scheduling cell may be configured with a SCS different from that of one or more co-scheduled cells, for example, component carrier (CC)1 with 30 KHz SCS, CC2 with 15 KHz SCS, CC3 with 60 KHz SCS, and CC4 with 120 KHz SCS. CC1 may co-schedule CC2, CC3 and CC4, together with CC1 or not together with CC1. CC1 may be configured in the same frequency range (FR) or different FR(s) as that of CC2, CC3 and/or CC4. In the example of FIG. 32, CC1 may be co-scheduled with a single PDSCH, CC2 with two PDSCHs, CC3 with three PDSCHs, and/or CC4 with four PDSCHs. Different co-scheduled cells may be co-scheduled with different number/quantity of PDSCHs. Example of FIG. 32 may (e.g., further) reduce power consumption of a wireless device for PDCCH monitoring/processing, for example, if/when multiple carriers/cells may be configured with different FRs/SCSs. Power consumption of a wireless device may be reduced, for example, compared with 3GPP Release 18 (or other 3GPP Releases) multi-cell multi-PDSCH/PUSCH scheduling with limitations (e.g., one PDSCH/PUSCH per cell, same carrier type, same SCS among co-scheduled cells).

Multi-cell scheduling may be combined with multi-PDSCH/PUSCH scheduling (e.g., in 3GPP Release 19), for example, as disclosed by some 3GPP paper. Multi-cell scheduling may be combined with multi-PDSCH/PUSCH scheduling (e.g., in 3GPP Release 19), for example, to (e.g., fully) exploit the gain of power saving and PDCCH overhead reduction so that one DCI format 0_3 or 1_3 may schedule multiple cells with one or multiple PUSCHs/PDSCHs per scheduled cell. Using the scheduling cell in FR1 with a lower SCS to schedule multiple cells in FR2 with higher SCS may benefit from what is described herein, as disclosed by some 3GPP paper.

Type 2 multi-cell scheduling as described herein may comprise scheduling, by single DCI with a DCI format (e.g., received via a serving/scheduling cell), multiple PDSCHs/PUSCHs on multiple cells with at least one cell being scheduled with at least two PDSCHs/PUSCHs. The multiple cells may have the same and/or different SCS(s). The multiple cells may be the same and/or different carrier type(s) (e.g., licensed/unlicensed, FR1/FR2/FR2-2)).

In at least some wireless communications, a wireless device may not expect to be configured with higher layer parameter (e.g., ScheduledCell-ListDCI-1-3 as shown in FIG. 24) for multiple-cell scheduling with one PDSCH per cell on any serving cell within a PUCCH group, for example, if the wireless device may be configured with pdsch-TimeDomainAllocationListForMultiPDSCH in which one or more rows may contain multiple SLIVs (Start and Length Indicator Values) for PDSCH on a DL BWP of a serving cell within the PUCCH group. The wireless device may not support a combination (e.g., simultaneous configurations) of single-cell multi-PDSCH/PUSCH scheduling and multiple-cell multiple-PDSCH/PUSCH scheduling for the same cell. Directly combining multi-cell scheduling (e.g., 3GPP Release 18 multi-cell scheduling) and multi-PDSCH/PUSCH scheduling (e.g., 3GPP Release 17 multi-PDSCH/PUSCH scheduling) for Type 2 multi-cell scheduling (e.g., 3GPP Release 19 Type 2 multi-cell scheduling) may cause misalignment between the base station and the wireless device, for example, regarding a size of one or more DCI size of the DCI format 0_3/1_3, and/or TDRA indication of the DCI format 0_3/1_3.

A wireless device may or may not support Type 1 multi-cell scheduling. A wireless device may or may not support Type 2 multi-cell scheduling. A base station may or may not perform Type 1 multi-cell scheduling. A base station may or may not perform Type 2 multi-cell scheduling.

PDSCH scheduling will be used herein as an example to describe one or more problems/issues with at least some wireless communications. PUSCH scheduling may have similar problems/issues for at least some wireless communications. A TDRA table (e.g., pdsch-TimeDomainAllocationListForMultiPDSCH) configured for single-cell multi-PDSCH scheduling (e.g., single-cell multi-PDSCH scheduling corresponding to 3GPP Release 17) may be not applicable for DCI format 1_3 which schedules multi-cell multi-PDSCH with one PDSCH per cell. The TDRA table (e.g., pdsch-TimeDomainAllocationList) configured for at least some wireless communications (e.g., corresponding to 3GPP Release 15 and/or Release 16) single-cell single-PDSCH scheduling may be applicable for DCI format 1_3 for additional wireless communications, such as 3GPP Release 18 multi-cell scheduling or multi-cell scheduling in other 3GPP Releases. Multiple TDRA tables, such as both of a TDRA table (e.g., pdsch-TimeDomainAllocationListForMultiPDSCH) configured for multi-PDSCH scheduling for a first DCI format (e.g., for DCI format 1_1) and a TDRA table (e.g., pdsch-TimeDomainAllocationList) configured for multi-cell PDSCH scheduling of a second DCI format (e.g., for DCI format 1_3), may be configured, for example, by directly combining different wireless communication technologies, such as 3GPP Release 18 multi-cell scheduling and 3GPP Release 17 multi-PDSCH/PUSCH scheduling. A wireless device may not know which one of the multiple TDRA tables (e.g., two TDRA tables) may be used for multi-cell scheduling, for example, if the wireless device and the base station are not aligned on the type (e.g., Type 1 or Type 2) of the multi-cell scheduling. at least some wireless devices may support a combination of single-cell multi-PDSCH scheduling and multi-cell multi-PDSCH scheduling. At least some other wireless devices may not support such a combination. At least some wireless communications may have incorrect/failed PDSCH reception at the wireless device and/or incorrect/failed PUSCH reception at the base station. As described herein, improvements are provided by aligning a type of multi-cell scheduling between the base station and the wireless device.

Misalignment/unalignment of the type of multi-cell scheduling between a wireless device and a base station may cause one or more problems/issues, such as misalignment of size(s) of one or more DCI fields of the DCI format 1_3/0_3, for example, if reusing the DCI format 1_3/0_3 for other multi-cell scheduling, such as 3GPP Release 19 multi-cell scheduling. The one or more DCI fields may comprise a new data indicator (NDI) field, a redundancy version (RV) field, a HARQ process number field, and/or one or more other fields.

In at least some wireless communications, a wireless device may determine whether a PDSCH and/or PUSCH scheduled by DCI may be a new transmission or a retransmission, for example, based on a value of an NDI field. The wireless device may consider/determine a TB to be a new transmission, for example, based on (e.g., after or in response to) the value of the NDI field being changed (e.g., toggled, flipped) relative to (or compared with) a previous value of the NDI field of previous DCI. The wireless device may perform an initial transmission of the TB (e.g., for PUSCH) and/or may receive/decode an initial transmission of the TB (e.g., for PDSCH). The wireless device may consider/determine the TB to be a re-transmission, for example, based on (e.g., after or in response to) the value of the NDI field not being changed (e.g., toggled, flipped) relative to (or compared with) a previous value of the NDI field of previous DCI. The wireless device may perform a retransmission of the previous TB (e.g., for PUSCH) and/or may combine a TB with a stored previous TB for decoding (e.g., for PDSCH).

In at least some wireless communications, a wireless device may determine an RV value of a PDSCH/PUSCH scheduled by DCI, for example, based on a value of the RV field. A bit (e.g., one bit) of the RV field may indicate a RV of TB which may be used by the base station and/or the wireless device for decoding, combination, and/or retransmission, for example, if/when at most two RV values may be configured for a PDSCH/PUSCH.

In at least some wireless communications, the wireless device may use a HARQ process number field to determine a HARQ process number of a HARQ process for a PDSCH/PUSCH scheduled by the DCI. Different PDSCH/PUSCHs may be associated with different HARQ process numbers. Different PDSCH/PUSCHs may be associated with the same HARQ process number. The wireless device and/or the base station may use the HARQ process number to determine whether DCI schedules an initial transmission, or a retransmission of a TB associated with the HARQ process number.

An NDI field will be used herein as an example to describe to describe one or more problems/issues with at least some wireless communications. An RV field may have similar problems/issues for at least some wireless communications. An NDI field of DCI format 0_1/1_1 may comprise a plurality of bits, each bit corresponding to a respective PDSCH/PUSCH on the serving cell, for example, in 3GPP Release 17 single-cell multi-PDSCH/PUSCH scheduling. An NDI field of DCI format 0_3/1_3 may comprise a plurality of blocks, each block (1 bit) corresponding to a PDSCH/PUSCH on a respective cell of the multiple cells, for example, in 3GPP Release 18 multi-cell multi-PDSCH/PUSCH scheduling with one PDSCH/PUSCH per cell. The wireless device may not know how many bits of an NDI field of the DCI format 0_3/1_3 may be used for multi-cell scheduling such as 3GPP Release 19 multi-cell scheduling, for example, by directly combining multi-cell scheduling (e.g., 3GPP Release 18 multi-cell scheduling) and multi-PDSCH/PUSCH scheduling (e.g., 3GPP Release 17 multi-PDSCH/PUSCH scheduling). At least some wireless communications may have incorrect PDSCH reception on the wireless device side and/or incorrect PUSCH reception on the base station side. As described herein, improvements are provided by aligning a type of multi-cell scheduling between the base station and the wireless device.

A PDSCH HARQ process number field will be used herein as an example to describe one or more problems/issues with at least some wireless communications. A PUSCH HARQ process number field may have similar problems/issues for at least some wireless communications. A HARQ field of DCI format 1_1 may comprise 5 bits (e.g., if harq-ProcessNumberSizeDCI-1-1 is configured, otherwise 4 bits) indicating a HARQ process number for the first/starting PDSCH of multiple PDSCHs scheduling on a serving cell, for example, in 3GPP Release 17 single-cell multi-PDSCH scheduling. A HARQ process number field of DCI format 1_3 may comprise a plurality of blocks, each block indicating a HARQ process number for a PDSCH on a respective cell of the multiple cells, for example, in 3GPP Release 18 multi-cell multi-PDSCH scheduling with one PDSCH per cell. Each block may comprise a number/quantity of bits (e.g., 0, 1, 2, 3, 4 or 5 bits) determined by an RRC parameter (e.g., harq-ProcessNumberSizeDCI-1-3) configured for the cell corresponding to the block. The wireless device may not know how many bits of a HARQ process number field of the DCI format 1_3 may be used for a 3GPP Release multi-cell scheduling (e.g., 3GPP Release 19 multi-cell scheduling), for example, by directly combining multi-cell scheduling (e.g., 3GPP Release 18 multi-cell scheduling) and multi-PDSCH scheduling (e.g., 3GPP Release 17 multi-PDSCH scheduling). At least some wireless communications may have incorrect PDSCH reception at the wireless device and/or incorrect PUSCH reception at the base station. As described herein, improvements are provided by aligning a type of multi-cell scheduling between the base station and the wireless device.

Examples described herein may be used to solve the problems/issues. One or more examples may comprise configuring/sending (e.g., transmitting), by a base station to a wireless device, and/or receiving by the wireless device from the base station, one or more RRC messages. The one or more RRC messages may comprise one or more parameters (e.g., in serving cell configuration of a serving/scheduling cell) indicating whether a DCI format, configured on the serving (or scheduling) cell, may be used to indicate/perform Type 1 multi-cell scheduling or Type 2 multi-cell scheduling.

One or more examples may comprise sending (e.g., transmitting), by a wireless device to a base station, one or more RRC messages comprising radio access capability information of the wireless device. The radio access capability information of the wireless device may comprise one or more parameters indicating whether the wireless device may support Type 1 multi-cell scheduling or Type 2 multi-cell scheduling. The one or more parameters may comprise a first parameter indicating whether the wireless device may support Type 1 multi-cell scheduling and/or a second parameter indicating whether the wireless device may support Type 2 multi-cell scheduling. The one or more parameters may be indicated per frequency band, per band combination, per frequency range, and/or per frequency range combination (e.g., FR1+FR1, FR1+FR2, FR2+FR1, FR2+FR2, FR1+FR2-2, FR2+FR2-2, etc.).

FR1 may comprise frequency range between 410 MHz and 7125 MHz. FR2 may comprise frequency range between 24.25 GHz and 52.6 GHz. FR2-2 may comprise frequency range between 52.6 GHz and 71 GHZ.

One or more examples may comprise the base station sending (e.g., transmitting) and/or the wireless device receiving, one or more RRC messages, for example, based on the one or more parameters of the radio access capability information of the wireless device. The one or more RRC messages may comprise one or more parameters (e.g., in serving cell configuration of a serving/scheduling cell) indicating whether a DCI format, configured on the serving (or scheduling) cell, may be used to indicate/perform Type 1 multi-cell scheduling or Type 2 multi-cell scheduling.

The one or more RRC messages may be used for, for example, a PDSCH configuration of each BWP of a first cell. The one or more RRC messages may comprise at least two PDSCH TDRA tables/lists for a first BWP of one or more BWPs of the first cell. The at least two PDSCH TDRA tables may comprise a first PDSCH TDRA table used for single-PDSCH scheduling and/or a second PDSCH TDRA table used for multi-PDSCH scheduling. The first cell may be a scheduled cell of the multiple cells scheduled by a DCI format via the serving/scheduling cell.

One or more examples described herein for PDSCH in this specification may be applicable for PUSCH. Detailed descriptions for examples of PUSCH may be omitted.

One or more examples may comprise determining, by a base station and/or a wireless device, a PDSCH TDRA table, for each co-scheduled cell, from a plurality of PDSCH TDRA tables. The base station and/or the wireless device may determine the PDSCH TDRA table, for example, based on whether DCI indicates Type 1 multi-cell scheduling or Type 2 multi-cell scheduling.

A wireless device may determine a TDRA index that may indicate an entry of a PDSCH TDRA table (e.g., a first PDSCH TDRA table) of a cell (e.g., a first cell, or a first BWP of the first cell) among multiple cells, for example, based on (e.g., in response to) the one or more parameters indicating that the DCI format may be used for Type 1 multi-cell scheduling. The wireless device may determine the TDRA index, for example, if/when receiving DCI with the DCI format on a serving cell. The DCI may indicate multiple PDSCHs scheduling on multiple cells with one PDSCH per cell (e.g., Type 1 multi-cell scheduling). The multiple cells may comprise the first cell and/or the first BWP of the first cell. The DCI may comprise a TDRA field for the multiple cells. The TDRA index may be of multiple TDRA indexes comprised in the TDRA field. The TDRA index may correspond to the first cell and/or the first BWP of the first cell.

The wireless device may determine a TDRA index that may indicate an entry of a PDSCH TDRA table (e.g., a second PDSCH TDRA table) of a cell (e.g., a first cell, or a first BWP of the first cell) among multiple cells, for example, based on (e.g., in response to) the one or more parameters indicating that the DCI format may be used for Type 2 multi-cell scheduling. The wireless device may determine the TDRA index, for example, if/when receiving DCI with the DCI format on the serving cell. The DCI may indicate multiple PDSCHs scheduling on multiple cells comprising the first cell scheduled with at least two PDSCHs (e.g., Type 2 multi-cell scheduling). The TDRA index may correspond to the first cell and/or the first BWP of the first cell.

One or more examples may comprise determining, by a base station and/or a wireless device, a size of a block of new data indicator (NDI) field, for each co-scheduled cell. The base station and/or the wireless device may determine the size of the NDI field, for example, based on whether DCI indicates Type 1 multi-cell scheduling or Type 2 multi-cell scheduling.

The wireless device may determine a first block of the NDI field corresponding to a first cell to be 1 (or any other value) bit, for example, based on (e.g., in response to) the one or more parameters indicating that the DCI format may be used for Type 1 multi-cell scheduling. The wireless device may determine a first block of the NDI field corresponding to a first cell to be 1 (or any other value) bit, for example, if/when receiving DCI (with the DCI format on a serving cell) indicating multiple PDSCHs scheduling on multiple cells (comprising the first cell) with one PDSCH per cell (e.g., Type 1 multi-cell scheduling) and comprising an NDI field for multiple cells.

The wireless device may determine that a first block of the NDI field may comprise a number/quantity of bits determined, for example, based on the maximum number/quantity of schedulable PDSCHs among all entries of a second PDSCH TDRA table of a cell (e.g., a first cell, or a first BWP of the first cell). The wireless device may determine that a first block of the NDI field may comprise the number/quantity of bits, for example, based on (e.g., in response to) the one or more parameters indicating that the DCI format is used for Type 2 multi-cell scheduling. The wireless device may determine that a first block of the NDI field may comprise the number/quantity of bits, for example, if/when receiving DCI (with the DCI format on a serving cell) indicating Type 2 multi-cell scheduling. The first block of the NDI field may correspond to a first cell and/or a first BWP of the first cell. The number/quantity of bits may be no less than two (>=2). Each bit may correspond to one scheduled PDSCH of the first cell.

One or more examples may comprise determining, by a base station and/or a wireless device, a size of a block of a redundancy version (RV) field, for each co-scheduled cell. The base station and/or the wireless device may determine the size of a block of an RV field, for example, based on whether DCI may indicate Type 1 multi-cell scheduling or Type 2 multi-cell scheduling.

The wireless device may determine that a first block of the RV field, corresponding to a first cell, may comprise a number/quantity of (e.g., 0, 1 or 2) bits determined by a higher layer parameter (e.g., numberOfBitsForRV-DCI-1-3) configured for the DCI format indicating Type 1 multi-cell scheduling. The wireless device may determine that the first block of the RV field may comprise the number/quantity of (e.g., 0, 1 or 2) bits, for example, based on (e.g., in response to) the one or more parameters indicating that the DCI format is used for Type 1 multi-cell scheduling. The wireless device may determine that the first block of the RV field may comprise the number/quantity of (e.g., 0, 1 or 2) bits, for example, if/when receiving DCI (with the DCI format on a serving cell) indicating multiple PDSCHs scheduling on multiple cells (comprising the first cell) with one PDSCH per cell (e.g., Type 1 multi-cell scheduling) and comprising a RV field for multiple cells.

The wireless device may determine that a first block of the RV field, corresponding to a first cell, may comprise a number/quantity of bits determined, for example, based on the maximum number/quantity of schedulable PDSCHs among all entries of a second PDSCH TDRA table of a cell (e.g., a first cell, or a first BWP of the first cell). The wireless device may determine that a first block of the RV field may comprise the number/quantity of bits, for example, based on (e.g., in response to) the one or more parameters indicating that the DCI format is used for Type 2 multi-cell scheduling. The wireless device may determine that a first block of the RV field may comprise the number/quantity of bits, for example, if/when receiving DCI (with the DCI format on a serving cell) indicating Type 2 multi-cell scheduling. The number/quantity of bits may be no less than two (>=2). Each bit may correspond to one scheduled PDSCH of the first cell.

One or more examples may comprise determining, by a base station and/or a wireless device, a size of a hybrid automatic repeat request (HARQ) process number field, for each co-scheduled cell. The base station and/or the wireless device may determine the size of a HARQ process number field, for example, based on whether DCI may indicate Type 1 multi-cell scheduling or Type 2 multi-cell scheduling.

The wireless device may determine that a HARQ process number field, corresponding to a first cell, may comprise a first number/quantity of bits. The first number/quantity may be indicated by a first parameter (e.g., harq-ProcessNumberSizeDCI-1-3-r18) of the first cell and configured for the DCI format indicating Type 1 multi-cell scheduling. The wireless device may determine that a HARQ process number field may comprise the first number/quantity of bits, for example, based on (e.g., in response to) the one or more parameters indicating that the DCI format is used for Type 1 multi-cell scheduling. The wireless device may determine that a HARQ process number field may comprise the first number/quantity of bits, for example, if/when receiving DCI (with the DCI format on a serving cell) indicating multiple PDSCHs scheduling on multiple cells (comprising the first cell) with one PDSCH per cell (e.g., Type 1 multi-cell scheduling) and comprising multiple HARQ process number fields for multiple cells.

The wireless device may determine that a HARQ process number field, corresponding to a first cell or a first BWP of the first cell, may comprise a second number/quantity of bits. The second number/quantity may be indicated by a second parameter (e.g., harq-ProcessNumberSizeDCI-1-3-r19) of the first cell or of the first BWP of the first cell and configured for the DCI format indicating Type 2 multi-cell scheduling. The wireless device may determine that a HARQ process number field may comprise the second number/quantity of bits, for example, based on (e.g., in response to) the one or more parameters indicating that the DCI format is used for Type 2 multi-cell scheduling. The wireless device may determine that a HARQ process number field may comprise the second number/quantity of bits, for example, if/when receiving DCI (with the DCI format on a serving cell) indicating Type 2 multi-cell scheduling.

A base station and/or a wireless device may be aligned, for example, by implementing the one or more examples. A base station and/or a wireless device may be aligned, for example, based on one or more parameters of the base station indicating whether a DCI format is used for Type 1 multi-cell scheduling and/or Type 2 multi-cell scheduling. A base station and/or a wireless device may be aligned, for example, with a size of one or more DCI fields (e.g., HARQ process number, NDI, RV) of the DCI format. A base station and/or a wireless device may be aligned, for example, with which PDSCH TDRA table (or PUSCH TDRA table) may be used for PDSCH (or PUSCH) receptions and/or transmissions on multiple cells. Examples described herein may improve detection reliability of the DCI format and/or increase system throughput.

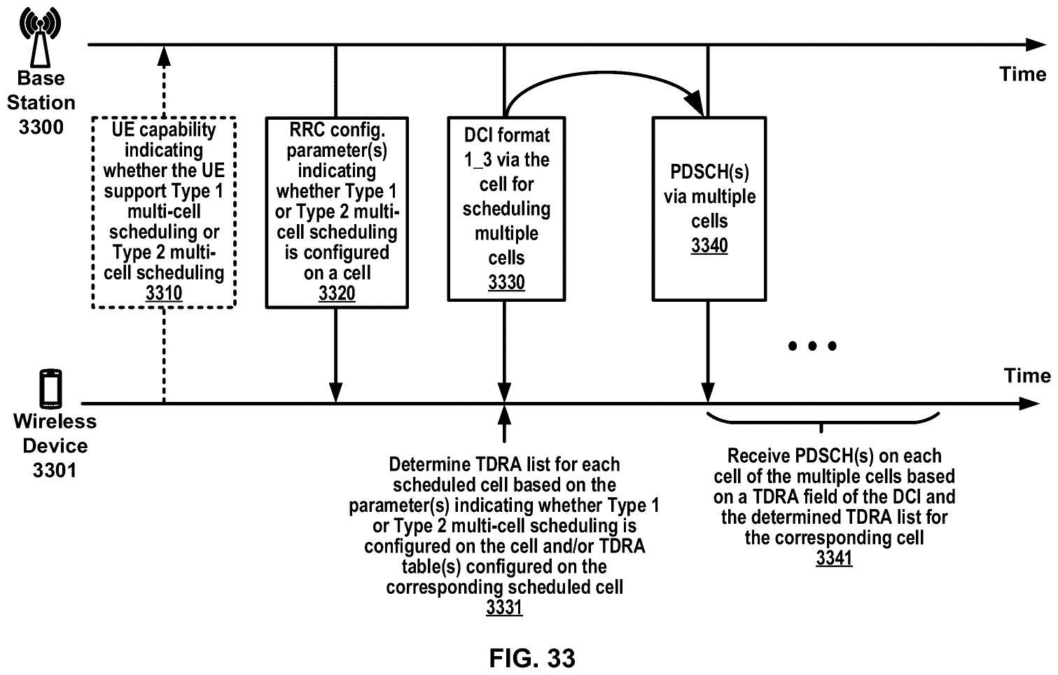

FIG. 33 shows an example of multi-cell scheduling. One or more steps of the example method may be rearranged (e.g., performed in a different order), omitted, and/or otherwise modified, and/or with other steps added.

A wireless device (e.g., UE, 3301) may send (e.g., transmit), to a base station (e.g., gNB, 3300), one or more (e.g., first) RRC messages comprising UE capability information (or UE radio access capability information, radio access capability information of a wireless device), for example, as shown in FIG. 33 (e.g., at step 3310). The UE capability information may comprise one or more parameters indicating whether the wireless device may support a Type 1 multi-cell scheduling or a Type 2 multi-cell scheduling (e.g., for PDSCH only, for PUSCH only, for both PDSCH and PUSCH). The wireless device may send (e.g., transmit) the one or more RRC messages comprising the UE capability information, for example, based on (e.g., after or in response to) receiving, from the base station, one or more RRC messages requesting the UE capability information.

The one or more parameters may be indicated for PDSCH reception and PUSCH transmission jointly. For example, the PDSCH reception and the PUSCH transmission may comprise the same parameters. The one or more parameters may be indicated for PDSCH reception and PUSCH transmission separately. For example, the PDSCH reception and the PUSCH transmission may comprise different parameters.

The one or more parameters may comprise a first parameter indicating whether the wireless device may support a Type 1 multi-cell scheduling. The one or more parameters may comprise a second parameter indicating whether the wireless device may support a Type 2 multi-cell scheduling. The first parameter may be separately indicated from the second parameter.

The wireless device may send (e.g., transmit) the one or more parameters per frequency band (e.g., band 40, band 42, band 57, etc.). Different frequency band may be indicated by different parameters regarding whether the wireless device may support Type 1 and/or Type 2 multi-cell scheduling.

The wireless device may send (e.g., transmit) the one or more parameters per frequency band combination (e.g., band 42+band 57, band 40+band 50, etc.). Different frequency band combination may be indicated by different parameters regarding whether the wireless device may support Type 1 and/or Type 2 multi-cell scheduling (e.g., one or more scheduled cell on a second band different from a scheduling cell on a first band).

The wireless device may send (e.g., transmit) the one or more parameters per frequency range (e.g., FR1, FR2, FR2-2 etc.). Different frequency range may be indicated by different parameters regarding whether the wireless device may support Type 1 and/or Type 2 multi-cell scheduling.

The wireless device may send (e.g., transmit) the one or more parameters per frequency range combination (e.g., FR1+FR1, FR1+FR 2, FR1+FR2-2, FR2+FR2, FR2+FR2-2, and/or FR1+FR2+FR2-2, etc.). Different frequency range combinations may be indicated by different parameters regarding whether the wireless device may support Type 1 and/or Type 2 multi-cell scheduling. For example, the wireless device may receive DCI on a FR1 scheduling cell, and the DCI may indicate Type 2 multi-cell scheduling on one or more co-scheduled FR2 cells, for example, if/when the wireless device indicates supporting of Type 2 multi-cell scheduling for a frequency range combination FR1+FR2. For example, the wireless device may receive DCI on a FR1 scheduling cell, and the DCI may indicate Type 2 multi-cell scheduling on one or more first co-scheduled FR2 cells and one or more second co-scheduled FR2-2 cells, for example, if/when the wireless device indicates supporting of Type 2 multi-cell scheduling for a frequency range combination FR1+FR2+FR2-2.

The one or more parameters may indicate a number/quantity of frequency ranges (or frequency range combinations) configured for multiple cells on which the wireless device may support Type 2 multi-cell scheduling. For example, the one or more parameters may indicate a maximum and/or supported number/quantity of frequency ranges (or frequency range combinations) configured for multiple cells on which the wireless device may support Type 2 multi-cell scheduling.

The wireless device may send (e.g., transmit) the one or more parameters per SCS combination (e.g., 1^{st} SCS+2nd SCS, 1^{st} SCS+2nd SCS+3^{rd} SCS, etc.). Different SCS combinations may be indicated by different parameters regarding whether the wireless device may support Type 1 and/or Type 2 multi-cell scheduling. For example, the wireless device may receive DCI on a 15 KHz-SCS scheduling cell, and the DCI may indicate Type 2 multi-cell scheduling on one or more co-scheduled 60 KHz-SCS cells, for example, if/when the wireless device indicates supporting of Type 2 multi-cell scheduling for a SCS combination 15 KHz SCS+60 KHz. For example, the wireless device may receive DCI on a 15 KHz-SCS scheduling cell, and the DCI may indicate Type 2 multi-cell scheduling on one or more first co-scheduled 60 KHz-SCS cells and one or more second co-scheduled 960 KHz-SCS cells, for example, if/when the wireless device indicates supporting of Type 2 multi-cell scheduling for a SCS combination 15 KHz SCS+60 KHz+960 KHz.

The one or more parameters may indicate a number/quantity of different SCS values (or SCS combinations) configured for multiple cells on which the wireless device may support Type 2 multi-cell scheduling. For example, the one or more parameters may indicate a maximum and/or supported number/quantity of different SCS values (or SCS combinations) configured for multiple cells on which the wireless device may support Type 2 multi-cell scheduling.

The wireless device may send (e.g., transmit) the one or more parameters per carrier type combination (e.g., licensed carrier+licensed carrier, licensed carrier+unlicensed carrier, unlicensed carrier+licensed carrier, etc.). Different carrier type combination may be indicated by different parameters regarding whether the wireless device may support Type 1 and/or Type 2 multi-cell scheduling. For example, the wireless device may receive DCI on a scheduling cell (configured as licensed carrier), and the DCI may indicate Type 2 multi-cell scheduling on one or more co-scheduled cells configured as licensed carriers, for example, if/when the wireless device indicates supporting of Type 2 multi-cell scheduling for a carrier type combination with licensed carrier+licensed carrier. For example, the wireless device may receive DCI on a scheduling cell (configured as licensed carrier), and the DCI may indicate Type 2 multi-cell scheduling on one or more co-scheduled cells configured as unlicensed carriers, for example, if/when the wireless device indicates supporting of Type 2 multi-cell scheduling for a carrier type combination with licensed carrier+unlicensed carrier.

The wireless device and the base station may be aligned regarding the supported Type 1 and/or Type 2 multi-cell scheduling on multiple cells, for example, based on the one or more examples described herein. The Type 1 and/or Type 2 multi-cell scheduling on multiple cells may be configured on same/different frequency bands. The Type 1 and/or Type 2 multi-cell scheduling on multiple cells may be configured on same/different frequency ranges. The Type 1 and/or Type 2 multi-cell scheduling on multiple cells may be configured with same/different SCSs. The Type 1 and/or Type 2 multi-cell scheduling on multiple cells may be configured on same/different carrier types. The base station may configure Type1 and/or Type 2 multi-cell scheduling parameters, for example, based on the one or more examples described herein.

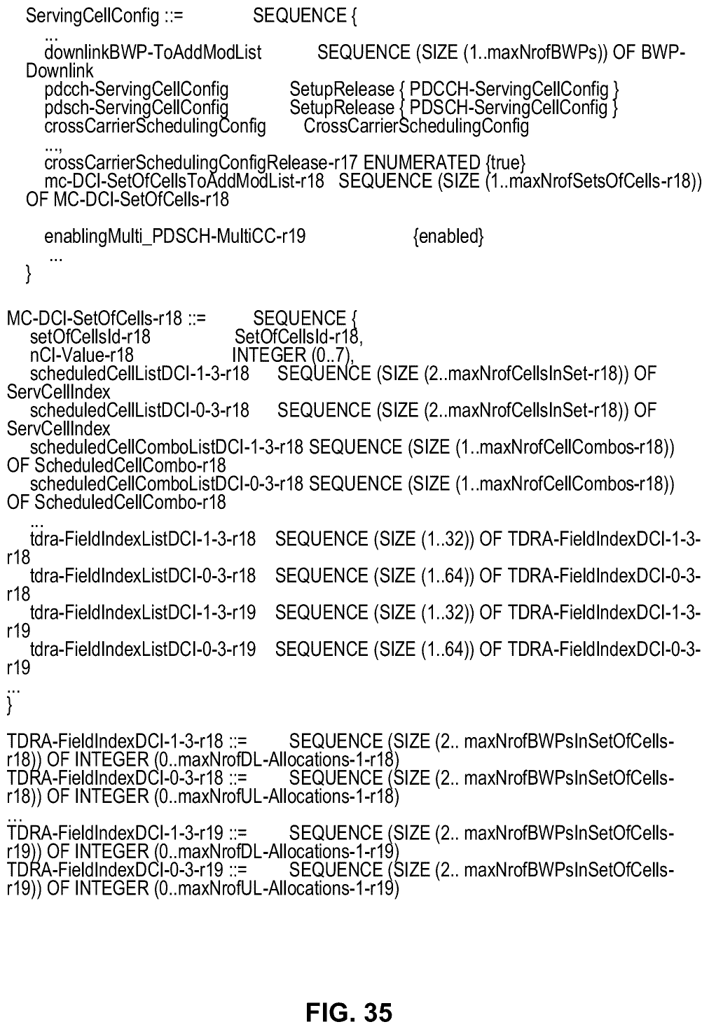

The base station (e.g., 3300) may send (e.g., transmit), to the wireless device (e.g., 3301), one or more (e.g., second) RRC messages comprising one or more parameters, for example, as shown in FIG. 33 (e.g., at step 3320). The one or more parameters may indicate whether Type 1 or Type 2 multi-cell scheduling may be configured on a (e.g., serving/scheduling and/or one or more co-scheduled) cell. For example, the one or more parameters may be comprised in a serving cell configuration of the cell, for example, based on examples of FIG. 24, FIG. 25 and/or FIG. 26. The serving cell configuration may be implemented, for example, based on FIG. 35 (which will be described herein).

The one or more (e.g., second) RRC messages may be configured, for example, based on (or according to) the UE capability information sent (e.g., transmitted) from the wireless device to the base station. The one or more (e.g., second) RRC messages may be configured based on the UE capability information so that the values of PDSCH/PDCCH/PUSCH configuration parameters of the scheduling/scheduled cell may not exceed the corresponding UE capability (e.g., as reported by the wireless device).

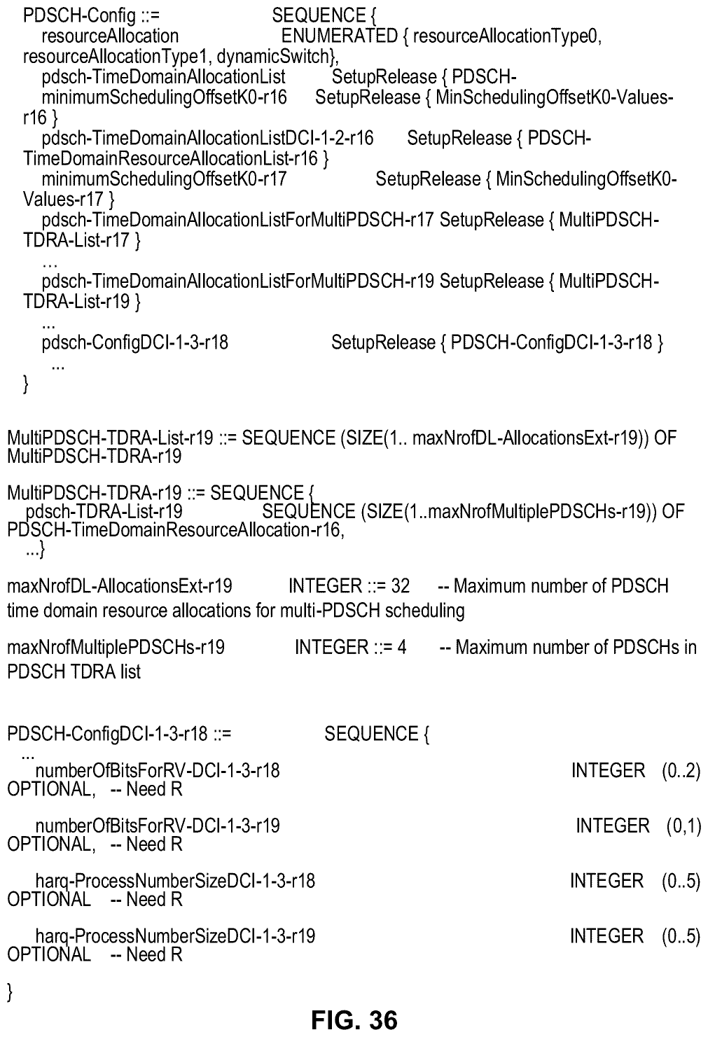

The one or more (e.g., second) RRC messages may comprise PDSCH configuration parameters of (e.g., each of) one or more co-scheduled cells scheduled by the scheduling cell. The PDSCH configuration parameters for a co-scheduled cell may be implemented, for example, based on examples of FIG. 27. The PDSCH configuration parameters for a co-scheduled cell may be implemented, for example, based on examples of FIG. 36 (which will be described herein).

PDSCH configuration parameters (e.g., configured for a first co-scheduled cell, or for each BWP of the first co-scheduled cell) may comprise a plurality of PDSCH TDRA tables. The plurality of PDSCH TDRA tables may comprise a first PDSCH TDRA table/list (e.g., configured by pdsch-TimeDomainAllocationList IE as shown in FIG. 27) for single-PDCH scheduling (e.g., on the first cell or a BWP of the first cell) and/or a second PDSCH TDRA table/list (e.g., configured by pdsch-Time DomainAllocationList ForMultiPDSCH IE as shown in FIG. 27) for multi-PDSCH scheduling (e.g., on the first cell or a BWP of the first cell). Similarly, for each co-scheduled cell, PDSCH configuration parameters may comprise a first PDSCH TDRA table for single-PDCH scheduling on the cell or a BWP of the cell and/or a second PDSCH TDRA table for multi-PDSCH scheduling on the cell or a BWP of the cell.

The wireless device (e.g., 3301) may receive, from the base station (e.g., 3300), DCI with a DCI format via the serving/scheduling cell (e.g., the cell for scheduling multiple cells), for example, as shown in FIG. 33 (e.g., at step 3330). For example, the DCI format may be DCI format 1_3 for multi-cell PDSCH scheduling. The DCI format may comprise a TDRA field indicating an entry of a PDSCH TDRA list (e.g., tdra-FieldIndexListDCI-1-3 as shown in FIG. 24) configured for DCI format 1_3. Each entry of the PDSCH TDRA list may comprise a plurality TDRA indexes for one or more BWPs of multiple cells co-scheduled by the DCI. Each BWP of each scheduled cell may be associated with a respective TDRA index. For example, the DCI format may be based on DCI format 1_3 as shown in FIG. 23 and/or FIG. 30. The DCI format may comprise a BWP ID indicating an active BWP for the PDSCH of each co-scheduled cell. For example, BWP ID may comprise two bits. BWP ID set to 00 may indicate the first BWP (e.g., with lowest BWP index) configured on each co-scheduled cell. BWP ID set to 01 may indicate the second BWP (e.g., with second lowest BWP index) configured on each co-scheduled cell, etc.

The wireless device may determine the multiple cells co-scheduled by the DCI, for example, based on examples of FIG. 30. The wireless device may determine whether the DCI may be used for Type 1 multi-cell scheduling or Type 2 multi-cell scheduling, for example, based on the one or more parameters received in the one or more (e.g., second) RRC messages.

The wireless device may determine a TDRA list for each scheduled cell. The wireless device may determine a TDRA list for each scheduled cell, for example, based on the parameter(s) indicating whether Type 1 or Type 2 multi-cell scheduling is configured on the cell and/or TDRA table(s) configured on the corresponding scheduled cell, for example, as shown in FIG. 33 (e.g., at step 3331).

The wireless device may determine that a TDRA index, corresponding to a BWP of a co-scheduled cell, may indicate an entry of a PDSCH time domain allocation list (e.g., configured for single-PDSCH scheduling) of the co-scheduled cell, for example, if/when one or more parameters indicate that the DCI may be used to indicate/perform Type 1 multi-cell scheduling on the serving cell. For example, the wireless device may determine that a first TDRA index, corresponding to a first BWP of a first co-scheduled cell, may indicate an entry of a first PDSCH time domain allocation list (e.g., configured for single-PDSCH scheduling) of the first co-scheduled cell. Similarly, the wireless device may determine that a second TDRA index, corresponding to a second BWP of a second co-scheduled cell, may indicate an entry of a second PDSCH time domain allocation list (e.g., configured for single-PDSCH scheduling) of the second co-scheduled cell.

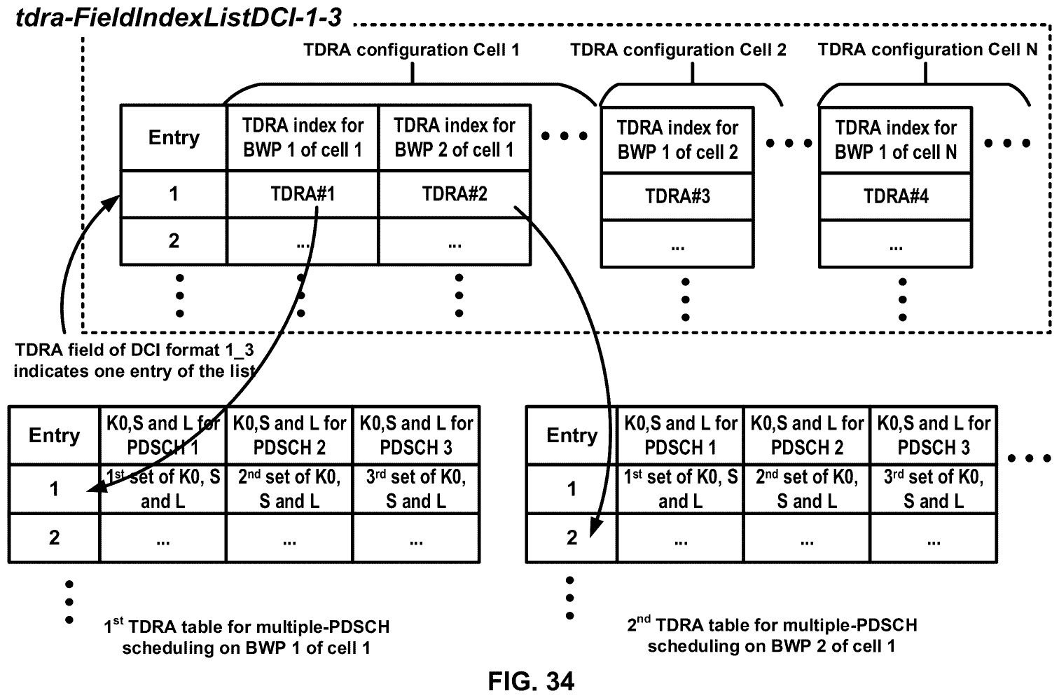

The wireless device may determine that a TDRA index, corresponding to a BWP of a co-scheduled cell, may indicate an entry of a second PDSCH time domain allocation list (e.g., configured for multi-PDSCH scheduling) of the co-scheduled cell, for example, if/when one or more parameters indicate that the DCI of the serving/scheduling cell may be used to indicate/perform Type 2 multi-cell scheduling. For example, the wireless device may determine that a first TDRA index, corresponding to a first BWP of a first co-scheduled cell, may indicate an entry of a second PDSCH time domain allocation list (e.g., configured for multi-PDSCH scheduling) of the first co-scheduled cell. Similarly, the wireless device may determine that a second TDRA index, corresponding to a second BWP of a second co-scheduled cell, may indicate an entry of a second PDSCH time domain allocation list (e.g., configured for multi-PDSCH scheduling) of the second co-scheduled cell. A mapping between a TDRA index to an entry of a PDSCH TDRA list for multi-PDSCH scheduling may be implemented, for example, based on examples of FIG. 34 which will be described herein.

The wireless device may determine that the DCI may be used for Type 1 multi-cell scheduling (e.g., if Type 1 multi-cell scheduling is not released), for example, if/when one or more parameters may be absent in the one or more (e.g., second) RRC message or released by one or more third RRC messages. The one or more parameters may indicate whether the DCI of the serving/scheduling cell may be used to indicate/perform Type 1 multi-cell scheduling or Type 2 multi-cell scheduling. The wireless device may implement at least some wireless communications for PDSCHs scheduling, for example, based on examples of FIG. 30 and/or FIG. 31.

The wireless device may receive one or more PDSCHs via multiple cells, for example, as shown in FIG. 33 (e.g., at step 3334). The wireless device may receive PDSCH(s) on each cell of the multiple cells, for example, based on a TDRA field of the DCI and/or the determined TDRA list for the corresponding cell (e.g., at step 3341). The wireless device may receive one or more PDSCHs via each co-scheduled cell, for example, based on the determined PDSCH time domain allocation list.

The wireless device may receive a single PDSCH via a co-scheduled cell, for example, if/when the DCI may indicate Type 1 multi-cell scheduling. The wireless device may receive a single PDSCH via a co-scheduled cell, for example, based on the determined PDSCH time domain allocation list (e.g., according to the examples of FIG. 28).

The wireless device may receive one or more PDSCHs via a co-scheduled cell, for example, if/when the DCI may indicate Type 2 multi-cell scheduling. The wireless device may receive one or more PDSCHs via a co-scheduled cell, for example, based on the determined PDSCH time domain allocation list (e.g., according to the examples of FIG. 29).

Examples of FIG. 33 may be (e.g., equally) applicable for multi-cell multi-PUSCH transmissions. For example, a wireless device may or may not be configured with a higher layer parameter ScheduledCell-ListDCI-1-3 on a serving cell within a PUCCH group, for example, based on the one or more examples. The wireless device may not expect to be configured with higher layer parameter ScheduledCell-ListDCI-1-3 on any serving cell within the PUCCH group, for example if the wireless device is configured with pdsch-TimeDomainAllocationListForMultiPDSCH in which one or more rows contain multiple SLIVs for PDSCH on a DL BWP of a serving cell within the PUCCH group and is not configured with Type 2 multi-cell scheduling. The wireless device may be configured with higher layer parameter ScheduledCell-ListDCI-1-3 on any serving cell within the PUCCH group, for example, if the wireless device is configured with pdsch-TimeDomainAllocationListForMultiPDSCH in which one or more rows contain multiple SLIVs for PDSCH on a DL BWP of a serving cell within the PUCCH group and is configured with Type 2 multi-cell scheduling.

A base station and/or a wireless device may be aligned, for example, by implementing the one or more examples of FIG. 33. A base station and/or a wireless device may be aligned, for example, based on one or more parameters of the base station indicating whether a DCI format is used for Type 1 multi-cell scheduling and/or Type 2 multi-cell scheduling. A base station and/or a wireless device may be aligned, for example, with which PDSCH/PUSCH TDRA table/list may be used for PDSCH/PUSCH receptions and/or transmissions on multiple cells, for example, if/when multiple PDSCH/PUSCH TDRA tables/lists may be configured on a BWP of a co-scheduled cell. Examples described herein may improve detection reliability of the DCI format and/or increase system throughput.

FIG. 34 shows an example of Type 2 multi-cell scheduling. FIG. 34 shows an example of Type 2 multi-cell scheduling, for example, based on examples of FIG. 33.

A TDRA field index list may be configured in a serving cell configuration of a serving cell for Type 2 multi-cell scheduling, for example, as shown in FIG. 34. A TDRA field index list may be configured in a serving cell configuration of a serving cell for Type 2 multi-cell scheduling, for example, based on examples of FIG. 24. The TDRA field index list for Type 2 multi-cell scheduling may reuse the TDRA field index list (e.g., tdra-FieldIndexListDCI-1-3-r18) configured for Type 1 multi-cell scheduling. The TDRA field index list for Type 2 multi-cell scheduling may be a (e.g., new) TDRA field index list (e.g., tdra-FieldIndexListDCI-1-3-r19) configured separately and/or independently from the TDRA field index list (e.g., tdra-FieldIndexListDCI-1-3-r18) configured for Type 1 multi-cell scheduling.

The maximum number/quantity of TDRA indexes among all entries of the TDRA field index list (e.g., new list) configured for Type 2 multi-cell scheduling may be different from the maximum number of TDRA indexes among all entries of the TDRA field index list configured for Type 1 multi-cell scheduling.

The maximum number/quantity of TDRA indexes among all entries of the TDRA field index list (e.g., new list) configured for Type 2 multi-cell scheduling may be smaller than the maximum number of TDRA indexes among all entries of the TDRA field index list configured for Type 1 multi-cell scheduling. Allowing a smaller number/quantity of TDRA indexes may bring advantages such as reducing the size of the TDRA field index indications in the one or more RRC messages, reducing the wireless device processing complexity. The reduction of size and/or processing complexity may be helpful, for example, if/when different co-scheduled cells may be configured with different SCSs/FRs/carrier types. This may be different from the Type 1 multi-cell scheduling where all co-scheduled cells may be configured with the same SCS/FR/carrier type.

The maximum number/quantity of entries of the TDRA field index list (e.g., new list) configured for Type 2 multi-cell scheduling may be different from the maximum number of entries of the TDRA field index list configured for Type 1 multi-cell scheduling. A size of a TDRA field of the DCI (e.g., as shown in FIG. 34) may be determined, for example, based on the maximum number/quantity of entries of the TDRA field index list. For example, a bit width of the TDRA field may be determined as [log₂ (I_{TDRA})] bits, where I_{TDRA} is the number/quantity of entries in the list. The TDRA field may be used to indicate an entry in the list. Each entry in the list may comprise a TDRA index for each BWP of each cell in the scheduled cell set. The TDRA indexes for all the cells may be placed, for example, according to an ascending order of a serving cell index. The TDRA indexes for all the BWPs of a cell may be placed, for example, according to an ascending order of the higher layer parameter BWP ID (e.g., BWP-Id).

The maximum number/quantity of entries of the TDRA field index list (e.g., new list) configured for Type 2 multi-cell scheduling may be smaller than the maximum number/quantity of entries of the TDRA field index list configured for Type 1 multi-cell scheduling. Allowing a smaller number/quantity of entries may bring advantages such as reducing size of the TDRA field in the DCI, reducing the wireless device processing complexity. The reduction of size and/or processing complexity may be helpful, for example, if/when different co-scheduled cells may be configured with different SCSs/FRs/carrier types. This may be different from the Type 1 multi-cell scheduling where all co-scheduled cells may be configured with the same SCS/FR/carrier type.

A (e.g., each) entry of the TDRA field index list for Type 2 multi-cell scheduling may comprise a plurality of TDRA indexes for one or more BWPs of co-scheduled cells. For example, as shown in FIG. 34, TDRA #1 may be associated with BWP 1 of cell 1, TDRA #2 may be associated with BWP 2 of cell 1, TDRA #3 may be associated with BWP 1 of cell 2, . . . . TDRA #4 may be associated with BWP1 of cell N, etc.

A wireless device may use the TDRA table/list configured for multi-PDSCH scheduling on BWP 1 of cell 1, for example, if/when DCI (e.g., the DCI as shown in FIG. 33) may indicate Type 2 multi-cell scheduling and may comprise a TDRA field with a value indicating entry 1 of a TDRA field index list (e.g., tdra-FieldIndexListDCI-1-3). A wireless device may use the TDRA table/list configured for multi-PDSCH scheduling on BWP 1 of cell 1, for example, if the active BWP of cell 1 is BWP 1 (e.g., as indicated by the BWP ID of the DCI). The TDRA table/list configured for multi-PDSCH scheduling on BWP 1 of cell 1 may be, for example, the 1^{st} TDRA table as shown in FIG. 34. The TDRA table/list configured for multi-PDSCH scheduling on BWP 1 of cell 1 may be, for example, a time domain allocation list for multiple PDSCHs (e.g., pdsch-Time DomainAllocationListForMultiPDSCH based on examples of FIG. 27 and/or FIG. 36 which will be described herein). The wireless device may determine corresponding K0, S and L values (set of K0, S and L) from the 1^{st} TDRA table, for example, for each PDSCH (e.g., PDSCH 1, PDSCH 2, PDSCH 3, etc.). The wireless device may determine corresponding K0, S and L values (set of K0, S and L) from the 1^{st} TDRA table, for example, based on TDRA #1 indicated for BWP1 of Cell 1 in entry 1 of the TDRA field index list (e.g., tdra-FieldIndexListDCI-1-3 based on examples of FIG. 29).

A wireless device may use the TDRA table/list configured for multi-PDSCH scheduling on BWP 2 of cell 1, for example, if/when the DCI may indicate Type 2 multi-cell scheduling and may comprise a TDRA field with a value indicating entry 1 of a TDRA field index list (e.g., tdra-FieldIndexListDCI-1-3). A wireless device may use the TDRA table/list configured for multi-PDSCH scheduling on BWP 2 of cell 1, for example, if the active BWP of cell 1 is BWP 2 (e.g., as indicated by the BWP ID of the DCI). The TDRA table/list configured for multi-PDSCH scheduling on BWP 2 of cell 1 may be, for example, the 2nd TDRA table as shown in FIG. 34. The TDRA table/list configured for multi-PDSCH scheduling on BWP 2 of cell 1 may be, for example, a time domain allocation list for multiple PDSCHs (e.g., pdsch-TimeDomainAllocationList ForMultiPDSCH based on examples of FIG. 27 and/or FIG. 36 which will be described herein). The wireless device may determine corresponding K0, S and L values (set of K0, S and L) from the 2nd TDRA table, for example, for each PDSCH (e.g., PDSCH 1, PDSCH 2, PDSCH 3, etc.). The wireless device may determine corresponding K0, S and L values (set of K0, S and L) from the 2nd TDRA table, for example, based on TDRA #2 indicated for BWP2 of Cell 1 in entry 1 of the TDRA field index list (e.g., tdra-FieldIndexListDCI-1-3 based on examples of FIG. 29).

A base station and/or a wireless device may be aligned with which PDSCH/PUSCH TDRA table/list may be used for PDSCH/PUSCH receptions and/or transmissions on multiple cells, for example, if/when multiple PDSCH/PUSCH TDRA tables/lists may be configured on a BWP of a co-scheduled cell. A base station and/or a wireless device may be aligned with which PDSCH/PUSCH TDRA table/list may be used for PDSCH/PUSCH receptions and/or transmissions on multiple cells, for example, by implementing the one or more examples of FIG. 34. Examples described herein may improve detection reliability of the DCI format and/or increase system throughput.

FIG. 35 shows an example of serving cell configuration of a serving cell for multi-cell scheduling. FIG. 35 shows an example of serving cell configuration of a serving cell for multi-cell scheduling, for example, based on examples of FIG. 24, FIG. 33 and/or FIG. 34.

A serving cell configuration of a serving/scheduling cell may be configured with one or more parameters (e.g., enablingMulti-PDSCH-MultiCC-r19) (e.g., explicitly) indicating whether Type 1 multi-cell scheduling or Type 2 multi-cell scheduling may be configured on the serving cell, for example, as shown in FIG. 35. For example, the parameter enablingMulti-PDSCH-MultiCC-r19 set to “enable” may indicate that Type 2 multi-cell scheduling may be supported/configured on the cell. In this case, the wireless device may perform Type 2 multi-cell scheduling, for example, based on examples of FIG. 33 and/or FIG. 34. For example, the parameter enablingMulti-PDSCH-MultiCC-r19 may be absent in the serving cell configuration of the serving cell. In this case, the wireless device may perform Type 1 multi-cell scheduling, for example, based on examples of FIG. 33 and/or FIG. 34.

The one or more parameters may be implicitly configured, for example, instead of configuring the parameter enablingMulti-PDSCH-MultiCC-r19 in the serving cell configuration of the serving cell. For example (not shown in FIG. 35), the base station may configure an (e.g., new) information element MC-DCI-SetOfCells-r19, different from the information element MC-DCI-SetOfCells-r18 in the serving cell configuration of the serving cell, indicating that Type 2 multi-cell scheduling may be configured. One or more parameters of the (e.g., new) MC-DCI-SetOfCells-r19 may be separately and/or independently configured from one or more parameters of the MC-DCI-SetOfCells-r18. For example (as shown in FIG. 35), The base station may configure one or more (e.g., new) parameters in the MC-DCI-SetOfCells-r18 in the serving cell configuration of the serving cell, indicating that Type 2 multi-cell scheduling may be configured. The one or more (e.g., new) parameters may comprise tdra-FieldIndexListDCI-1-3-r19, and/or tdra-FieldIndexListDCI-0-3-r19, separate from the tdra-FieldIndexListDCI-1-3-r18, and/or tdra-FieldIndexListDCI-0-3-r18. The parameter tdra-FieldIndexListDCI-1-3-r19 may comprise a number/quantity of the parameter TDRA-FieldIndexDCI-1-3-r19. Each parameter TDRA-FieldIndexDCI-1-3-r19 may comprise at most a number/quantity (e.g., maxNrofBWPsInSetOfCells-r19) of values (e.g., INTEGER (0 . . . maxNRofDI-Allocations-1-r19)) configured for Type 2 multi-cell scheduling.

The parameter maxNrofBWPsInSetOfCells-r19 may be the same as the parameter maxNrofBWPsInSetOfCells-r18. The parameter maxNrofBWPsInSetOfCells-r19 may be different from the parameter maxNrofBWPsInSetOfCells-r18. The parameter maxNRofDl-Allocations-1-r19 may be the same as the parameter maxNRofDI-Allocations-1-r18. The parameter maxNRofDI-Allocations-1-r19 may be different from the parameter maxNRofDl-Allocations-1-r18. For example (not shown in FIG. 35), the information element MC-DCI-SetOfCells-r18 may comprise the one or more (e.g., new) parameters comprising setOfCellsId-r19 (different from setOfCellsId-r18), nCl-Value-r19 (different from nCl-Value-r18), scheduledCellListDCI-1-3-r19 (different from scehduledCellListDCI-1-3-r18), scheduledCellListDCI-0-3-r19 (different from scehduledCellListDCI-0-3-r18), scheduledCellComboListDCI-1-3-r19 (different from scheduledCellComboListDCI-1-3-r18), scheduledCellComboListDCI-0-3-r19 (different from scheduledCellComboListDCI-0-3-r18), etc., indicating that Type 2 multi-cell scheduling may be configured on the serving/scheduling cell.

The wireless device may determine that Type 1 multi-cell scheduling may be applied on (e.g., used for) the serving cell, for example, if/when the one or more (e.g., new) parameters may be released/absent in the serving cell configuration of the serving/scheduling cell. The wireless device may determine that Type 1 multi-cell scheduling may be applied on (e.g., used for) the serving cell, for example, if Type 1 multi-cell scheduling is not released.

A base station and/or a wireless device may be aligned with which type of multi-cell scheduling may be configured and/or how configuration parameters may be applied/used for the type of multi-cell scheduling, for example, based on examples of FIG. 33, FIG. 34, and/or FIG. 35. Examples described herein may improve detection reliability of the DCI format and/or increase system throughput.

FIG. 36 shows an example of PDSCH configuration of a scheduled cell for multi-cell scheduling. FIG. 36 shows an example of PDSCH configuration of a scheduled cell for multi-cell scheduling, for example, based on examples of FIG. 33, FIG. 34, and/or FIG. 35.

A PDSCH configuration (e.g., PDSCH-Config) of a co-scheduled cell (or a BWP of a co-scheduled cell) may be configured with one or more (e.g., new) parameters for Type 2 multi-cell scheduling, for example, as shown in FIG. 36. The one or more (e.g., new) parameters for Type 2 multi-cell scheduling may comprise a (e.g., new) PDSCH TDRA list (e.g., pdsch-TimeDomainAllocationListForMultiPDSCH-r19) different from a (e.g., existing) PDSCH TDRA list (e.g., pdsch-TimeDomainAllocationListForMultiPDSCH-r17). The PDSCH TDRA list pdsch-TimeDomainAllocationListForMultiPDSCH-r19 may be configured by MultiPDSCH-TDRA-List-r19 different from MultiPDSCH-TDRA-List-r17. For example, MultiPDSCH-TDRA-List-r19 may comprise a smaller number/quantity of entries than MultiPDSCH-TDRA-List-r17. Each entry of MultiPDSCH-TDRA-List-r19 may comprise a smaller number/quantity of TDRA configurations than an entry of MultiPDSCH-TDRA-List-r17.

Configuring the (e.g., new) PDSCH TDRA list may allow the base station to schedule multiple cells, for example, by implementing examples described herein. Configuring the (e.g., new) PDSCH TDRA list may allow the base station to schedule multiple cells, for example, by considering more implementation complexity (than at least some wireless communications) at the base station and/or the wireless device. Configuring the (e.g., new) PDSCH TDRA list may allow the base station to schedule multiple cells, for example, if/when the multiple cells may be scheduled with more than one PDSCH/PUSCH and/or may be configured with SCS/FR/carrier type different from the serving/scheduled cell.

The one or more (e.g., new) parameters for Type 2 multi-cell scheduling may be comprised in the (e.g., existing) PDSCH-ConfigDCI-1-3-r18, or in a (e.g., new) PDSCH-ConfigDCI-1-3-r19 not shown in FIG. 36. The one or more (e.g., new) parameters may comprise numberOfBitsForRV-DCI-1-3-r19 (which may be 0 or 1 bit) different from numberOfBitsForRV-DCI-1-3-r18 (which may be 0, 1, 2 bits). Reduced number/quantity of bits for RV indication for Type 2 multi-cell scheduling may reduce processing complexity of the wireless device. The one or more (e.g., new) parameters may comprise harq-ProcessNumberSizeDCI-1-3-r19 (which may be 0, 1, 2, 3, 4, 5 bits) different from harq-ProcessNumberSizeDCI-1-3-r18 (which may be 0, 1, 2, 3, 4, 5 bits).

Configuring the (e.g., new) PDSCH parameters of a scheduled cell for Type 2 multi-cell scheduling may allow the base station to schedule multiple cells, for example, by implementing examples of FIG. 36. Configuring the (e.g., new) PDSCH parameters of a scheduled cell for Type 2 multi-cell scheduling may allow the base station to schedule multiple cells, for example, by considering more implementation complexity (than at least some wireless communications) at the base station and/or the wireless device. Configuring the (e.g., new) PDSCH parameters of a scheduled cell for Type 2 multi-cell scheduling may allow the base station to schedule multiple cells, for example, if/when the multiple cells may be scheduled with more than one PDSCH/PUSCH and/or may be configured with SCS/FR/carrier type different from the serving/scheduled cell.

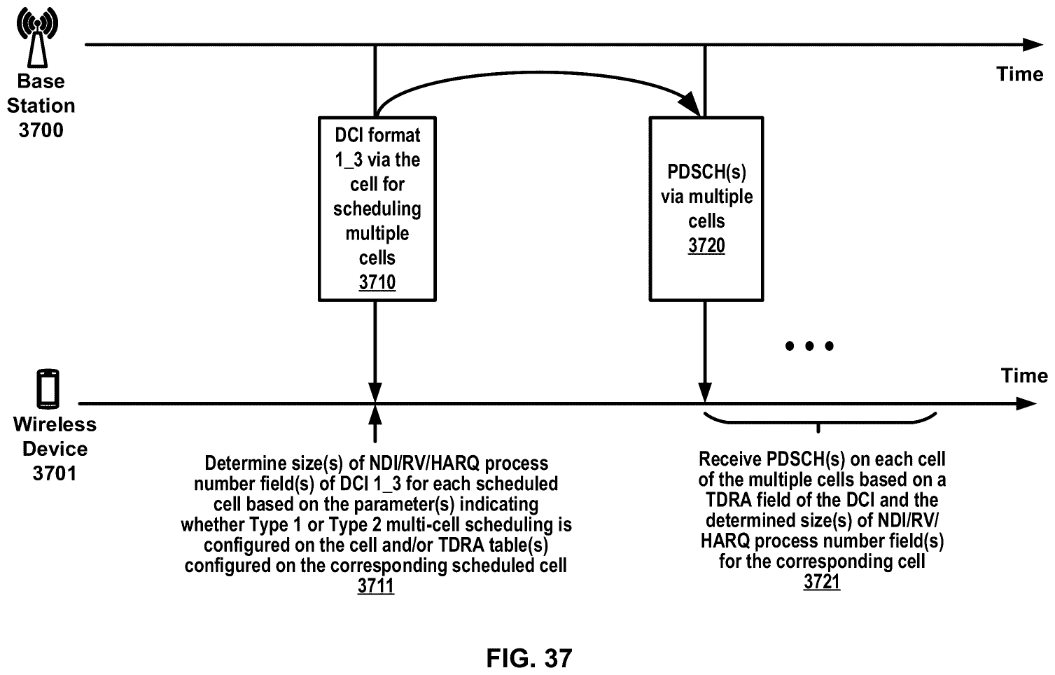

FIG. 37 shows an example of multi-cell scheduling. More specifically, FIG. 37 shows an example of DCI field size determination for multi-cell scheduling. FIG. 37 shows an example of DCI field size determination for multi-cell scheduling, for example, based on examples of FIG. 33, FIG. 34, FIG. 35, and/or FIG. 36. One or more steps of the example method may be rearranged (e.g., performed in a different order), omitted, and/or otherwise modified, and/or with other steps added.

A wireless device (e.g., 3701) may receive, from a base station (e.g., 3700), DCI with a DCI format 1_3 (e.g., as shown in FIG. 37, at step 3710). The wireless device may receive the DCI with the DCI format 1_3 via a cell for scheduling multiple cells. The wireless device may receive the DCI with the DCI format 1_3 indicating a multi-cell scheduling. The multi-cell scheduling may be Type 1 multi-cell scheduling or Type 2 multi-cell scheduling, for example, based on examples of FIG. 33, FIG. 34, FIG. 35, and/or FIG. 36.

The wireless device may determine size(s) of one or more DCI fields (e.g., NDI/RV/HARQ process number) of the DCI format (e.g., DCI format 1_3) for each co-scheduled cell (e.g., at step 3711). The wireless device may determine size(s) of one or more DCI fields (e.g., NDI/RV/HARQ process number) of the DCI format for each co-scheduled cell, for example, based on receiving the DCI format. The wireless device may determine the size(s) of one or more DCI fields (e.g., NDI/RV/HARQ process number) of the DCI format for each co-scheduled cell, for example, based on whether the DCI (e.g., parameter(s)) may indicate Type 1 multi-cell scheduling or Type 2 multi-cell scheduling. The wireless device may determine whether the DCI may indicate Type 1 multi-cell scheduling or Type 2 multi-cell scheduling, for example, based on examples of FIG. 33, FIG. 34, FIG. 35, and/or FIG. 36. The wireless device may determine the size(s) of one or more DCI fields (e.g., NDI/RV/HARQ process number) of the DCI format for each co-scheduled cell, for example, based on TDRA table(s) configured on the corresponding scheduled cell.

The wireless device may determine a block of the NDI field, corresponding to a cell, for example, based on (e.g., in response to) the DCI format indicating Type 1 multi-cell scheduling. For example, the wireless device may determine that a first block of the NDI field, corresponding to the first cell, is 1 bit, for example, based on (e.g., in response to) the DCI format indicating Type 1 multi-cell scheduling. The wireless device may determine that a first block of the NDI field, corresponding to the first cell, is 1 bit, for example, if/when receiving the DCI indicating multiple PDSCHs scheduling on multiple cells with one PDSCH per cell (e.g., Type 1 multi-cell scheduling) and/or comprising an NDI field (comprising a plurality of blocks) for multiple cells.

The wireless device may determine that the first block of the NDI field, corresponding to the first cell (or the first BWP of the first cell), may comprise a number/quantity (e.g., >=2) of bits, for example, based on (e.g., in response to) the DCI indicating Type 2 multi-cell scheduling. The wireless device may determine that the first block of the NDI field may comprise a number/quantity (e.g., >=2) of bits, for example, if/when receiving the DCI indicating Type 2 multi-cell scheduling and/or comprising an NDI field (comprising a plurality of blocks) for multiple cells. The number/quantity (e.g., >=2) of bits may be determined, for example, based on the maximum number/quantity of schedulable PDSCH among all entries of a PDSCH TDRA table (e.g., of the first cell or of the first BWP of the first cell) configured for multiple PDSCH scheduling (e.g., pdsch-TimeDomainAllocationListDCI-1-3-r17, pdsch-TimeDomainAllocationListDCI-1-3-r19, as shown in FIG. 36). Each bit may correspond to one scheduled PDSCH of the first cell.

An NDI field of the DCI format may comprise a plurality of blocks for multiple co-scheduled cells. A (e.g., each) block may correspond to the NDI for a respective cell of the multiple cells. The blocks may be placed, for example, according to an ascending order of a serving cell index. For example, block number 1 may correspond to the new data indicator for the cell with the smallest serving cell index. Each block may be 1 bit, for example, if Type 1 multi-cell scheduling may be configured (or Type 2 multi-cell scheduling is not configured) and/or if the number/quantity of scheduled PDSCH indicated by the TDRA field is 1. Each block may comprise other quantity of (e.g., 2, 3, 4, 5, 6, 7 or 8) bits, for example, if Type 2 multi-cell scheduling is configured and/or if the number/quantity of scheduled PDSCH indicated by the TDRA field is more than 1. The quantity of (e.g., 2, 3, 4, 5, 6, 7 or 8) bits may be determined, for example, based on the maximum number/quantity of schedulable PDSCHs among all entries in the field pdsch-TimeDomainAllocationListForMultiPDSCH (e.g., as shown in FIG. 36). Each bit may correspond to one scheduled PDSCH as defined in clause 5.1.3 in TS 38.214 (e.g., based on examples of FIG. 29).

The wireless device may determine that a first block of the RV field, corresponding to a first cell, may comprise a quantity of (e.g., 0, 1 or 2) bits, for example, based on (e.g., in response to) the DCI format indicating Type 1 multi-cell scheduling. The wireless device may determine that the first block of the RV field may comprise a quantity of (e.g., 0, 1 or 2) bits, for example, if/when receiving the DCI indicating multiple PDSCHs scheduling on multiple cells with one PDSCH per cell (e.g., Type 1 multi-cell scheduling) and/or comprising a RV field (comprising a plurality of blocks) for multiple cells. The quantity of (e.g., 0, 1 or 2) bits may be determined by the field numberOfBitsForRV-DCI-1-3 (e.g., as shown in FIG. 36) configured for the DCI format indicating Type 1 multi-cell scheduling.

The wireless device may determine that a first block of the RV field, corresponding to a first cell, may comprise a number/quantity of (e.g., >=2) bits, for example, based on (e.g., in response to) the DCI format indicating Type 2 multi-cell scheduling. The wireless device may determine that the first block of the RV field may comprise a number/quantity of (e.g., >=2) bits, for example, if/when receiving the DCI indicating Type 2 multi-cell scheduling and/or comprising a RV field comprising a plurality of blocks for multiple cells. The number/quantity of (e.g., >=2) bits may be determined, for example, based on the maximum number/quantity of schedulable PDSCH among all entries of the second PDSCH TDRA table (e.g., of the first cell or of the first BWP of the first cell) and/or the field numberOfBitsForRV-DCI-1-3-19. Each bit may correspond to one scheduled PDSCH of the first cell.

An RV field of the DCI format may comprise a plurality of blocks for multiple co-scheduled cells. A (e.g., each) block may correspond to the RV for a respective cell of the multiple cells. The blocks may be placed, for example, according to an ascending order of a serving cell index. For example, block number 1 may correspond to the RV for the cell with the smallest serving cell index. Each block may be 0, 1 or 2 bits, for example, if Type 1 multi-cell scheduling is configured (or Type 2 multi-cell scheduling is not configured). The quantity of (e.g., 0, 1 or 2) bits may be determined by the parameter numberOfBitsForRV-DCI-1-3-r18 configured for the cell corresponding to the block. Each block may comprise other quantity of (e.g., 2, 3, 4, 5, 6, 7 or 8) bits, for example, if Type 2 multi-cell scheduling is configured and/or if the number/quantity of scheduled PDSCH indicated by the TDRA field is more than 1. The other quantity of (e.g., 2, 3, 4, 5, 6, 7 or 8) bits may be determined, for example, based on the maximum number/quantity of schedulable PDSCH among all entries in the field pdsch-TimeDomainAllocationListForMultiPDSCH. Each bit may correspond to one scheduled PDSCH as defined in clause 5.1.3 in TS 38.214 (e.g., based on examples of FIG. 29).

The wireless device may determine that a HARQ process number field, corresponding to a first cell, may comprise a first number/quantity of bits, for example, based on (e.g., in response to) the DCI format indicating Type 1 multi-cell scheduling. The wireless device may determine that the HARQ process number field may comprise a first number/quantity of bits, for example, if/when receiving the DCI format indicating Type 1 multi-cell scheduling and/or comprising multiple HARQ process number fields for multiple cells. The first number/quantity may be indicated by a first parameter (e.g., harq-ProcessNumberSizeDCI-1-3-r18) of the first cell and/or may be configured for the DCI format indicating Type 1 multi-cell scheduling.

The wireless device may determine that a HARQ process number field, corresponding to a first cell (or a first BWP of the first cell), may comprise a second number/quantity of bits, for example, based on (e.g., in response to) the DCI format indicating Type 2 multi-cell scheduling. The wireless device may determine that the HARQ process number field may comprise a second number/quantity of bits, for example, if/when receiving the DCI format indicating Type 2 multi-cell scheduling. The second number/quantity may be indicated by a second parameter (e.g., harq-ProcessNumberSizeDCI-1-3-r19) of the first cell (or of the first BWP of the first cell) and/or may be configured for the DCI format indicating Type 2 multi-cell scheduling.

A wireless device (e.g., 3701) may receive, from a base station (e.g., 3700), PDSCH(s) via multiple cells (e.g., as shown in FIG. 37, at step 3720). The wireless device may receive PDSCH(s) on each cell of the multiple cells, for example, based on a TDRA field of the DCI and the determined size(s) of NDI/RV/HARQ process number field(s) for the corresponding cell (e.g., at step 3721).

Examples of FIG. 33, FIG. 34, FIG. 35, FIG. 36, and/or FIG. 37 may be applicable for Type 2 multi-cell scheduling for PUSCH(s) transmissions on multiple cells. Detailed descriptions for examples of PUSCH may be omitted.

A base station and a wireless device may be aligned on how to receive the DCI format and/or corresponding PDSCH(s)/PUSCH(s) on multiple cells, for example, by implementing examples of FIG. 37. The base station and the wireless device may be aligned on how to receive the DCI format and/or corresponding PDSCH(s)/PUSCH(s) on multiple cells, for example, by determining size(s) of one or more DCI fields of a DCI format, for example, based on whether the DCI format indicating Type 1 multi-cell scheduling or Type 2 multi-cell scheduling. Examples described herein may improve delivery robustness of the DCI format and/or system throughput.

One or more examples (e.g., based on examples of FIG. 33, FIG. 34, FIG. 35, FIG. 36, and/or FIG. 37) may comprise receiving, by a wireless device from a base station, one or more messages comprising one or more first parameters, and second parameters of the second cell. The one or more first parameters may indicate whether DCI configured on a first cell may be used to indicate/perform Type 1 multi-cell scheduling or Type 2 multi-cell scheduling. The second parameters may indicate a first PDSCH time domain allocation list for single-PDSCH scheduling and/or a second PDSCH time domain allocation list for multiple-PDSCH scheduling. The wireless device may receive, from the base station and via the first cell, the DCI comprising a TDRA field. The TDRA field may comprise a plurality of TDRA indexes comprising a first TDRA index associated with the second cell. The wireless device may determine that the first TDRA index may indicate an entry of the first PDSCH time domain allocation list or an entry of the second PDSCH time domain allocation list, for example, based on the one or more first parameters. The wireless device may receive one or more PDSCHs via the second cell, for example, based on the determined entry.

One or more examples may comprise receiving, by a wireless device from a base station, one or more messages comprising: one or more first parameters indicating that a DCI format configured on a first cell may be used to indicate/perform Type 2 multi-cell scheduling; and second parameters of a second cell. The second parameters may indicate a second PDSCH time domain allocation list for multiple-PDSCH scheduling. The wireless device may receive, via the first cell, the DCI format comprising a TDRA field. The TDRA field may comprise a plurality of TDRA indexes comprising a first TDRA index associated with the second cell. The wireless device may determine that the first TDRA index may indicate an entry of the PDSCH time domain allocation list, for example, based on the one or more first parameters. The wireless device may receive one or more PDSCHs via the second cell, for example, based on the determined entry.

One or more examples may comprise receiving, by a wireless device from a base station, one or more messages indicating a DCI format, configured on a first cell, used for Type 2 multi-cell scheduling, and a PDSCH time domain allocation list for multiple-PDSCH scheduling of a second cell. The wireless device may receive, via the first cell, the DCI format comprising a TDRA field. The TDRA field may comprise a plurality of TDRA indexes comprising one or more first TDRA indexes associated with the second cell. The wireless device may determine that the one or more first TDRA indexes may indicate an entry of the PDSCH time domain allocation list. The wireless device may receive one or more PDSCHs via the second cell, for example, based on the determined entry.

One or more examples may comprise receiving, by a wireless device from a base station, one or more messages comprising a first parameter indicating that DCI may be configured on a first cell. The DCI may schedule multiple PDSCHs on multiple cells comprising a second cell scheduled with at least two PDSCHs. The one or more messages may comprise a PDSCH time domain allocation list, of the second cell. The PDSCH time domain allocation list may comprise a plurality of entries with each entry indicating a number of schedulable PDSCHs. The wireless device may receive the DCI, for example, via the first cell and based on the first parameter. The DCI may comprise a first block, of a NDI field, corresponding to the second cell. A size of the first block may be determined, for example, based on the maximum number/quantity of schedulable PDSCHs among the plurality of entries in the PDSCH time domain allocation list of the second cell. The wireless device may receive one or more PDSCHs via the second cell, for example, based on the determined size of the first block.

One or more examples may comprise receiving, by a wireless device from a base station, one or more messages comprising a first PDSCH time domain allocation list of a first cell and a second PDSCH time domain allocation list of a second cell. The wireless device may receive DCI scheduling PDSCHs on the first cell and the second cell. The DCI may comprise an NDI field comprising a first block and a second block corresponding to the first cell and the second cell, respectively. The wireless device may determine the size of the first block, for example, based on the maximum number/quantity of schedulable PDSCHs among entries in the first PDSCH time domain allocation list. The wireless device may determine the size of the second block, for example, based on the maximum number/quantity of schedulable PDSCHs among entries in the second PDSCH time domain allocation list. The wireless device may receive one or more first PDSCHs via the first cell, for example, based on the determined size of the first block. The wireless device may receive one or more second PDSCHs via the second cell, for example, based on the determined size of the second block.

One or more examples may comprise receiving, by a wireless device from a base station, DCI scheduling multiple PDSCHs on a first cell and a second cell. The DCI may comprise an NDI/RV field comprising a first block and a second block corresponding to the first cell and the second cell, respectively. The size of the first block may be determined, for example, based on the (e.g., maximum number/quantity of) schedulable PDSCHs among entries in the first PDSCH time domain allocation list. The size of the second block may be determined, for example, based on the (e.g., maximum number/quantity) of schedulable PDSCHs among entries in the second PDSCH time domain allocation list.

One or more examples may comprise receiving, by a wireless device from a base station, DCI scheduling multiple PDSCHs on a first cell and a second cell. The DCI may comprise an HARQ process number field comprising a first block and a second block corresponding to the first cell and the second cell, respectively. The size of the first block may be determined, for example, based on a first value associated with the first cell. The size of the second block may be determined, for example, based on a second value associated with the second cell. The first value may be configured on the first cell for the DCI. The second value may be configured on the second cell for the DCI.

A Type 1 multi-cell scheduling may comprise scheduling, by the DCI, multiple PDSCHs on multiple cells with one PDSCH per cell. A type 2 multi-cell scheduling may comprise scheduling, by the DCI, multiple PDSCHs on multiple cells with at least one cell scheduled with at least two PDSCHs. The multiple cells may be configured with at least one of: a same carrier type and/or a same subcarrier spacing, for example, for the Type 1 multi-cell scheduling.

A carrier type may comprise whether the cell may be deployed in licensed band or in unlicensed band. A carrier type may comprise a frequency range where the cell may be deployed.

The multiple cells may comprise at least two cells configured with: different carrier types and/or different subcarrier spacing values, for example, for the Type 2 multi-cell scheduling. The multiple cells may comprise the first cell on which the DCI may be received.

The first cell may be deployed in a first frequency range. The second cell may be deployed in a second frequency range. The first cell and the second cell may be configured with different subcarrier spacing values.

The wireless device may monitor a PDCCH on the first cell. The wireless device may monitor a PDCCH on the first cell, for example, for receiving the DCI format.

A (e.g., each) entry of the first PDSCH time domain allocation list for single-PDSCH scheduling may comprise at least one of: a K0 value indicating a slot offset between the PDSCH and the DCI, a PDSCH mapping indication, and/or a start symbol and length indicator.

A (e.g., each) entry of the second PDSCH time domain allocation list for multi-PDSCH scheduling may comprise a plurality of PDSCH TDRA configurations. Each PDSCH TDRA configuration may correspond to a respective PDSCH of multiple PDSCHs. Each PDSCH TDRA configuration may be associated with at least one of: a K0 value indicating a slot offset between the DCI and the corresponding PDSCH, a PDSCH mapping indication, and/or a start symbol and length indicator.

The first list may be configured on a first BWP of one or more BWPs of the second cell. The second list may be configured on the first BWP of one or more BWPs of the second cell.

The wireless device may send (e.g., transmit) to the base station, one or more second RRC messages comprising wireless device's radio access capability information. radio The access capability information may comprise one or more parameters indicating whether the wireless device may support Type 1 multi-cell scheduling or Type 2 multi-cell scheduling.

The one or more parameters may be per frequency band indicated. The one or more parameters may be per frequency band combination indicated. The one or more parameters may be per frequency range indicated. The one or more parameters may be per frequency range combination indicated. A frequency range combination may comprise at least one of: FR1+FR 2, FR1+FR2−2, FR2+FR2−2, and/or FR1+FR2+FR2−2. A frequency range combination being set to FR1+FR2 may comprise: the scheduling cell being configured on FR1 and one or more scheduled cells being configured on FR2. A frequency range combination being set to FR1+FR2+FR2−2 may comprise: the scheduling cell being configured on FR1, one or more first scheduled cells being configured on FR2 and one or more first scheduled cells being configured on FR2−2.

The one or more parameters may be per SCS combination indicated. A SCS combination may comprise at least one of: 15 KHz+30 KHz, 15 KHz+60 KHz, 15 KHZ+480 KHz, 15 KHz+960 KHz and/or 15 KHz+60 KHz+960 KHz. A SCS combination being set to 15 KHz+30 KHz may comprise: the scheduling cell being configured with 15 KHz SCS and one or more scheduled cells being configured with 30 KHz SCS. A SCS combination being set to 15 KHz+60 KHz+960 KHz may comprise: the scheduling cell being configured with 15 KHz SCS, one or more first scheduled cells being configured with 60 KHz SCS, and one or more second scheduled cells being configured with 960 KHz SCS.

The one or more parameters may indicate whether the wireless device may support Type 2 multi-cell scheduling with: the scheduling cell being configured in licensed band and one or more scheduled cells being configured in unlicensed band. The one or more parameters may indicate a (maximum/supported) number/quantity of different SCS values configured for multiple cells on which the wireless device may support Type 2 multi-cell scheduling. The one or more parameters may indicate a (maximum/supported) number/quantity of frequency ranges configured for multiple cells on which the wireless device may support Type 2 multi-cell scheduling.

The first block, of the NDI field, may correspond to a first BWP of a plurality of BWPs of the first cell. Each BWP of the plurality of BWPs of the first cell may be associated with a respective block. The first BWP may be indicated by a BWP ID of the DCI.

The second block, of the NDI field, may correspond to a second BWP of a plurality of BWPs of the second cell. Each BWP of the plurality of BWPs of the second cell may be associated with a respective block. The second BWP may be indicated by the BWP ID of the DCI.

A wireless device may perform a method comprising multiple operations. The wireless device may receive one or more configuration parameters. The one or more configuration parameters may indicate: a format associated with scheduling for multiple cells and for multiple transmissions via at least one cell of the multiple cells; and time domain resource allocations (TDRAs) associated with the scheduling. The wireless device may receive downlink control information formatted according to the format associated with the scheduling. The downlink control information may be configured to schedule a plurality of transmissions via a first cell of the multiple cells.

The downlink control information may comprise a time domain resource allocation (TDRA) field. The TDRA field may indicate a plurality of TDRA indexes. A first TDRA index, of a plurality of TDRA indexes, indicated by the TDRA field, may indicate one or more TDRAs of the TDRAs associated with the scheduling. Each TDRA of the one or more TDRAs may correspond to a respective scheduled transmission of a plurality of transmissions scheduled, via a first cell of the multiple cells, by the downlink control information. The wireless device may receive, via the first cell, the plurality of scheduled transmissions. The downlink control information may further comprise a new data indicator (NDI) field. The NDI field may comprise a plurality of blocks. A first block, of the plurality of blocks, may contain a number of bits equal to a maximum number of a plurality of schedulable transmissions. Each bit of the number of bits may correspond to a schedulable transmission. The maximum number may be determined based on the TDRAs. The TDRAs may be indicated in the downlink control information. The multiple transmissions may comprise at least one of: multiple downlink transmissions via a physical downlink shared channel (PDSCH); or multiple uplink transmissions via a physical uplink shared channel (PUSCH). The first TDRA index may further indicate a bandwidth part of the first cell. The wireless device may receive the plurality of scheduled transmissions via the bandwidth part of the first cell. The multiple cells may comprise at least two cells configured with one or more of: different carrier types; or different subcarrier spacing values. The TDRAs may be comprised in a TDRA table, and at least one entry of the TDRA table may correspond to multiple TDRAs. The TDRAs may be comprised in a TDRA table. Each TDRA index, of the plurality of TDRA indexes, may correspond to an entry of the TDRA table. The TDRAs may be comprised in a TDRA table. At least one entry of the TDRA table may comprise a plurality of TDRA configurations. Each TDRA configuration may correspond to a respective transmission of the multiple transmissions. Each TDRA configuration may be associated with at least one of: a value indicating a slot offset between the downlink control information and a corresponding transmission of the multiple transmissions; a transmission mapping indication; or a start symbol and length indicator. The wireless device may send (e.g., transmit), to a base station, one or more messages comprising one or more parameters indicating whether the wireless device supports Type 1 multiple-cell scheduling or Type 2 multiple-cell scheduling. The wireless device may comprise one or more processors; and memory storing instructions that, when executed by the one or more processors, cause the wireless device to perform the described method, additional operations and/or include the additional elements. A system may comprise a wireless device configured to perform the described method, additional operations and/or include the additional elements; and a base station configured to send the one or more configuration parameters. A computer-readable medium may store instructions that, when executed, cause performance of the described method, additional operations, and/or include the additional elements.

A wireless device may perform a method comprising multiple operations. The wireless device may receive one or more configuration parameters. The one or more configuration parameters may indicate: a format associated with scheduling for multiple cells and for multiple transmissions via at least one cell of the multiple cells; and time domain resource allocations (TDRAs) associated with the scheduling. The wireless device may receive downlink control information formatted according to the format associated with the scheduling. The downlink control information may be configured to schedule a plurality of transmissions via a first cell of the multiple cells and may comprise a new data indicator (NDI) field. The NDI field may comprise a plurality of blocks. A first block, of the plurality of blocks, may contain a number of bits equal to a maximum number of a plurality of schedulable transmissions. Each bit of the number of bits may correspond to a schedulable transmission. The maximum number may be determined based on the TDRAs. The wireless device may receive, via the first cell, the plurality of scheduled transmissions. Each bit of the number of bits may correspond to a transport block of multiple transport blocks transmitted via the multiple transmissions. The multiple transmissions may comprise at least one of: multiple downlink transmissions via a physical downlink shared channel (PDSCH); or multiple uplink transmissions via a physical uplink shared channel (PUSCH). The multiple cells may comprise at least two cells configured with one or more of: different carrier types; or different subcarrier spacing values. The TDRAs may be comprised in a TDRA table, and at least one entry of the TDRA table may correspond to multiple TDRAs. The wireless device may comprise one or more processors; and memory storing instructions that, when executed by the one or more processors, cause the wireless device to perform the described method, additional operations and/or include the additional elements. A system may comprise a wireless device configured to perform the described method, additional operations and/or include the additional elements; and a base station configured to send the one or more configuration parameters. A computer-readable medium may store instructions that, when executed, cause performance of the described method, additional operations, and/or include the additional elements.

A base station may perform a method comprising multiple operations. The base station may send one or more configuration parameters. The one or more configuration parameters may indicate: a format associated with scheduling for multiple cells and for multiple transmissions via at least one cell of the multiple cells; and time domain resource allocations (TDRAs) associated with the scheduling. The base station may send downlink control information formatted according to the format associated with the scheduling. The downlink control information may be configured to schedule a plurality of transmissions via a first cell of the multiple cells. The downlink control information may comprise a time domain resource allocation (TDRA) field. The TDRA field may indicate a plurality of TDRA indexes. A first TDRA index, of a plurality of TDRA indexes, indicated by the TDRA field, may indicate one or more TDRAs of the TDRAs associated with the scheduling. Each TDRA of the one or more TDRAs may correspond to a respective scheduled transmission of the plurality of scheduled transmissions via the first cell. The base station may send, via the first cell, the plurality of scheduled transmissions. The TDRAs may be indicated in the downlink control information. The multiple transmissions may comprise at least one of: multiple downlink transmissions via a physical downlink shared channel (PDSCH); or multiple uplink transmissions via a physical uplink shared channel (PUSCH). The first TDRA index may further indicate a bandwidth part of the first cell. The base station may send the plurality of scheduled transmissions via the bandwidth part of the first cell. The base station may receive, from a wireless device, one or more messages comprising one or more parameters indicating whether the wireless device supports Type 1 multiple-cell scheduling or Type 2 multiple-cell scheduling. The base station may comprise one or more processors; and memory storing instructions that, when executed by the one or more processors, cause the base station to perform the described method, additional operations and/or include the additional elements. A system may comprise a base station configured to perform the described method, additional operations and/or include the additional elements; and a wireless device configured to receive the one or more configuration parameters. A computer-readable medium may store instructions that, when executed, cause performance of the described method, additional operations, and/or include the additional elements.

A wireless device may perform a method comprising multiple operations. The wireless device may receive one or more messages. The one or more messages may comprise: downlink control information (DCI), of a first cell, indicating multiple-cell scheduling comprising a second cell being scheduled with multiple physical downlink shared channels (PDSCHs); and a time domain resource allocation (TDRA) table, of a first bandwidth part (BWP) of the second cell, for multiple PDSCHs scheduling using the DCI. The wireless device may receive, via the first cell, the DCI comprising a time domain resource allocation (TDRA) field. The TDRA field may comprise a plurality of TDRA indexes comprising a first TDRA index corresponding to the first BWP of the second cell. The first TDRA index may point to a first entry of the TDRA table. The first entry may indicate multiple TDRAs with each TDRA corresponding to a respective PDSCH of the multiple PDSCHs. The wireless device may receive, via the first BWP of the second cell, the multiple PDSCHs based on the DCI. The multiple-cell scheduling may be a type 2 multiple-cell scheduling. The type 2 multiple-cell scheduling may comprise scheduling, by the DCI, multiple PDSCHs on multiple cells with at least one cell scheduled with at least two PDSCHs. The type 2 multiple-cell scheduling may be different from a type 1 multiple-cell scheduling. The type 1 multiple-cell scheduling may comprise scheduling, by the DCI, multiple PDSCHs on multiple cells with one PDSCH per cell. For the Type 1 multiple-cell scheduling, the multiple cells may be configured with at least one of: a same carrier type; and a same subcarrier spacing. A carrier type may comprise whether the cell may be deployed in licensed band or in unlicensed band. A carrier type may comprise a frequency range where the cell may be deployed. For the Type 2 multiple-cell scheduling, the multiple cells may comprise at least two cells configured with: different carrier types; and different subcarrier spacing values. The multiple cells may comprise the first cell. The first cell may be deployed in a first frequency range. The second cell may be deployed in a second frequency range. The first cell and the second cell may be configured with different subcarrier spacing values. The wireless device may monitor a PDCCH on the first cell for receiving the DCI. The one or more messages may further comprise a second TDRA table for single-PDSCH scheduling on the first BWP of the second cell. Each entry of the second TDRA table for single-PDSCH scheduling may comprise at least one of: a K0 value indicating a slot offset between the PDSCH and the DCI; a PDSCH mapping indication; and a start symbol and length indicator. Each entry of the TDRA table for multi-PDSCH scheduling may comprise a plurality of TDRA configurations. Each TDRA configuration may correspond to a respective PDSCH of the multiple PDSCHs. Each TDRA configuration may be associated with at least one of: a K0 value indicating a slot offset between the DCI and the corresponding PDSCH; a PDSCH mapping indication; and a start symbol and length indicator. The wireless device may send (e.g., transmit), to a base station, one or more second RRC messages comprising wireless device's radio access capability information. The radio access capability information may comprise one or more parameters indicating whether the wireless device supports Type 1 multiple-cell scheduling or Type 2 multiple-cell scheduling. The one or more parameters may be per frequency band indicated. The one or more parameters may be per frequency band combination indicated. The one or more parameters may be per frequency range indicated. The one or more parameters may be per frequency range combination indicated. A frequency range combination may comprise at least one of: FR1+FR 2; FR1+FR2−2; FR2+FR2−2; and FR1+FR2+FR2−2. A frequency range combination being set to FR1+FR2 may comprise: the scheduling cell being configured on FR1; and one or more scheduled cells being configured on FR2. A frequency range combination being set to FR1+FR2+FR2−2 may comprise: the scheduling cell being configured on FR1; one or more first scheduled cells being configured on FR2; and one or more first scheduled cells being configured on FR2−2. The one or more parameters may be per SCS combination indicated. A SCS combination may comprise at least one of: 15 KHz+30 KHz; 15 KHz+60 KHz; 15 KHz+480 KHz; 15 KHz+960 KHz; and 15 KHz+60 KHz+960 KHz. A SCS combination being set to 15 KHz+30 KHz may comprise: the scheduling cell being configured with 15 KHz SCS; and one or more scheduled cells being configured with 30 KHz SCS. A SCS combination being set to 15 KHz+60 KHz+960 KHz may comprise: the scheduling cell being configured with 15 KHz SCS; one or more first scheduled cells being configured with 60 KHz SCS; and one or more second scheduled cells being configured with 960 KHz SCS. The one or more parameters may indicate whether the wireless device supports Type 2 multi-cell scheduling with: the scheduling cell being configured in licensed band; and one or more scheduled cells being configured in unlicensed band. The one or more parameters may indicate a (maximum/supported) number of different SCS values configured for multiple cells on which the wireless device supports Type 2 multi-cell scheduling. The one or more parameters may indicate a (maximum/supported) number of frequency ranges configured for multiple cells on which the wireless device supports Type 2 multi-cell scheduling. The wireless device may comprise one or more processors; and memory storing instructions that, when executed by the one or more processors, cause the wireless device to perform the described method, additional operations and/or include the additional elements. A system may comprise a wireless device configured to perform the described method, additional operations and/or include the additional elements; and a base station configured to send the one or more configuration parameters. A computer-readable medium may store instructions that, when executed, cause performance of the described method, additional operations, and/or include the additional elements.

A wireless device may perform a method comprising multiple operations. The wireless device may receive one or more messages. The one or more messages may comprise: downlink control information (DCI), of a first cell, indicating multiple-cell scheduling comprising a second cell being scheduled with multiple physical downlink shared channels (PDSCHs); and a time domain resource allocation (TDRA) table, of the second cell, for multiple PDSCHs scheduling using the DCI. The wireless device may receive, via the first cell, the DCI comprising a new data indicator (NDI) field. The NDI field may comprise a plurality of blocks comprising a first block corresponding to the second cell. A number of bits contained in the first block may be equal to a maximum number of PDSCHs on the second cell. Each bit of the number of bits, corresponding to a respective transport block (TB) of multiple TBs transmitted via the multiple PDSCHs, may indicate whether the TB may be a new transmission. The maximum number may be determined based on the TDRA table of the second cell. The wireless device may receive, based on the DCI, the multiple TBs via the multiple PDSCHs of the second cell. The multiple-cell scheduling may be a type 2 multiple-cell scheduling. The type 2 multiple-cell scheduling may comprise scheduling, by the DCI, multiple PDSCHs on multiple cells with at least one cell scheduled with at least two PDSCHs. The type 2 multiple-cell scheduling may be different from a type 1 multiple-cell scheduling. The type 1 multiple-cell scheduling may comprise scheduling, by the DCI, multiple PDSCHs on multiple cells with one PDSCH per cell. For the Type 1 multiple-cell scheduling, the multiple cells may be configured with at least one of: a same carrier type; and a same subcarrier spacing. A carrier type may comprise whether the cell may be deployed in licensed band or in unlicensed band. A carrier type may comprise a frequency range where the cell may be deployed. For the Type 2 multiple-cell scheduling, the multiple cells may comprise at least two cells configured with: different carrier types; and different subcarrier spacing values. The wireless device may comprise one or more processors; and memory storing instructions that, when executed by the one or more processors, cause the wireless device to perform the described method, additional operations and/or include the additional elements. A system may comprise a wireless device configured to perform the described method, additional operations and/or include the additional elements; and a base station configured to send the one or more configuration parameters. A computer-readable medium may store instructions that, when executed, cause performance of the described method, additional operations, and/or include the additional elements.

A base station may perform a method comprising multiple operations. The base station may send one or more configuration parameters. The one or more configuration parameters may indicate: a format associated with scheduling for multiple cells and for multiple transmissions via at least one cell of the multiple cells; and time domain resource allocations (TDRAs) associated with the scheduling. The base station may send downlink control information formatted according to the format associated with the scheduling. The downlink control information may be configured to schedule a plurality of transmissions via a first cell of the multiple cells. The downlink control information may comprise a new data indicator (NDI) field. The NDI field may comprise a plurality of blocks. A first block, of the plurality of blocks, may contain a number of bits equal to a maximum number of a plurality of schedulable transmissions. Each bit of the number of bits may correspond to a schedulable transmission. The maximum number may be determined based on the TDRAs. The base station may send, via a first cell of the multiple cells, a plurality of transmissions scheduled by the downlink control information. Each bit of the number of bits may correspond to a transport block of multiple transport blocks transmitted via the multiple transmissions. The multiple transmissions may comprise at least one of: multiple downlink transmissions via a physical downlink shared channel (PDSCH); or multiple uplink transmissions via a physical uplink shared channel (PUSCH). The multiple cells may comprise at least two cells configured with one or more of: different carrier types; or different subcarrier spacing values. The TDRAs may be comprised in a TDRA table, and at least one entry of the TDRA table may correspond to multiple TDRAs. The base station may comprise one or more processors; and memory storing instructions that, when executed by the one or more processors, cause the base station to perform the described method, additional operations and/or include the additional elements. A system may comprise a base station configured to perform the described method, additional operations and/or include the additional elements; and a wireless device configured to receive the one or more configuration parameters. A computer-readable medium may store instructions that, when executed, cause performance of the described method, additional operations, and/or include the additional elements.

One or more of the operations described herein may be conditional. For example, one or more operations may be performed if certain criteria are met, such as in a wireless device, a base station, a radio environment, a network, a combination of the above, and/or the like. Example criteria may be based on one or more conditions such as wireless device and/or network node configurations, traffic load, initial system set up, packet sizes, traffic characteristics, a combination of the above, and/or the like. If the one or more criteria are met, various examples may be used. It may be possible to implement any portion of the examples described herein in any order and based on any condition.

A base station may communicate with one or more of wireless devices. Wireless devices and/or base stations may support multiple technologies, and/or multiple releases of the same technology. Wireless devices may have some specific capability(ies) depending on wireless device category and/or capability(ies). A base station may comprise multiple sectors, cells, and/or portions of transmission entities. A base station communicating with a plurality of wireless devices may refer to a base station communicating with a subset of the total wireless devices in a coverage area. Wireless devices referred to herein may correspond to a plurality of wireless devices compatible with a given LTE, 5G, 6G, or other 3GPP or non-3GPP release with a given capability and in a given sector of a base station. A plurality of wireless devices may refer to a selected plurality of wireless devices, a subset of total wireless devices in a coverage area, and/or any group of wireless devices. Such devices may operate, function, and/or perform based on or according to drawings and/or descriptions herein, and/or the like. There may be a plurality of base stations and/or a plurality of wireless devices in a coverage area that may not comply with the disclosed methods, for example, because those wireless devices and/or base stations may perform based on older releases of LTE, 5G, 6G, or other 3GPP or non-3GPP technology.

One or more parameters, fields, and/or Information elements (IEs), may comprise one or more information objects, values, and/or any other information. An information object may comprise one or more other objects. At least some (or all) parameters, fields, IEs, and/or the like may be used and can be interchangeable depending on the context. If a meaning or definition is given, such meaning or definition controls.

One or more elements in examples described herein may be implemented as modules. A module may be an element that performs a defined function and/or that has a defined interface to other elements. The modules may be implemented in hardware, software in combination with hardware, firmware, wetware (e.g., hardware with a biological element) or a combination thereof, all of which may be behaviorally equivalent. For example, modules may be implemented as a software routine written in a computer language configured to be executed by a hardware machine (such as C, C++, Fortran, Java, Basic, MATLAB or the like) or a modeling/simulation program such as Simulink, Stateflow, GNU Octave, or LabVIEWMathScript. Additionally or alternatively, it may be possible to implement modules using physical hardware that incorporates discrete or programmable analog, digital and/or quantum hardware. Examples of programmable hardware may comprise: computers, microcontrollers, microprocessors, application-specific integrated circuits (ASICs); field programmable gate arrays (FPGAs); and/or complex programmable logic devices (CPLDs). Computers, microcontrollers and/or microprocessors may be programmed using languages such as assembly, C, C++ or the like. FPGAs, ASICs and CPLDs are often programmed using hardware description languages (HDL), such as VHSIC hardware description language (VHDL) or Verilog, which may configure connections between internal hardware modules with lesser functionality on a programmable device. The above-mentioned technologies may be used in combination to achieve the result of a functional module.

One or more features described herein may be implemented in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. The functionality of the program modules may be combined or distributed as desired. The functionality may be implemented in whole or in part in firmware or hardware equivalents such as integrated circuits, field programmable gate arrays (FPGA), and the like. Particular data structures may be used to more effectively implement one or more features described herein, and such data structures are contemplated within the scope of computer executable instructions and computer-usable data described herein.

A non-transitory tangible computer readable media may comprise instructions executable by one or more processors configured to cause operations of multi-carrier communications described herein. An article of manufacture may comprise a non-transitory tangible computer readable machine-accessible medium having instructions encoded thereon for enabling programmable hardware to cause a device (e.g., a wireless device, wireless communicator, a wireless device, a base station, and the like) to allow operation of multi-carrier communications described herein. The device, or one or more devices such as in a system, may include one or more processors, memory, interfaces, and/or the like. Other examples may comprise communication networks comprising devices such as base stations, wireless devices or user equipment (wireless device), servers, switches, antennas, and/or the like. A network may comprise any wireless technology, including but not limited to, cellular, wireless, WiFi, 4G, 5G, 6G, any generation of 3GPP or other cellular standard or recommendation, any non-3GPP network, wireless local area networks, wireless personal area networks, wireless ad hoc networks, wireless metropolitan area networks, wireless wide area networks, global area networks, satellite networks, space networks, and any other network using wireless communications. Any device (e.g., a wireless device, a base station, or any other device) or combination of devices may be used to perform any combination of one or more of steps described herein, including, for example, any complementary step or steps of one or more of the above steps.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the descriptions herein. Accordingly, the foregoing description is by way of example only, and is not limiting.

1. A method comprising:
receiving, by a wireless device, one or more configuration parameters indicating:
a format associated with scheduling for multiple cells and for multiple transmissions via at least one cell of the multiple cells; and
time domain resource allocations (TDRAs) associated with the scheduling;
receiving downlink control information formatted according to the format associated with the scheduling, wherein the downlink control information comprises a time domain resource allocation (TDRA) field, and wherein:
a first TDRA index, of a plurality of TDRA indexes, indicated by the TDRA field, indicates one or more TDRAs of the TDRAs associated with the scheduling; and
each TDRA of the one or more TDRAs corresponds to a respective scheduled transmission of a plurality of transmissions scheduled, via a first cell of the multiple cells, by the downlink control information; and
receiving, via the first cell, the plurality of scheduled transmissions.

2. The method of claim 1, wherein the downlink control information further comprises a new data indicator (NDI) field comprising a plurality of blocks, and wherein:
a first block, of the plurality of blocks, contains a number of bits equal to a maximum number of a plurality of schedulable transmissions;
each bit of the number of bits corresponds to a schedulable transmission; and
the maximum number is determined based on the TDRAs associated with the scheduling.

3. The method of claim 1, wherein the TDRAs associated with the scheduling are indicated in the downlink control information.

4. The method of claim 1, wherein the multiple transmissions comprise at least one of:
multiple downlink transmissions via a physical downlink shared channel (PDSCH); or
multiple uplink transmissions via a physical uplink shared channel (PUSCH).

5. The method of claim 1, wherein the first TDRA index further indicates a bandwidth part of the first cell, and wherein the receiving the plurality of scheduled transmissions comprises receiving the plurality of scheduled transmissions via the bandwidth part of the first cell.

6. The method of claim 1, wherein the multiple cells comprise at least two cells configured with one or more of:
different carrier types; or
different subcarrier spacing values.

7. The method of claim 1, wherein the TDRAs associated with the scheduling are comprised in a TDRA table, and wherein at least one entry of the TDRA table corresponds to multiple TDRAs.

8. The method of claim 1, wherein the TDRAs associated with the scheduling are comprised in a TDRA table, wherein each TDRA index, of the plurality of TDRA indexes, corresponds to an entry of the TDRA table.

9. The method of claim 1, wherein the TDRAs associated with the scheduling are comprised in a TDRA table, wherein at least one entry of the TDRA table comprises a plurality of TDRA configurations, each TDRA configuration corresponding to a respective transmission of the multiple transmissions, wherein each TDRA configuration is associated with at least one of:
a value indicating a slot offset between the downlink control information and a corresponding transmission of the multiple transmissions;
a transmission mapping indication; or
a start symbol and length indicator.

10. The method of claim 1, further comprising:
transmitting, to a base station, one or more messages comprising one or more parameters indicating whether the wireless device supports Type 1 multiple-cell scheduling or Type 2 multiple-cell scheduling.

11. A method comprising:
receiving, by a wireless device, one or more configuration parameters indicating:
a format associated with scheduling for multiple cells and for multiple transmissions via at least one cell of the multiple cells; and
time domain resource allocations (TDRAs) associated with the scheduling;
receiving, downlink control information formatted according to the format associated with the scheduling, wherein the downlink control information comprises a new data indicator (NDI) field comprising a plurality of blocks, and wherein:
a first block, of the plurality of blocks, contains a number of bits equal to a maximum number of a plurality of schedulable transmissions;
each bit of the number of bits corresponds to a schedulable transmission; and
the maximum number is determined based on the TDRAs; and
receiving, via a first cell of the multiple cells, a plurality of transmissions scheduled by the downlink control information.

12. The method of claim 11, wherein each bit of the number of bits corresponds to a transport block of multiple transport blocks transmitted via the multiple transmissions.

13. The method of claim 11, wherein the multiple transmissions comprise at least one of:
multiple downlink transmissions via a physical downlink shared channel (PDSCH); or
multiple uplink transmissions via a physical uplink shared channel (PUSCH).

14. The method of claim 11, wherein the multiple cells comprise at least two cells configured with one or more of:
different carrier types; or
different subcarrier spacing values.

15. The method of claim 11, wherein the TDRAs are comprised in a TDRA table, and wherein at least one entry of the TDRA table corresponds to multiple TDRAs.

16. A method comprising:
sending, by a base station, one or more configuration parameters indicating:
a format associated with scheduling for multiple cells and for multiple transmissions via at least one cell of the multiple cells; and
time domain resource allocations (TDRAs) associated with the scheduling;
sending downlink control information formatted according to the format associated with the scheduling, wherein the downlink control information comprises a time domain resource allocation (TDRA) field, and wherein:
a first TDRA index, of a plurality of TDRA indexes, indicated by the TDRA field, indicates one or more TDRAs of the TDRAs associated with the scheduling; and
each TDRA of the one or more TDRAs corresponds to a respective scheduled transmission of a plurality of transmissions scheduled, via a first cell of the multiple cells, by the downlink control information; and
sending, via the first cell, the plurality of scheduled transmissions.

17. The method of claim 16, wherein the downlink control information further comprises a new data indicator (NDI) field comprising a plurality of blocks, and wherein:
a first block, of the plurality of blocks, contains a number of bits equal to a maximum number of a plurality of schedulable transmissions;
each bit of the number of bits corresponds to a schedulable transmission; and
the maximum number is determined based on the TDRAs associated with the scheduling.

18. The method of claim 16, wherein the multiple transmissions comprise at least one of:
multiple downlink transmissions via a physical downlink shared channel (PDSCH); or
multiple uplink transmissions via a physical uplink shared channel (PUSCH).

19. The method of claim 16, wherein the first TDRA index further indicates a bandwidth part of the first cell, and wherein the sending the plurality of scheduled transmissions comprises sending the plurality of scheduled transmissions via the bandwidth part of the first cell.

20. The method of claim 16, further comprising:
receiving, from a wireless device, one or more messages comprising one or more parameters indicating whether the wireless device supports Type 1 multiple-cell scheduling or Type 2 multiple-cell scheduling.
